(19) United States
(12) Patent Application Publication
(10) Pub. No.: US 2014/0164285 A1
(43) Pub. Date: Jun. 12, 2014

(54) System and Method for the Creation, Review and Revision of Investment Banking Materials

(71) Applicant: PELLUCID ANALYTICS, LP, Boulder, CO (US)

(72) Inventors: Brian P. Ashburn, Longmont, CO (US); James A. Ballingall, Broomfield, CO (US); Andrew Scott Crockett, New York, NY (US); Eric Andrew Rattner, New York, NY (US); Andrew Marc Russakoff, New York, NY (US); Dustin Ted Whitney, New York, NY (US)

(73) Assignee: PELLUCID ANALYTICS, LP, Boulder, CO (US)

(21) Appl. No.: 13/707,060

(22) Filed: Dec. 6, 2012

(51) Int. Cl. G06Q 40/06

(52) U.S. Cl. CPC G06Q 40/06
USPC 705/36 R

(57) ABSTRACT

A system and method for the creation, review and revision of investment banking materials is described. The system includes an end-to-end software application that assists investment bankers in creating decks to present to their clients. The decks contain a mixture of publically-available and confidential information presented in charts and tables together with textual commentary and advice. The user is shown charts and if preferred, a chart can be immediately placed into a deck. Each chart has the bank's branding and style guidelines (e.g., colors, fonts) encoded such that charts are presented to the user pre-formatted. The system supports auditability, chart linking, and visual alerts. The system and methods can be executed on various devices, including pad and tablet computers, desktops and workstations, smartTVs, and mobile telephone units.

### CROSS-REFERENCE TO RELATED APPLICATIONS

None.

### BACKGROUND OF THE INVENTION

Currently, the predominant workflow for the creation of investment banking client presentations requires iterative interaction between the senior banker (who will present to the client) and the junior banker or bankers (who will construct the presentation ahead of time for the senior banker). Such presentations are called “decks,” as in a deck of cards. They might involve, for example, twenty to one hundred pages of financial charts and executive summaries. Often such decks report on and analyze company data for publicly traded companies, as well as comparable companies in the industry. Decks are a mainstay of the investment banking services industry.

While the senior banker typically presents the final deck to a corporate client as an ADOBE .pdf file, or in the form of bound paper, the workflow leading to its creation often involves multiple computer applications. Such decks also require multiple interactions between the senior banker and the junior banker team who creates them. For example, a typical workflow involves the senior banker describing to the junior banker what is generally wanted. The junior banker finds the data using a service such as FactSet, downloads the data to an Excel spreadsheet, creates a chart in Excel with the assistance of a custom Excel addin application, copy-pastes the chart into PowerPoint, aligns the chart with the assistance of a custom PowerPoint addin, prints the PowerPoint presentation (a .pptx file) to a .pdf file, and emails the .pdf to the senior banker who reviews it on an iPad with GoodReader. The senior banker then provides comments to the junior banker either as comments to the .pdf file, hand-written comments on a printout, or orally via phone or in person. This repeats until a satisfactory result is achieved. Some of these steps may be substituted, but without any gains in efficiency or accuracy. For instance, FactSet may be substituted with Capital IQ, Bloomberg, a Thomson Reuters product or manual data collection. PowerPoint may be substituted with MS Word. Or GoodReader may be substituted with a similar alternative product.

This workflow is inefficient, error-prone and isolates the decision maker (the senior banker) from the data.

What is needed is a system and method that generates a superior deck product to an investment bank senior banker, and by extension, to the bank's client. In particular, what is needed is a system and method that will lower expenses for investment banks by allowing them to require fewer junior resources, freeing those resources for other use. What is also needed is a system and method that can increase the number of clients a senior banker can cover, thereby increasing productivity. What is also needed is a system and method that will decrease the time it takes for a senior banker to respond to a client request, thereby building relationship capital. Such a system and method should also provide to senior bankers the benefits of mobility (the ability to do deck-creation work wherever he or she is), velocity (validation of ideas with quickly-created charts) and relevancy (only those deck charts that are truly needed, from among all that are possible). Such a system and method should also provide to junior bankers the benefits of focus (getting the basics done faster), thinking (quicker deck creation freeing time to focus on more challenging work) and satisfaction (a more challenging and engaging junior banker experience to better prepare for the senior banker position). Finally, such a system and method should provide investment bank management the benefits of leverage (reduction in man hours to deliver equivalent services), transparency (real-time insight and monitoring across banker workflow) and branding (consistent standards automatically enforced across bankers).

In accordance with the above objects, the invention herein includes an improved system and method that permits the creation, review and revision of investment banking materials, including investment banking decks.

### BRIEF SUMMARY OF THE INVENTION

The invention includes a software system and application having a novel and unconventional set of inputs that assists investment bankers in creating materials to present to their clients for discussion. These materials are typically referred to in the investment banking industry as pitchbooks, or decks. The decks contain a mixture of publically-available and confidential information (generally about the client) presented in charts and tables together with textual commentary, discussion and advice. Decks are typically, but not always, landscape style.

In a preferred embodiment, the application is delivered via a software-as-a-service model. The core delivery is to a web browser where the user simply navigates to a host website, logs in and begins using the application. This is sometimes referred to in other art as a cloud, or hosted system. Important functionality such as data access and chart rendering are performed on the server, although an offline mode which would not require an internet connection is another possible embodiment. The core version of the hosted system is not device specific but rather available on any modern web browser.

The present invention in one or more embodiments employs several features that make improvements over previously-known devices or processes. The application provides end-to-end connectivity, being the first product that allows a user to make a deck in a single application. The invention employs a review-reject-tweak model whereby the application suggests charts and ideas and lets the user choose those he/she prefers with modifications. The application is investment banker focused, being the first charting tool specifically designed for the needs of investment bankers rather than finance users generally. The chart formatting and autosizing aspect of the system creates charts in the client's own style and autosizes them to fit templated page layouts. The system provides significantly improved auditability over previous systems with the ability to see who made what changes and when. It also allows users to overlay data changes on top of existing vendor-provided data. The invention also provides for a novel controllable chart linking system, and a visual alert system.

Any platform with an enabled web browser is suitable for running the application. Exemplary portable platforms where the client side of the application can be run are Apple's iPad or an Android tablet computer. It will be appreciated, though, that any non-portable device having a web browser can also execute the invention, such as a standard desktop, laptop, workstation, or smartTV. Portable devices with smaller screens such as mobile phones can also run the application if necessary.

Additional device-specific versions represent another embodiment of the invention. For example, one version of the invention will be for the iPad (or analogously an Android tablet) and available as a downloadable app. This embodiment of the app consists mainly of a web browser rendering the core system but without extraneous user interface components like an address bar or back buttons. The user experience will be kept largely similar between versions of the invention but some device-specific changes would be necessary. For example, click-and-drag operations in a web browser will become tap-hold-and-swipe operations on a tablet. Some native iOS code may be added to ensure a satisfactory user experience but largely the system remains the same on the iPad as on a desktop browser.

Therefore, in one aspect, the invention comprises a system for use in creating investment-banking materials, comprising: a first computer server coupled in real time to a financial data source, the server comprising one or more user accounts corresponding to respective users, the server further comprising a set of default financial chart templates and one or more preselected companies for each of the user accounts, wherein the server is constructed to receive real-time financial data from the financial data source to populate one or more of the templates to generate a default library of charts for each of the preselected companies, wherein the server is further constructed to receive requests concerning the user accounts, such requests including selection from among the default library of which selected chart or charts is to be placed into one or more slides, wherein the server updates the default library of charts for each of the preselected companies with the retrieved real-time financial data, and propagates the real-time financial data into any selected charts, whereby slides that contain the selected charts also contain real-time financial data; and a rendering computer server coupled to the first computer server, constructed to render the graphic image of the selected charts and the one or more slides.

In another aspect, the invention comprises a method for generating investment-banking materials, comprising: a. viewing on a web browser a list of companies; b. selecting a company from that list; c. reviewing charts related to that company, the reviewed charts populated with real-time financial data inserted into the charts at a connected web server; d. selecting one or more of the reviewed charts for addition to a deck; e. repeating steps c. through d. until a deck has been created.

In yet another aspect, the invention comprises a non-transitory computer-readable medium comprising first computer program instructions, wherein the first computer program instructions are executable by at least one computer processor to perform a method, the method comprising: coupling in real time to a financial data source, establishing one or more user accounts corresponding to respective users, establishing a set of default financial chart templates and one or more preselected companies for each of the user accounts, receiving real-time financial data from the financial data source to populate one or more of the templates to generate a default library of charts for each of the preselected companies, receiving requests concerning the user accounts, such requests including selection from among the default library of which selected chart or charts is to be placed into one or more slides, updating the default library of charts for each of the preselected companies with the retrieved real-time financial data, and propagating the real-time financial data into any selected charts, whereby slides that contain the selected charts also contain real-time financial data; and rendering the graphic image of the selected charts and the one or more slides.

The system can also be used with other Apple devices, such as iPad mini, iPhone, or iPod touch) and other device manufacturer's products (e.g., Samsung or Microsoft).

### BRIEF DESCRIPTION OF THE DRAWINGS

FIG. 1 is a view of an exemplary dashboard.

FIG. 2 is a view of an exemplary resized dashboard.

FIG. 3 is a view of a dashboard as first experienced by the user.

FIG. 4 is a view of a dashboard in search mode.

FIG. 5 is a view of a dashboard in search mode with a company selected.

FIG. 6 is a view of a dashboard after a new company has been added or a company with no decks is selected.

FIG. 7 is a view of a dashboard after the user clicks a company on a row with existing decks.

FIG. 8 is a view of a dashboard immediately after clicking on the chart library button but before the application navigates to the library view.

FIG. 9 is a view of the chart library.

FIG. 10 is a view of the chart library while dragging and dropping a slide into a deck.

FIG. 11 is a view of the chart library resized on the screen to 1280 pixels.

FIG. 12 is a view of the chart library with auxiliary vertical scroll navigation in the left pane.

FIG. 13 is a view of comparable company selection within the chart library.

FIG. 14 is a view of the chart library in edit comparables mode.

FIG. 15 is a view of the chart library in edit comparables mode with a comparable selected to have its display name changed.

FIG. 16 is a view of the chart library in edit comparables mode with a company selected ready to be moved.

FIG. 17 is a view of the chart library in edit comparables mode with a group selected.

FIG. 18 is a view of the chart library in edit comparables mode while dragging a company from one group to another.

FIG. 19 is a view of the chart library in edit comparables mode ready to add a new group.

FIG. 20 is a view of a chart in detail tweak mode.

FIG. 21 is a view of a chart in detail with auxiliary vertical scroll navigation in the left pane.

FIG. 22 is a view of a chart in detail tweak mode, specifically tweaking comparables.

FIG. 23 is a view of a chart in detail tweak mode, confirming choice of version after the user has tapped the current chart.

FIG. 24 is a view of a chart in detail tweak mode, scrolling between different versions of the chart.

FIG. 25 is a view of a chart in detail tweak mode while searching for a company to add to comparables.

FIG. 26 is a view of a chart in detail tweak mode, specifically editing time frame with Year To Date selected.

FIG. 27 is a view of a chart in detail tweak mode while editing a custom time frame.

FIG. 28 is another view of a chart in detail tweak mode while editing a custom time frame.

FIG. 29 is a view of a chart in detail tweak mode while dragging the current chart to a deck.

FIG. 30 is a view of a chart in detail tweak mode after the chart has been dragged to the deck but before it is released, incrementing the deck size by one.

FIG. 31 is a view of a new deck with charts added from the library.

FIG. 32 is a view of a fleshed out deck with three charts from the left chart rail being added to a specific slide.

FIG. 33 is a view of a slide in detail mode.

FIG. 34 is a view of a slide in detail mode with the chart area selected, engaging layout mode.

FIG. 35 is a view of a slide in detail mode with the chart rail open.

FIG. 36 is a view of a slide in detail mode with a two chart layout being adjusted.

FIG. 37 is a view of a slide in detail mode with multiple exhibit adjustment being made.

FIG. 38 is a view of a slide in detail mode with text being entered into one exhibit.

FIG. 39 is a view of a slide in detail mode with content being popped out of an exhibit.

FIG. 40 is a view of a slide in detail mode with a chart header being entered and styled.

FIG. 41a is an example title page of an example deck.

FIG. 41b is an example table of contents of an example deck.

FIG. 41c is an example section break page of an example deck.

FIG. 41d is an example executive summary of an example deck.

FIG. 41e is an example section break page of an example deck.

FIG. 41f is an example rebased share price historical performance chart of an example deck.

FIG. 41g is an example comparable share price performance chart of an example deck.

FIG. 41h is an example section break page of an example deck.

FIG. 41i is an example peer comparison financial metrics slide of an example deck.

FIG. 41j is an example section break of an example deck.

FIG. 41k is an example historical context chart for short-term and long-term interest rates of an example deck.

FIG. 41l is an example slide with a debt “skyline” chart, yield curve and commentary of an example deck.

FIG. 41m is an example section break of an example deck.

FIG. 41n is an example comparables table of an example deck.

FIG. 41o is an example disclaimer of an example deck.

FIG. 42 is a high level overview of the system architecture.

FIG. 43 is a diagram of the client side application architecture component of the system architecture.

FIG. 44 is a diagram of the server side general application component of the system architecture.

FIG. 45 is a diagram of the visualization application programming interface of the system architecture.

FIG. 46 is a diagram of the data component of the system architecture.

FIG. 47 is a diagram of the software architecture and logic flow supporting chart formatting in the embodiment.

FIG. 48 is a diagram of the software architecture and logic flow supporting auto sizing in the embodiment.

FIG. 49 is a diagram of the software architecture and logic flow supporting chart linking in the embodiment.

FIG. 50 is a diagram of the software architecture and logic flow supporting visual alert definition in the embodiment.

### DETAILED DESCRIPTION OF THE PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting. These and other features of the invention will be more readily understood upon consideration of the attached drawings and of the following detailed description of those drawings and the embodiments of the invention.

A. The User Interface Experience

### Overview

The user of the invention interacts with the system dashboard, chart library and deck. The final output is an investment banker's deck, either in file or paper form. The dashboard is the entry point of the system. The main view of the dashboard comprises a list of companies with their respective summary financial data. The system stores all previously created decks by the user for each company.

The application is presentation-creation focused. The application shows the user a collection of default charts through the library and always ensures that if the user likes what he sees, he can immediately place that chart into a deck. For each investment bank that is a user of the system, the application encodes the bank's branding and style guidelines (e.g., colors, fonts) so that charts are presented to the user pre-formatted. This is a significant step-up in usability from tools like finance.yahoo.com, google.com/finance since they will only display charts in their own format and a significant step-up in usability from other tools, such as those supplied by Bloomberg or Thomson Reuters, that require the user to individually change formatting attributes like colors and fonts. Another key aspect of the user-interface and system is that it does not require imagination from the user. The user is shown a set of charts that he/she might be interested in and is allowed to make changes. This is called the review-reject-tweak model. The user reviews pre-generated charts, rejecting those he/she does not like. Those the banker likes can be customized to an exact preference. This dramatically decreases the cognitive load on the user versus requiring the user to know what he or she wants at the start of the process.

Most users will create decks in a two phase process: first they will select the charts they think might be interesting and then they will arrange those charts on slides to tell a story in a deck. The user is in a “story creation” mindset and looking to assemble the selected charts into a narrative. In the first phase the user will be free with chart selection, selecting all charts that might be interesting and in the second phase he or she will “tighten up” the deck to be more focused. In both phases, the system empowers the user to customize the charts.

### Interaction Flow

A “chart” is a core component of the system. A chart is a visualization of some data and the definition includes bar charts, line charts and tables as well as more complex visualizations. The term “exhibit” refers to any visual component of a page, including charts, text, headers and graphics.

The main interaction flow is:

1a. View a list of companies with prompts regarding recent market events (e.g., news, share price changes).

1b. Select a company from that list or find a company not already listed.

2a. Browse charts related to that company; these charts are fully populated with actual data and of quality such that they could be immediately included in a deck.

2b. (Optionally) Change some of the settings or assumptions of the chart to customize it to the user's exact needs.

2c. Add the chart to a deck—i.e., select the chart to indicate that the user might want to include in it a pitchbook.

3a. Enter deck mode to organize the charts. Specify the page layout (how many charts, what size, where on the page) and place the charts into the layout.

3b. (Optionally) Tweak the charts as in step 2b.

3c. Add text around the charts.

3d. Export the deck to PowerPoint or share it with colleagues More detail on step 1

In this step, the user picks the company from a list on a dashboard or searches to find a company not on the list. Also available is information about recent activity (share price, bond and spread moves, news and credit rating events) to help the banker determine if one of the companies covered needs attention.

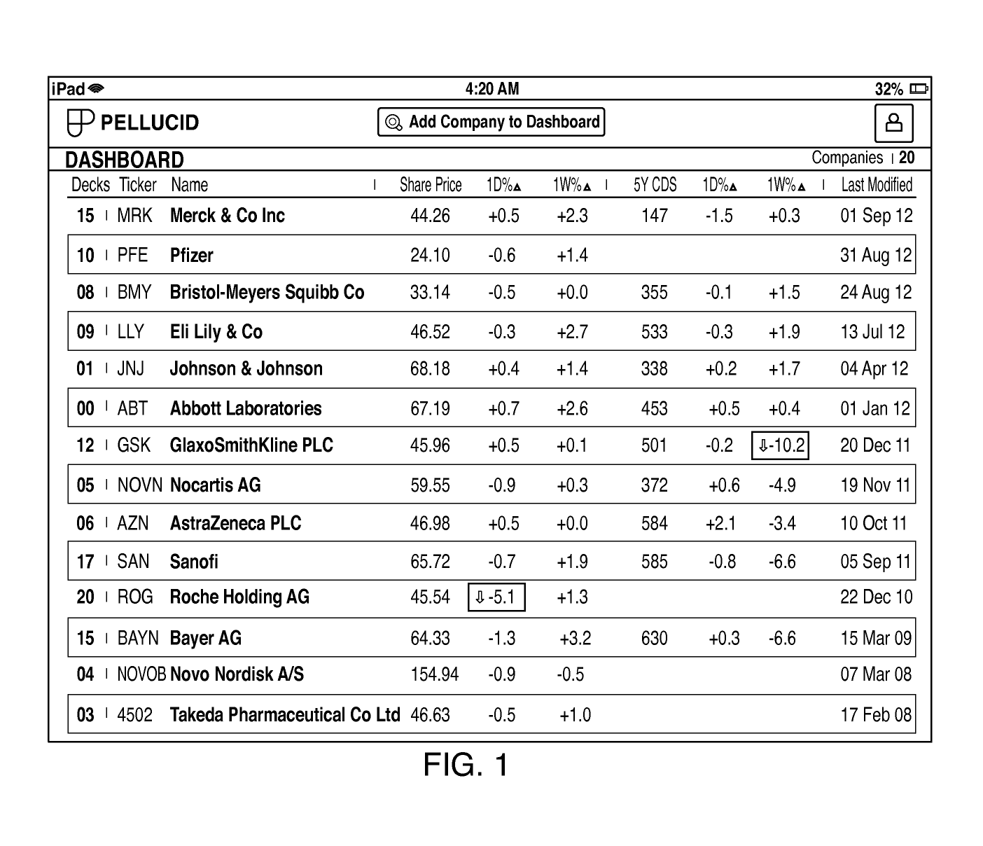

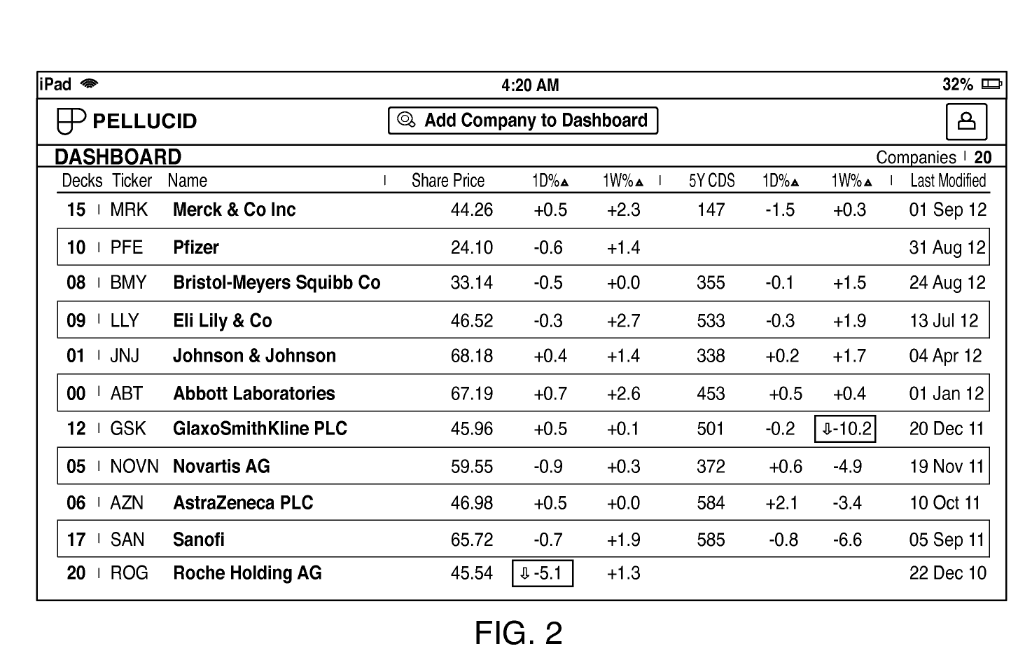

FIG. 1 is a view of the dashboard showing the list of companies that are available for analysis. Information for each company is shown in the columns to the right of the company name. From left to right, FIG. 1 includes information regarding the number of decks that have already been created for the company, the company's ticker symbol, the name of the company, share price, 1 day percentage change in share price, 1 week percentage change in share price, 5 year CDS spread, 1 day and 1 week percentage change in the 5 year CDS, and the date a deck for the company was last modified. FIG. 1 shows that 15 decks have been created and are available for the first company on the list, Merck & Co Inc. The total number of companies within the dashboard is indicated in the upper right hand corner, in this case, 20. A user is able to add a company to the dashboard by interacting with the “Add Company to Dashboard” option, and navigates through the various companies in the list by scrolling up or down. The metrics and information displayed on the dashboard is customizable and is not limited to information shown in FIG. 1. For example, bond yield may be substituted for share price. Other embodiments of the invention may incorporate multi-layered dashboard display. As is shown in FIG. 1, alerts represented by color highlights (e.g., boxes with up or down arrows are colored red or green) have been coded to signal events or necessary actions to the user. Because the 1 week percentage change in the CDS for ticker GSK has decreased by more than 10 percentage points, the number is boxed with a green highlight. This can highlight the information and/or encourage an action, such as recommending to the client to issue more debt. Similarly, because the 1 day percentage change in the share price of ticker ROG is over 5 percentage points, the number is boxed in red highlight and this may prompt the investment banker to raise this as a concern to the company's management. Alerts can be added with customizable colors. In the upper left hand corner is a logo that can be made to be the logo of the investment bank using the application. In FIG. 2, the same dashboard is shown resized to 1280 pixels. This is generally done according to a specific user's taste.

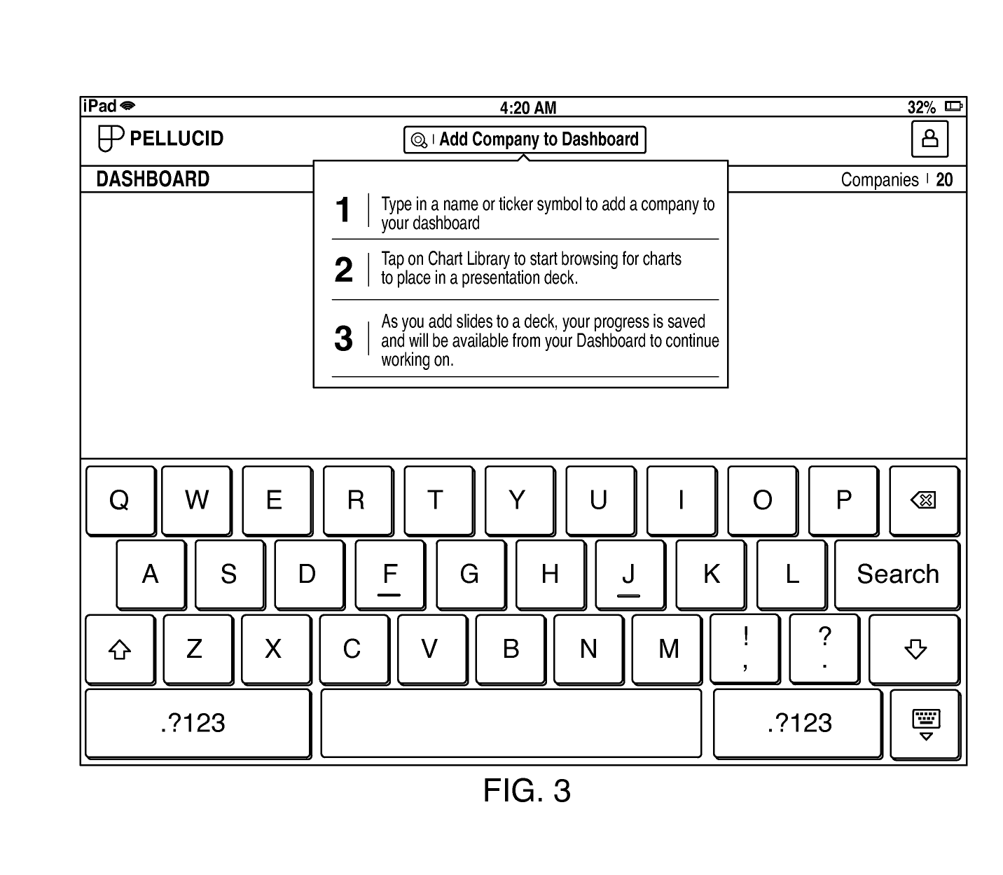

FIG. 3 shows the dashboard as first experienced by the user, with no companies added. Once a user touches a part of the search bar in the top-center of the dashboard, a qwerty keyboard and instructions appear. As shown in FIG. 3, steps 1-3 instruct the user to type in a name or ticker symbol to add a company to the dashboard. Other embodiments of the invention would enable the user to enter tickers or companies using voice and/or thought commands. Once a company is added, the user taps on the chart library to start browsing for charts to place in a presentation deck, while progress of the user in generating the presentation deck is saved.

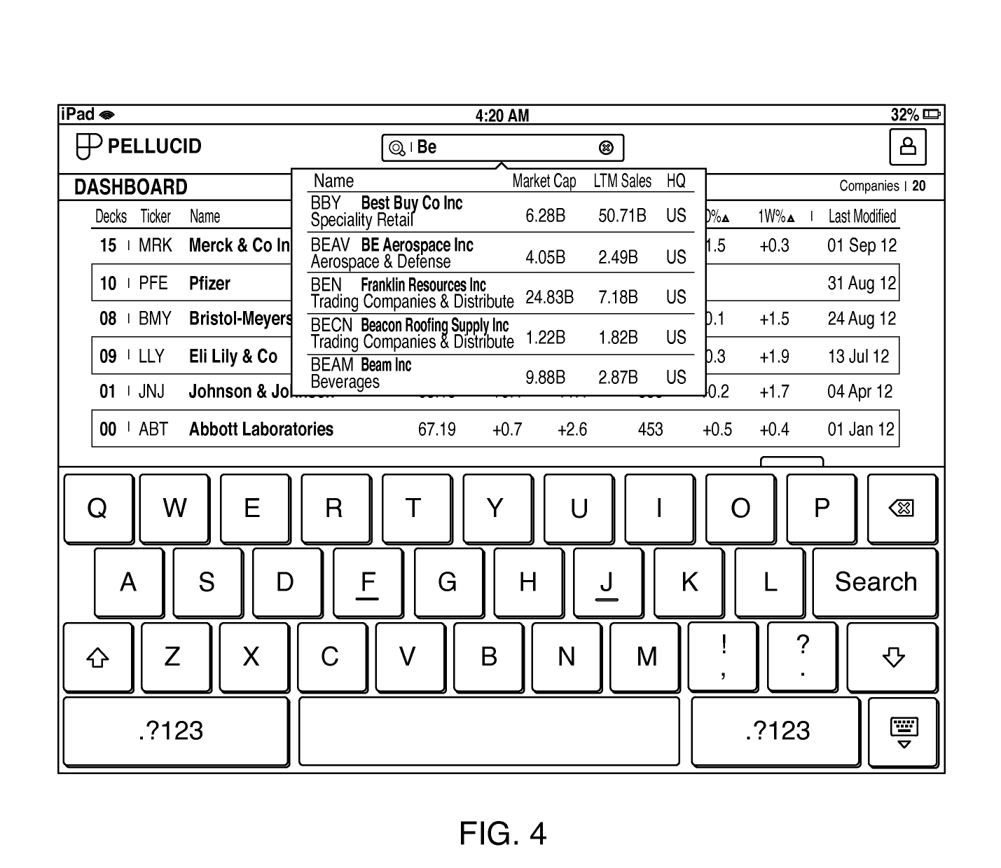

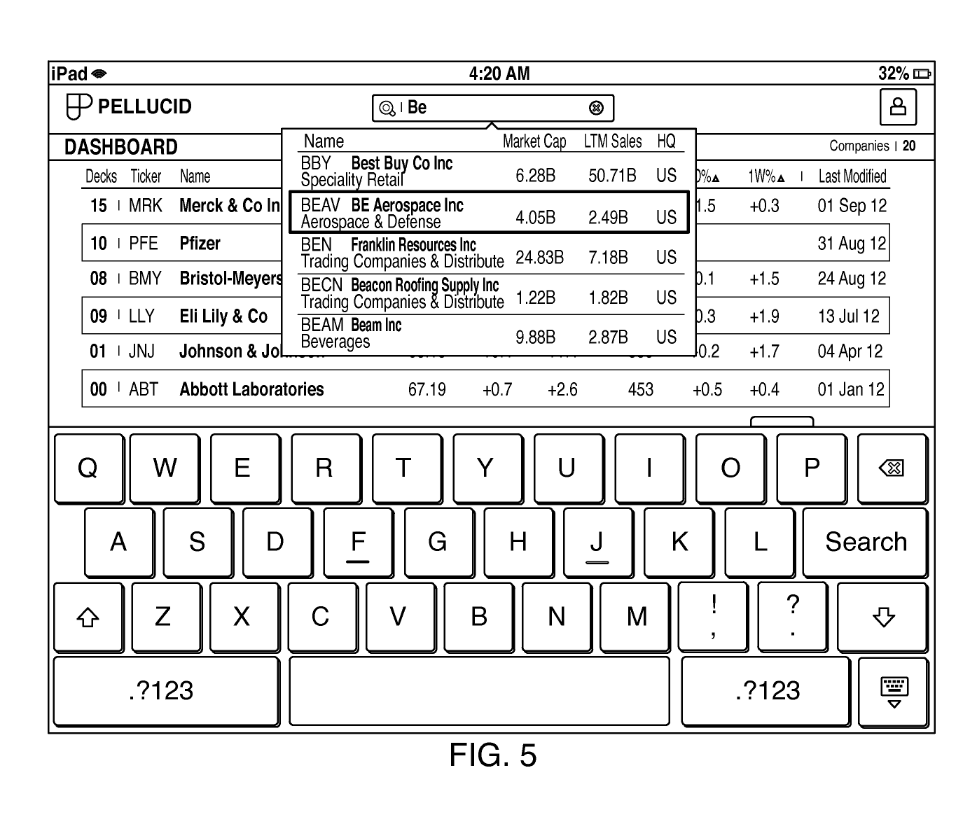

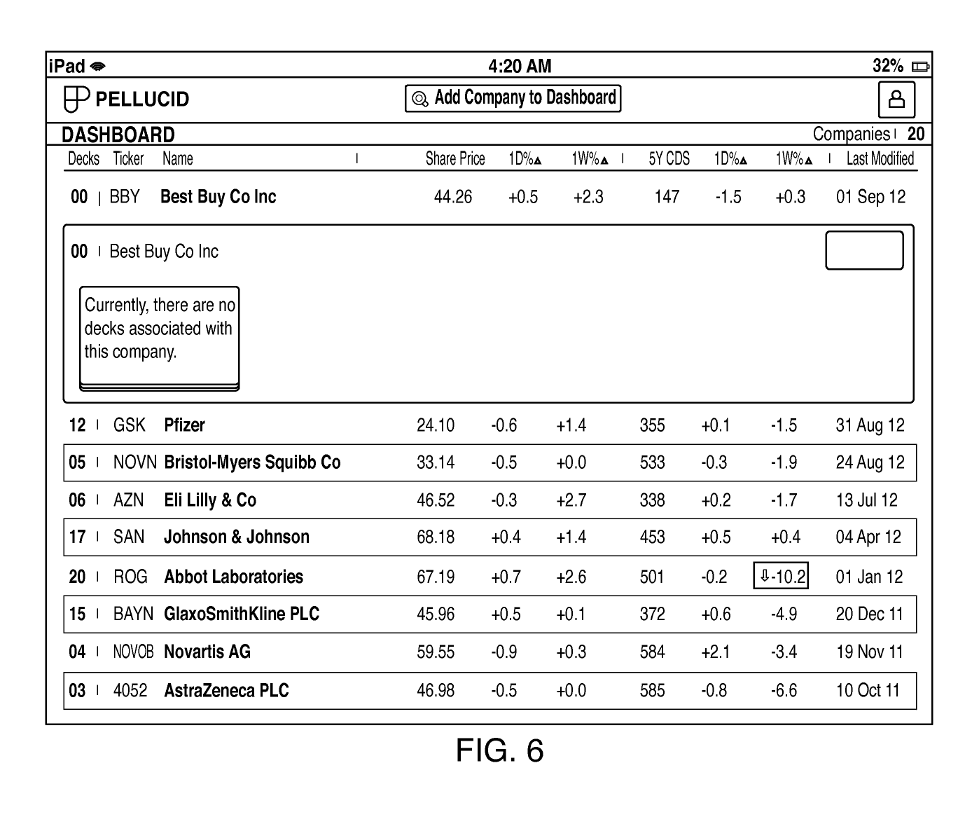

FIG. 4 is a view of the dashboard while the user is searching for a company, with several companies already added. At this point, when the user searches for a company, company suggestions are autofilled from the system database and displayed below the search bar. In FIG. 4, the user types “Be” and several companies are listed with either the name of the company beginning with “Be”, or with “Be” included in the ticker symbol. These may populate through a network connection (discussed below) or through a local database. When the suggestions are automatically provided, information about the companies is also provided including the type of company (for Best Buy, “Specialty Retail”), and header information including market capitalization, LTM sales and company headquarters location. The actual header text is also shown. The information included in the autofill fields is also customizable. For example, a company's logo can also be included among the information in the autofill fields, or L™ Sales could be replaced with YTD (year-to-date) sales. FIG. 5 is a view of the dashboard in search mode immediately after the user has selected a company to add. In FIG. 5, the user has selected BE Aerospace Inc. This view would be visible for a short time before being replaced with the view shown in FIG. 6.

FIG. 6 is a view of the dashboard after the user has selected a new company to add to the dashboard or has selected a company already on the dashboard that has no decks. Here, the banker has added Best Buy Co Inc. Financial information from the databases, timely as of that instant, has been automatically and quickly imported (share price, etc.) and shown on the dashboard. Since the user has not created any Best Buy decks, the system indicates directly below the Best Buy entry on the dashboard that “Currently, there are no decks associated with this company,” and the number of decks indicated for the company is 00. In addition, on the right hand side of the entry is a button and image after which the user presses he/she is taken to the chart library.

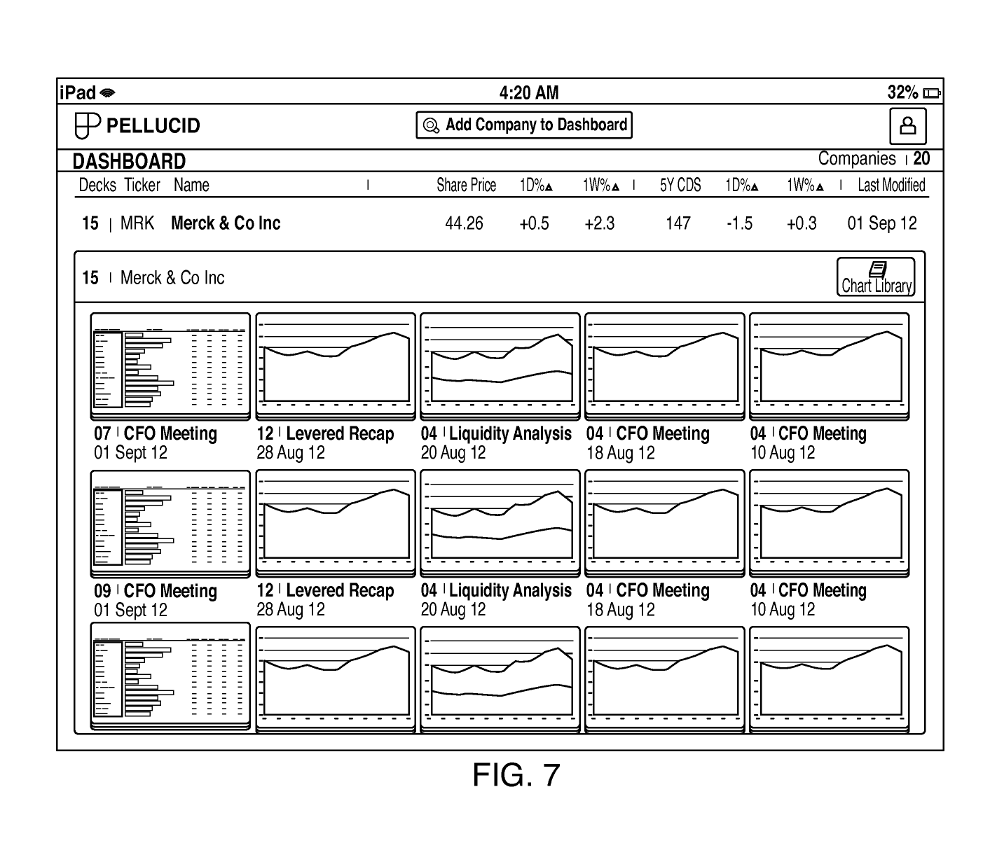

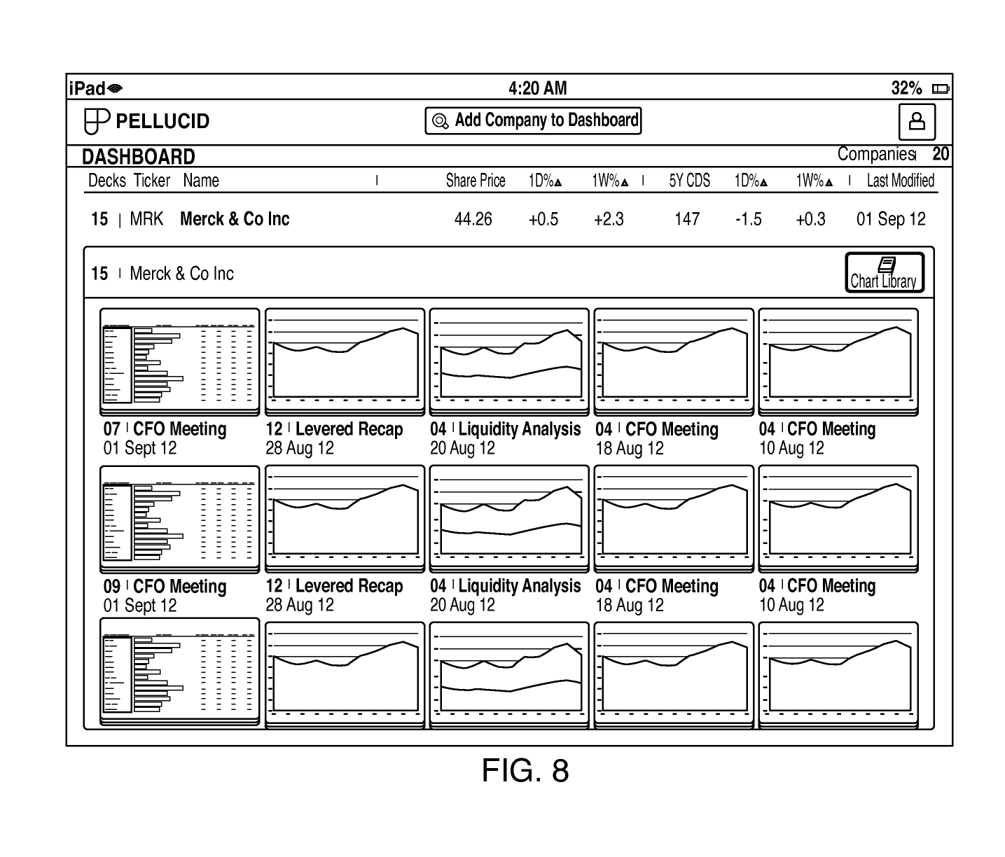

FIG. 7 is a view of the dashboard after a banker has clicked on a company to view. After the banker has done this, summary financial information is still shown, now at the top-middle of the screen. In FIG. 7, after the user has selected Merck & Co Inc., the 15 decks that have been created for Merck & Co are displayed. A chart image is shown, which is a thumbnail or mini view of any one of the charts in the deck. The mini-chart image that is shown is typically the first chart from that particular deck, but this can be changed to be, for example, either the chart that has been viewed or edited the most, or one selected by the user. Shown below the deck image is the number of charts for the deck, the title of the deck, and the date the deck was created or last modified. Thus, the deck directly below the name Merck & Co Inc has 7 charts, is titled CFO Meeting, and was last modified on Sep. 1, 2012. All this information is customizable, so for example the date could be the date the deck was created rather than last modified. From this view, the user is still able to access the chart library by accessing the Chart Library button on the right-hand side. FIG. 8 is the dashboard of FIG. 7 immediately after the user clicks the Chart Library button. Shortly after that click, the user will be taken to the library view.

### More Detail on Step 2

In step 2 the user is able to browse charts related to a company. This section of the app, the “chart library”, is a fundamental core of the app. This is where the user browses through charts, selecting those he/she wants to potentially include in a deck. The charts are arranged in a flat grid-like layout with vertical and horizontal swiping to navigate. Swiping horizontally only affects that row.

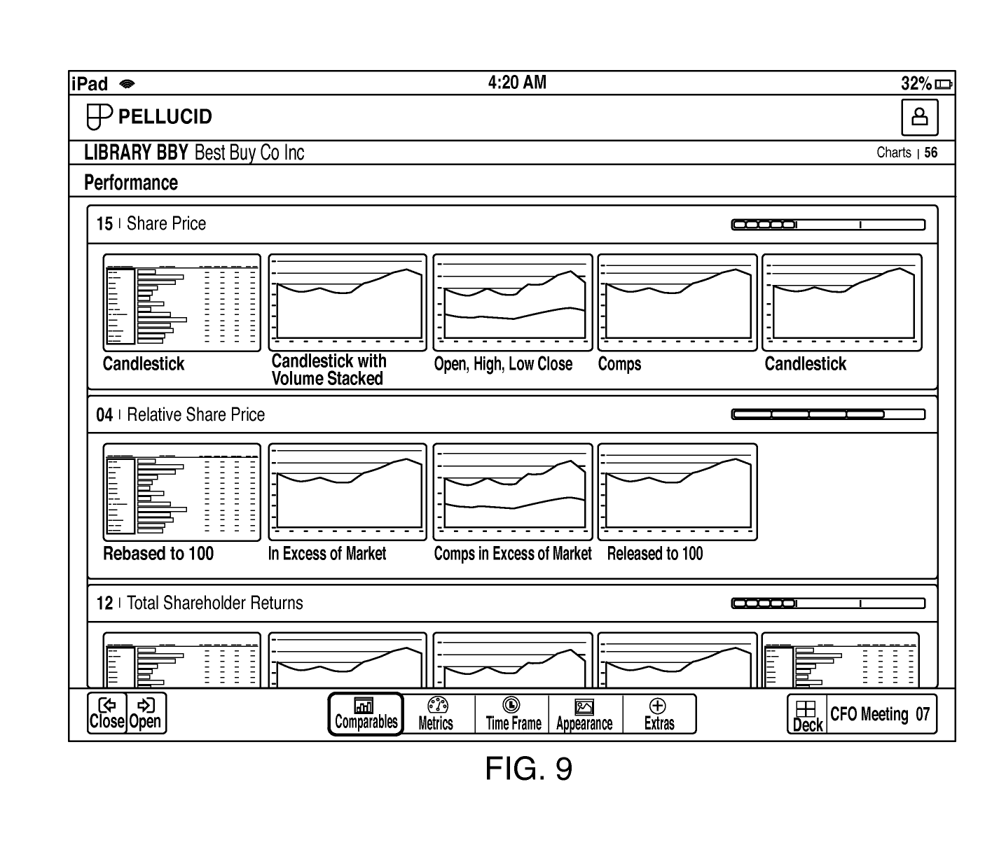

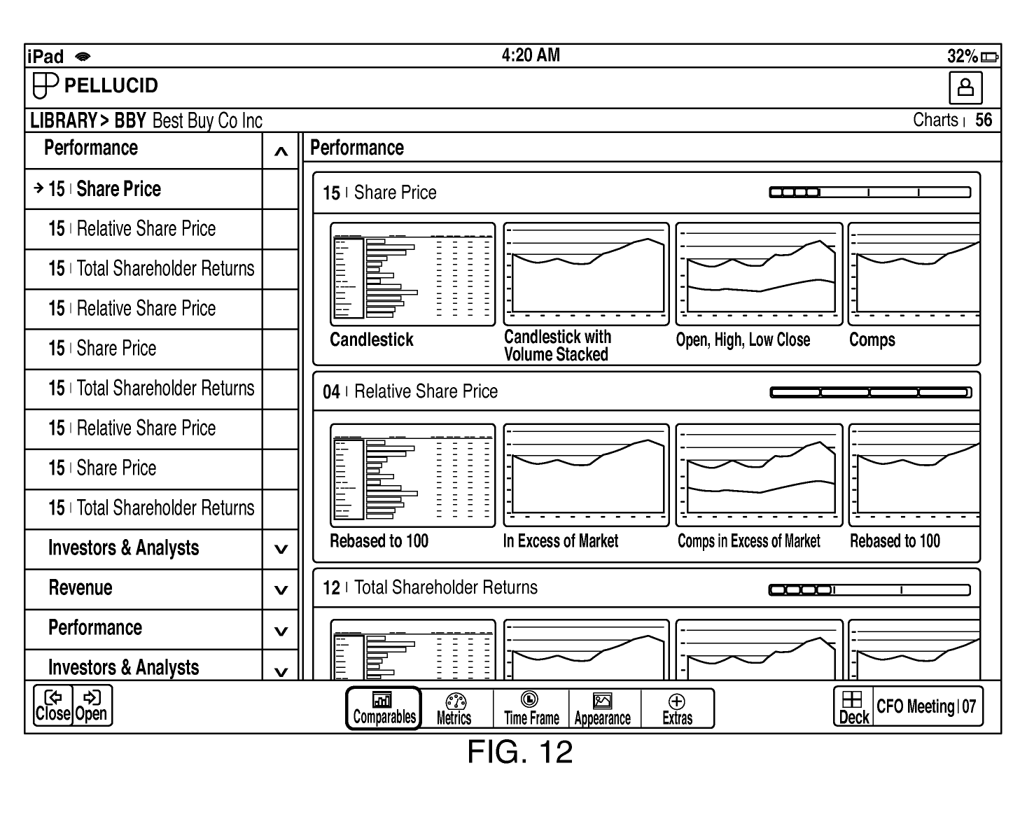

FIG. 9 shows the library contents of the Best Buy company while the user is editing the CFO Meeting deck. The upper right hand corner shows the total number of charts available in the chart library, 56. The title of the deck is shown in the lower right hand corner. In the lower left hand corner is a “Close/Open” button which controls whether the left navigation pane is visible (see FIG. 12). Clicking the Pellucid icon in the top left corner brings the user back to the Dashboard. Each row represents a topic category for potential charts in the deck. For example, under the larger category of company “Performance”, there are share price charts, relative share price charts, and total shareholder returns charts. The title of the chart is shown below each chart. For example, under the “Relative Share Price” topic, “Rebased to 100”, “In Excess of Market”, “Comps in Excess of Market” and “Rebased to 100” charts are available. There is a ledger on the upper right hand corner of each category in blocks representing how many charts that have been selected that are actually shown on the screen relative to those that are available. At the bottom center of the library, there are buttons for “Comparables”, “Metrics”, “Time Frame”, “Appearance” and “Extras”, which the banker uses later to tweak selected charts.

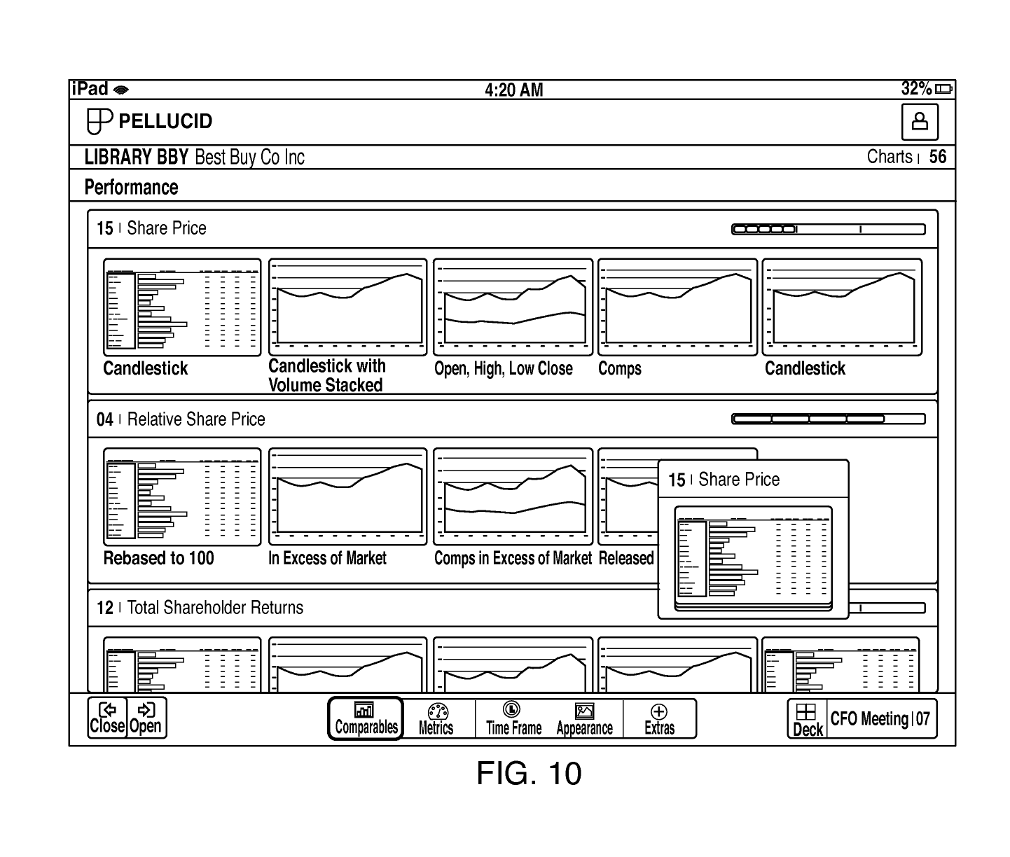

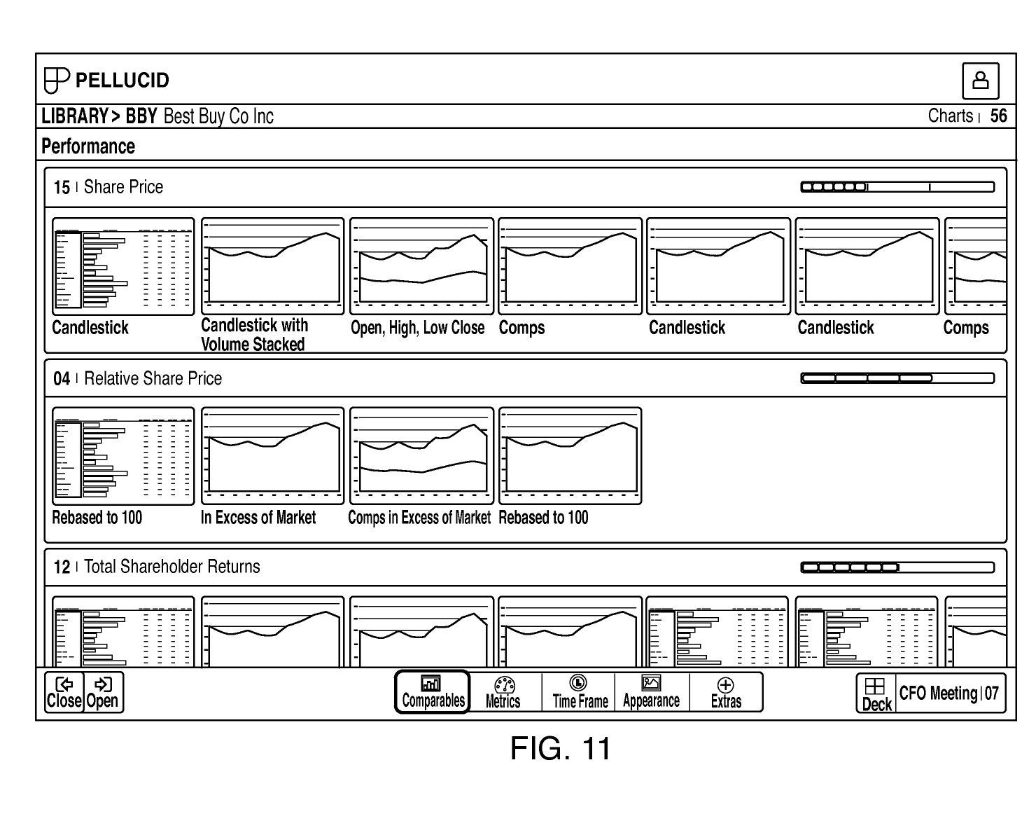

In FIG. 10, the user is shown dragging and dropping an entire row into the CFO meeting deck. Here the 15 charts in the Share Price row are being dragged and dropped. While doing this, the charts in the Share Price row are shown with a white silhouette. FIG. 11 shows the library resized to 1280 pixels, to fit to a resized browser window. FIG. 12 shows the library with the left vertical navigation pane visible. Additional navigation is available on the left side of the screen and amounts to accelerated vertical scrolling through chart categories. FIG. 12 shows categories of “Performance”, “Investors & Analysts”, and “Revenue”. After clicking on Performance, the different subcategories are shown, including “Share Price,” “Relative Share Price” and “Total Shareholder Returns”, plus the number of library charts available for each subcategory. After a user selects one of the categories in the left-hand navigation pane, the charts in the right scroll vertically to reflect that category's position in the library

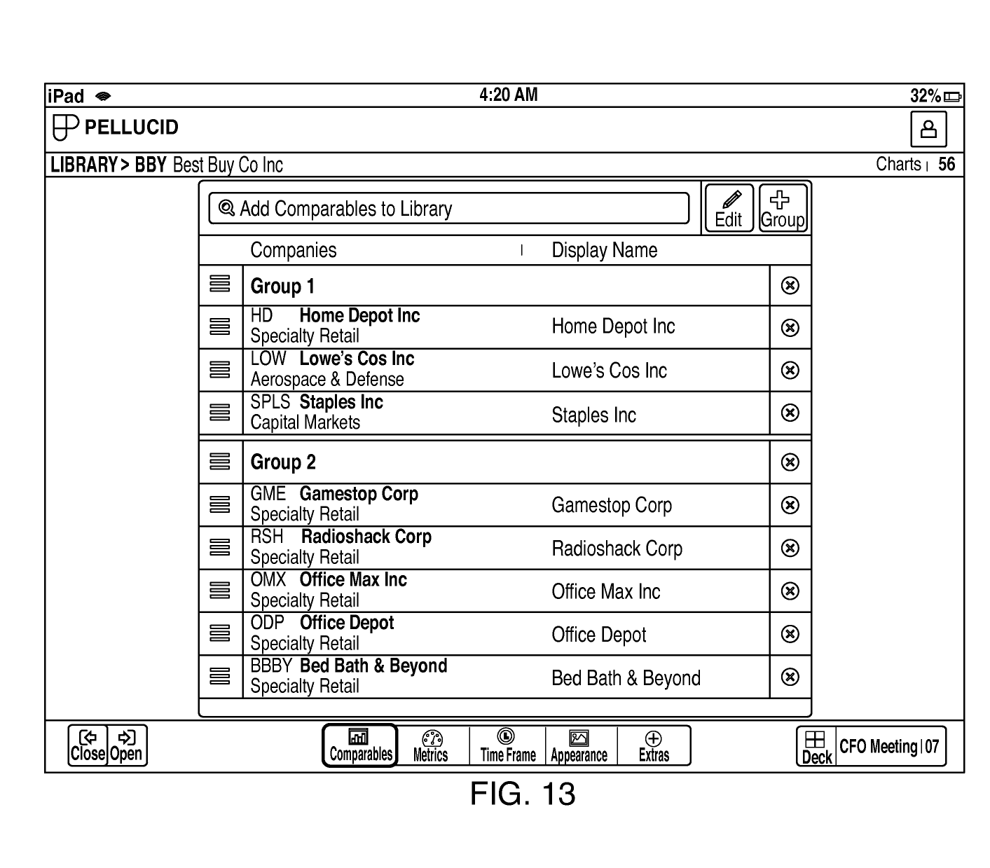

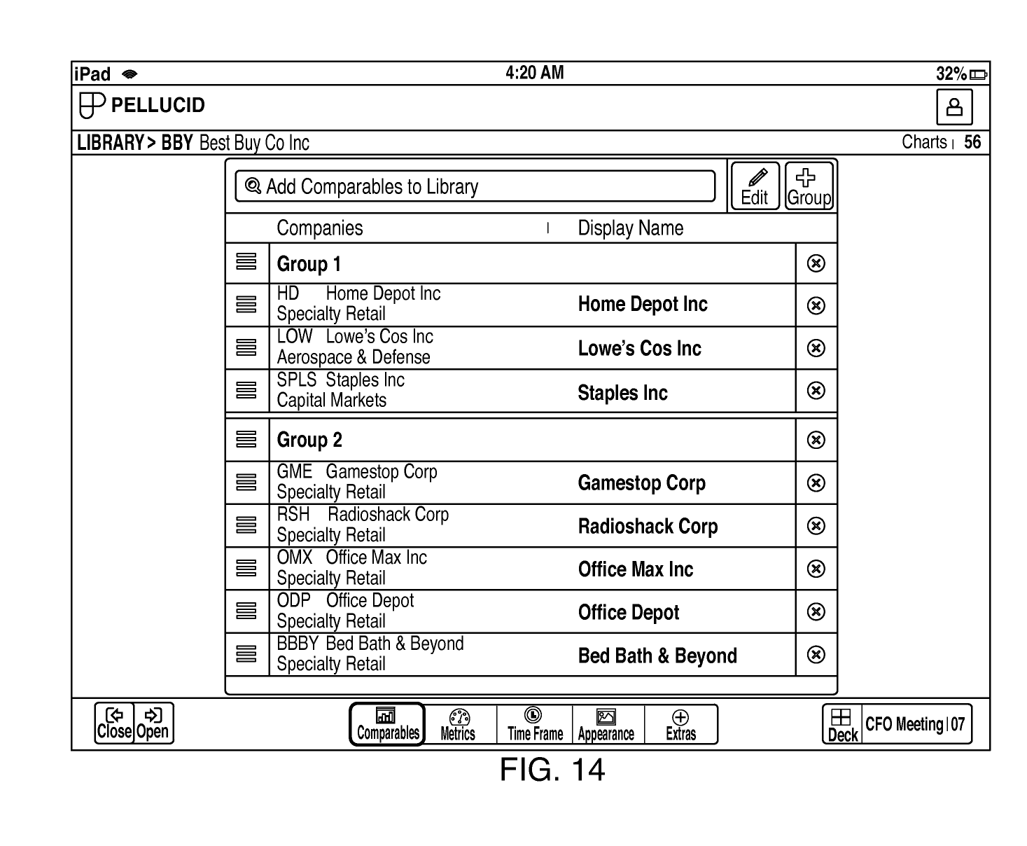

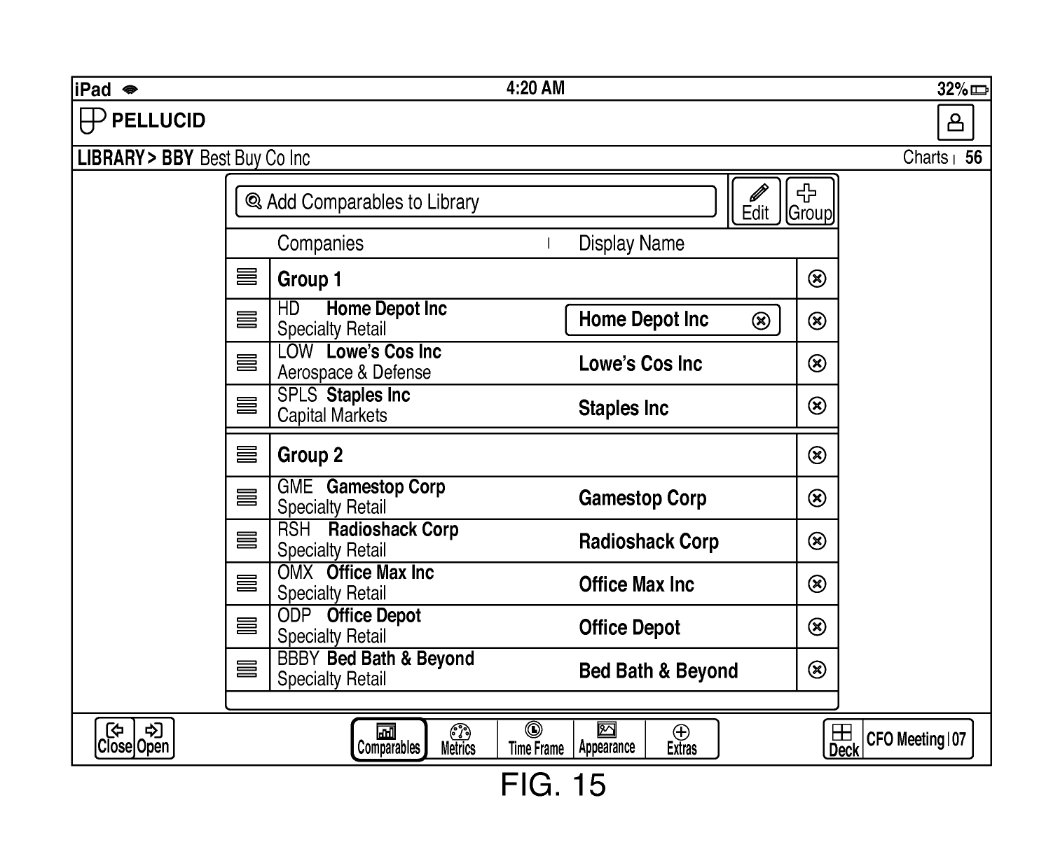

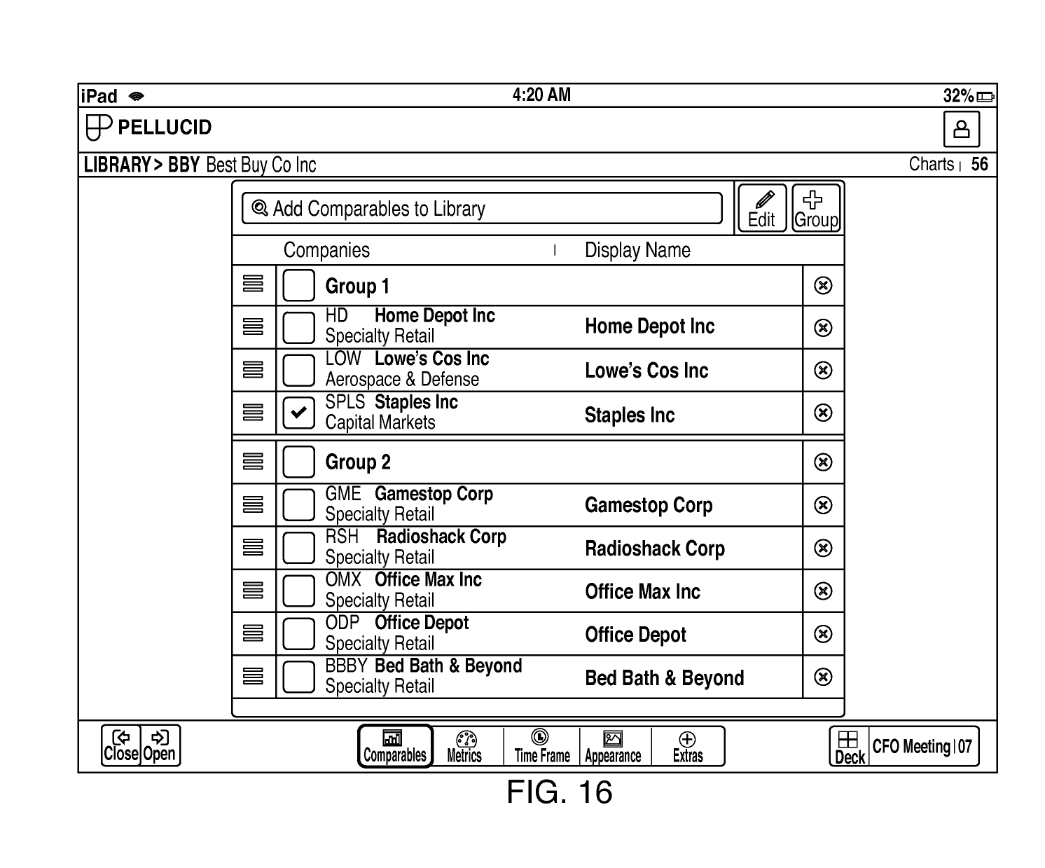

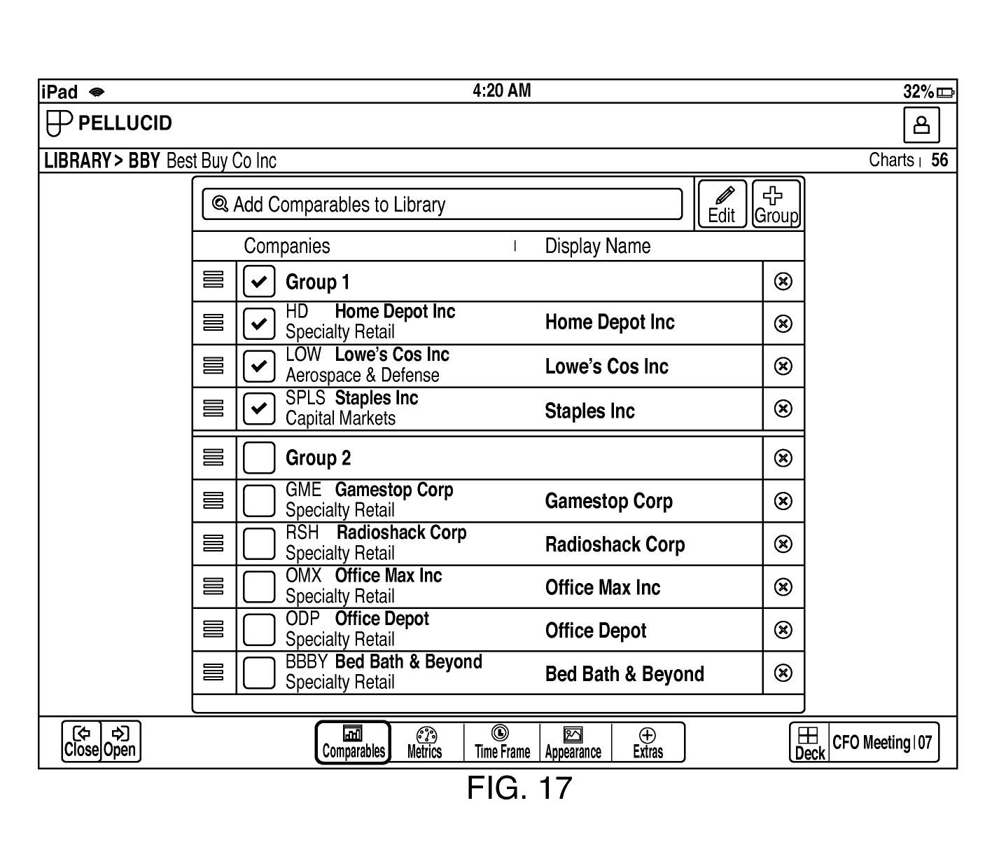

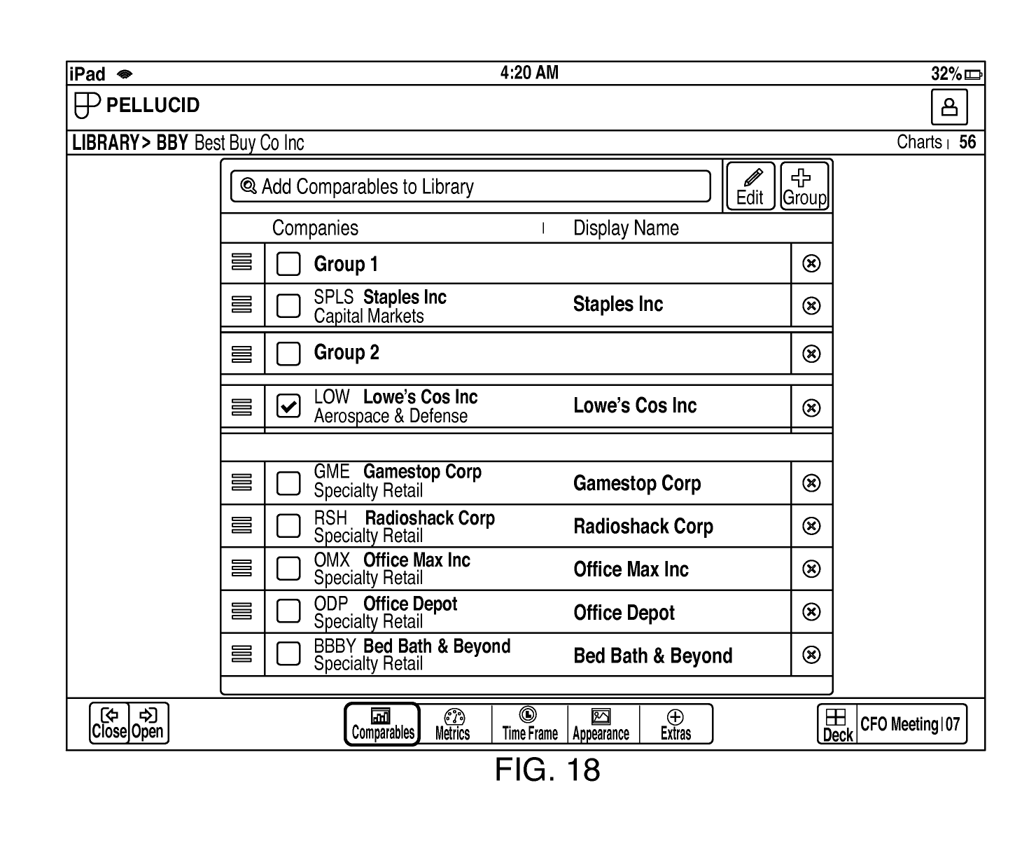

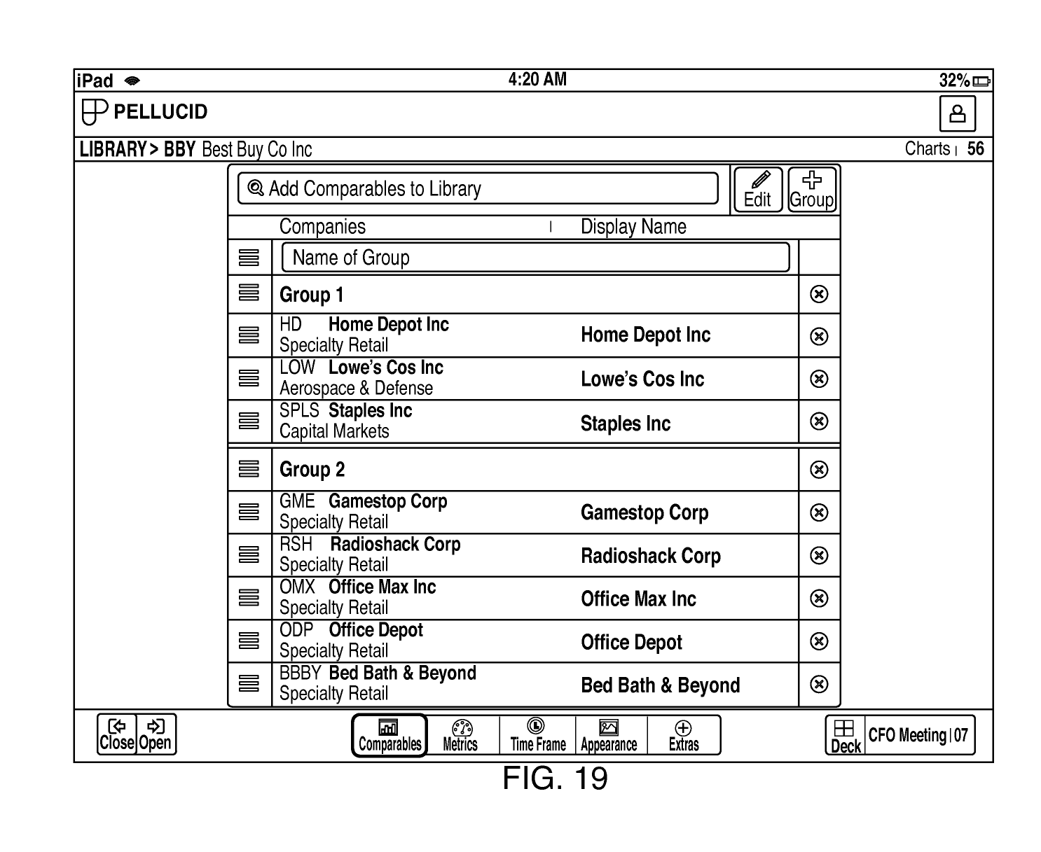

FIG. 13 shows the user being presented the option of adding comparable companies into the default charts of the chart library. A common chart pattern is to compare a financial ratio for the company in question to similar financial ratios for a set of comparable companies. In this Figure, the user is changing the list of comparable companies. Each Group in the figure contains candidate companies. Group 1 contains 3 companies and Group 2 contains 5 companies. In FIG. 14, the user is able to edit the comparables by selecting the edit button indicated with a pencil in the upper right hand corner of the window, or add a group by pressing the plus sign. A gray box is presented on the left side of each company's name as a means of selecting that company. Additionally groups, and companies within the group, can be removed by pressing on the ‘x’ located on the right side of the row. In FIG. 15, the user is editing the display name of the Home Depot Inc company. In FIG. 16 the user has clicked on the gray box to the left of SPLS. The box is then populated with a checkmark, to indicate that SPLS is selected. In FIG. 17 the user has pressed the box to the left of Group 1, after which each company within the group is marked with a check. In FIG. 18, the user has selected the Lowes Cos Inc and drags the row from Group 1 into Group 2. FIG. 19 demonstrates the process of adding a group to the Library. After the user selects “+Group”, the “Name of Group” field is highlighted prompting the user to enter the group name that he/she wishes to insert into the comparables list.

All charts are already in the relevant default format, based on the style guidelines of the bank. The application pipes data from one or more data vendors (e.g., Thomson Reuters or Bloomberg) into the system and provides full click-through auditing, down to PDFs of sources (e.g., SEC filings, annual reports). In addition, the system will allow users to revise the data in the system and broadcast that change to other users.

Data quality can be controlled in various ways. The user may simply trust the third-party data vendor or may check each data item himself/herself. In one likely use case, junior bankers within industry-specific coverage groups will be responsible for loading the vendor-supplied data, checking it and either confirming it or revising it. This improves the overall data quality for the app by adding an additional layer of checking and gives the senior banker someone to hold accountable within their own organization if the numbers are wrong (or perceived to be wrong).

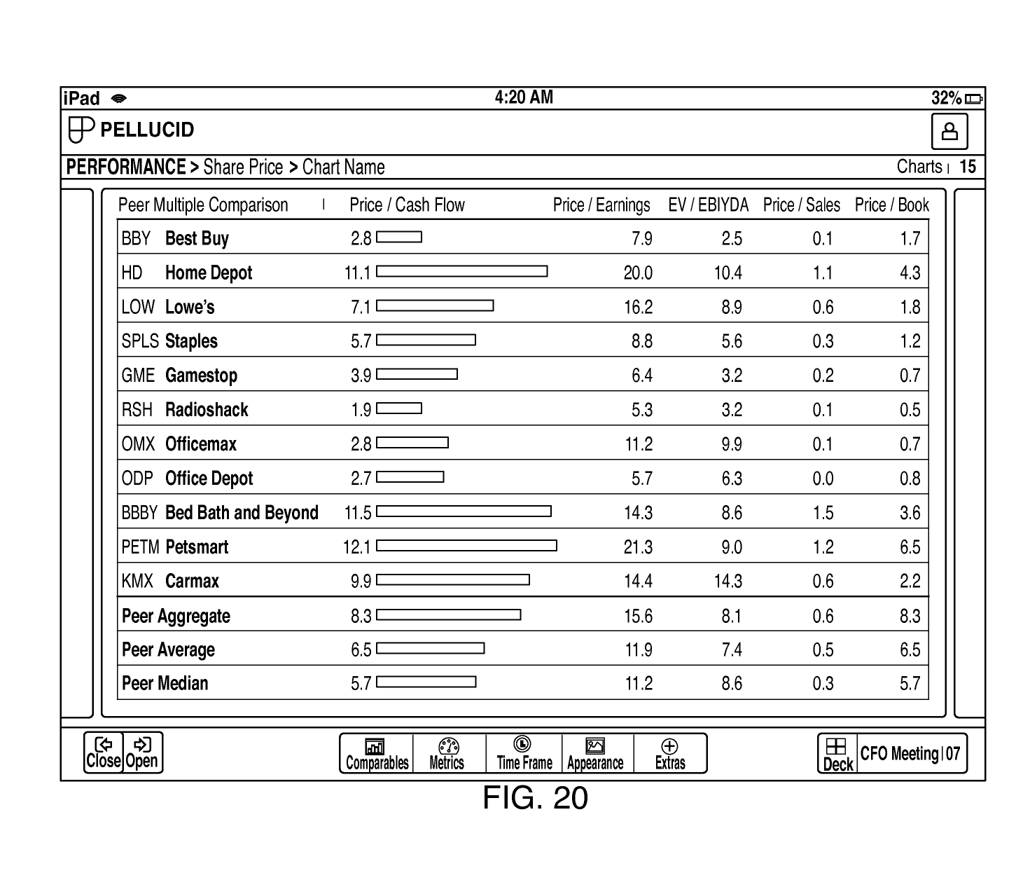

The “tweaking” step is described in FIGS. 20-30. The space of possible charts is huge so the application displays only common or representative charts and allows users to modify them. The application provides for an underlying set of chart archetypes (not explicitly displayed to the user) and each chart archetype has editable options (comparables, metrics, time frame, appearance and extras). For example, if the user sees a chart with 12 companies showing Price/Earnings he or she might tweak that by adding a 13th company and changing Price/Earnings to EV/EBITDA.

FIG. 20 shows the Peer Multiple Comparison chart. This chart shows the company ticker symbol, the company name, the price/cash flow ratio, the price/earnings ratio, the EV/EBITDA ratio, price/sales ratio, and the price/book ratio. This chart is tweaked by accessing the different tweak modes via the buttons below, either comparables, metrics, time frame, or appearance. The ‘Comparables’ selection allows the user to group companies and to add/remove companies from a group. The ‘Metrics’ selection allows the user to change which metrics are displayed on the chart. The ‘Time Frame’ selection allows to the user to adjust the time frame of the metrics. For example, the price/cash flow ratio may be tweaked to reflect the ratio over the last month rather than the last fiscal quarter. The ‘Appearance’ selection allows the user to adjust the appearance of the chart by changing the order of the columns, which columns have bars, the number format and various other aspects of the chart's appearance.

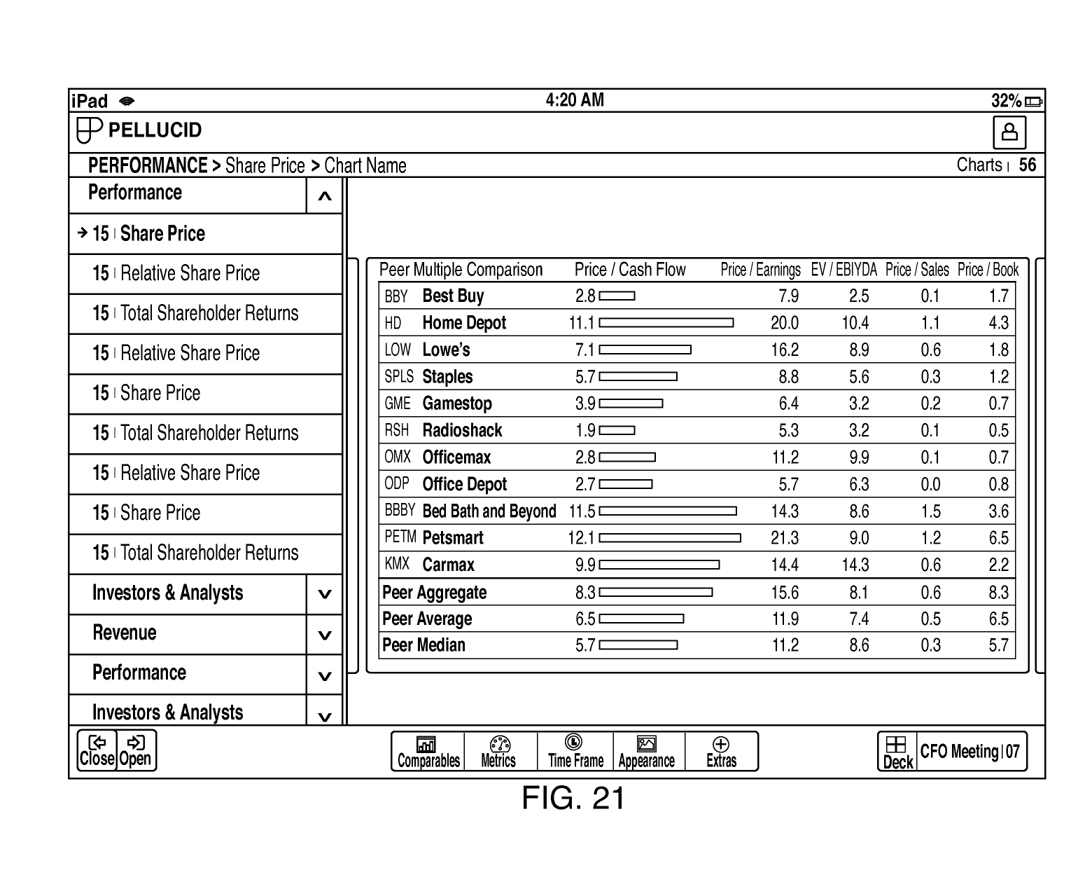

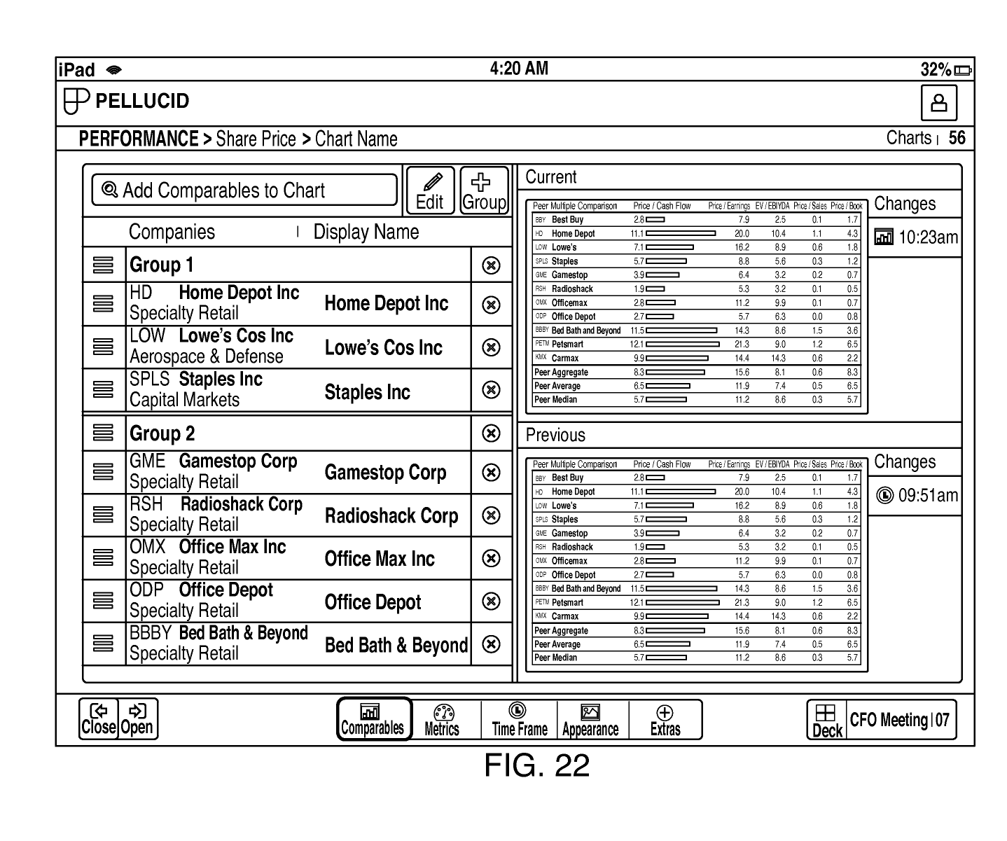

FIG. 21 demonstrates the navigation capability of the library while in detail mode, as the user is able to vertically scroll on the left and select which of the charts to tweak. In FIG. 22, the user has decided to tweak the comparables aspect of the chart. The previously edited chart is shown on the right-bottom of the screen. Also shown is the time when changes were last made to the previously saved chart (In FIG. 22, 09:51 am). Shown in the top right section of the screen is the chart currently being edited, as well as the time the chart was last saved (In FIG. 22, 10:23 am). As the user makes changes, versions of the chart are stacked on the right-hand side to provide a history of changes. Each version is nevertheless a fully functional object within the system and the user can rollback changes or drag previous versions of the chart into the deck.

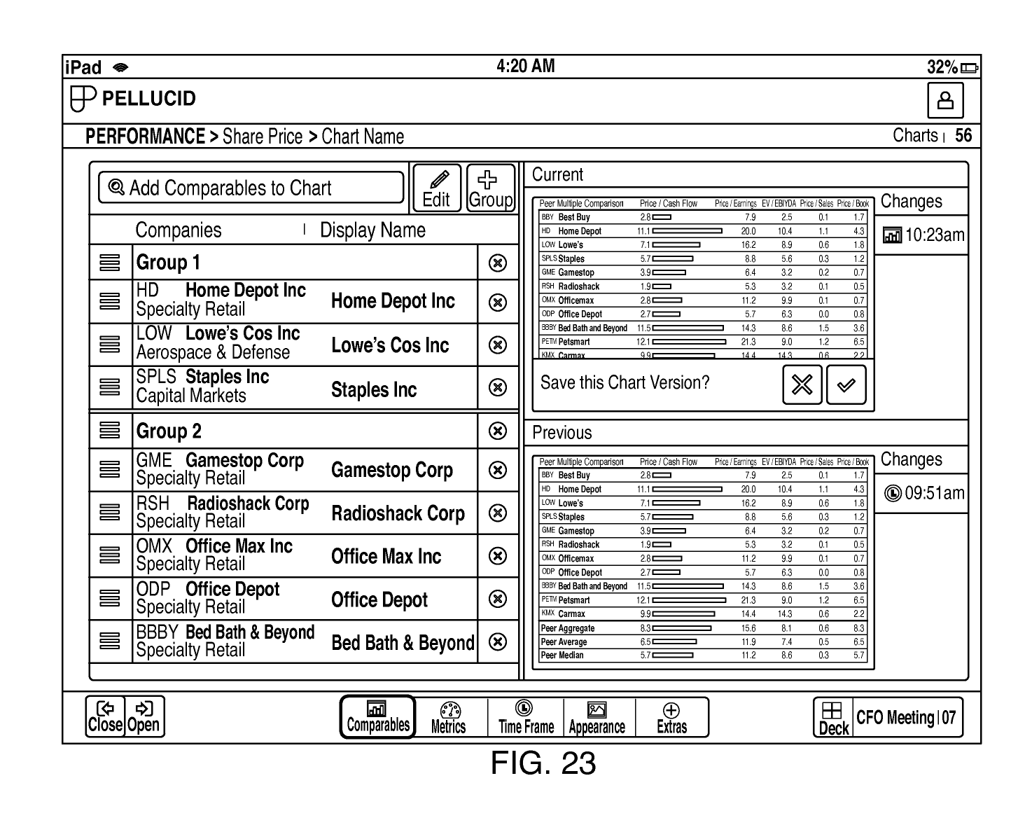

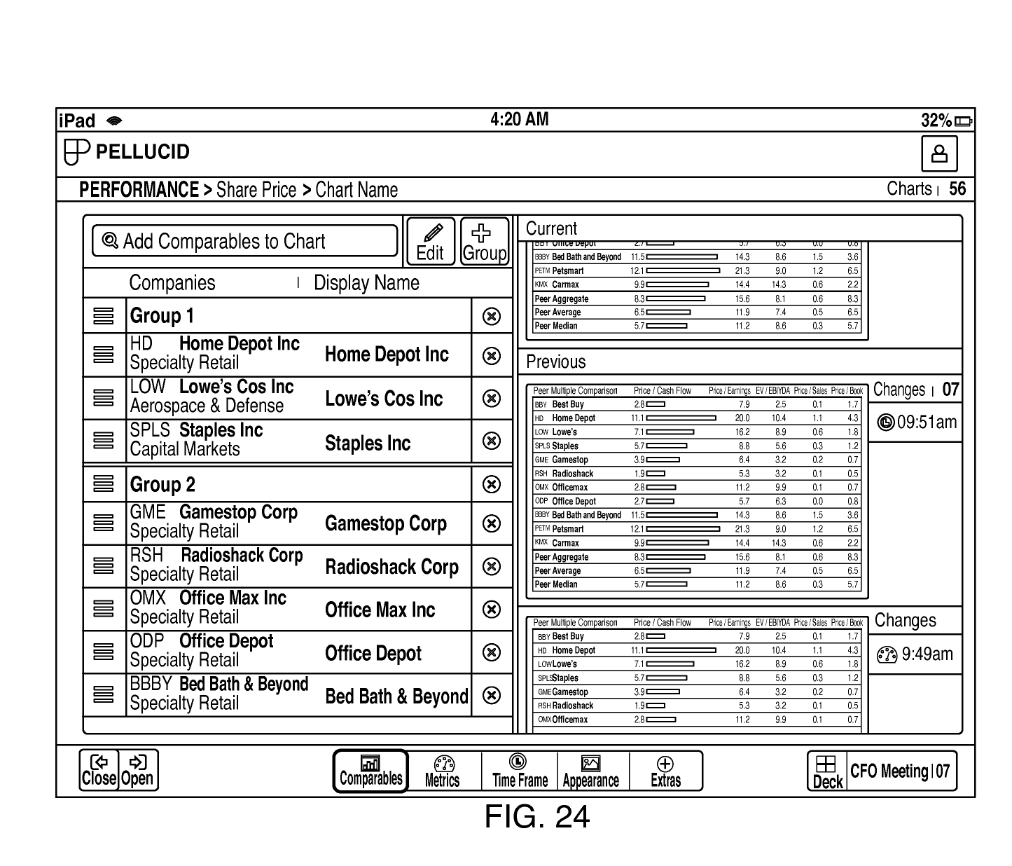

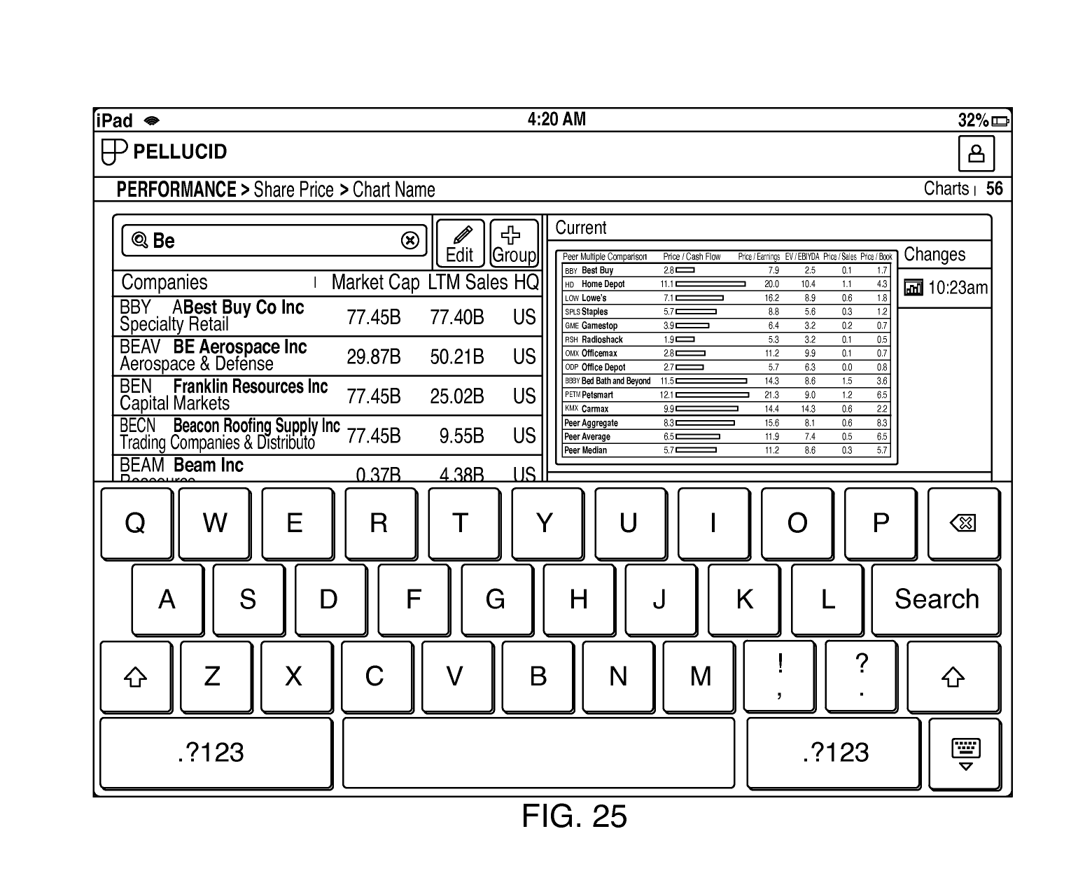

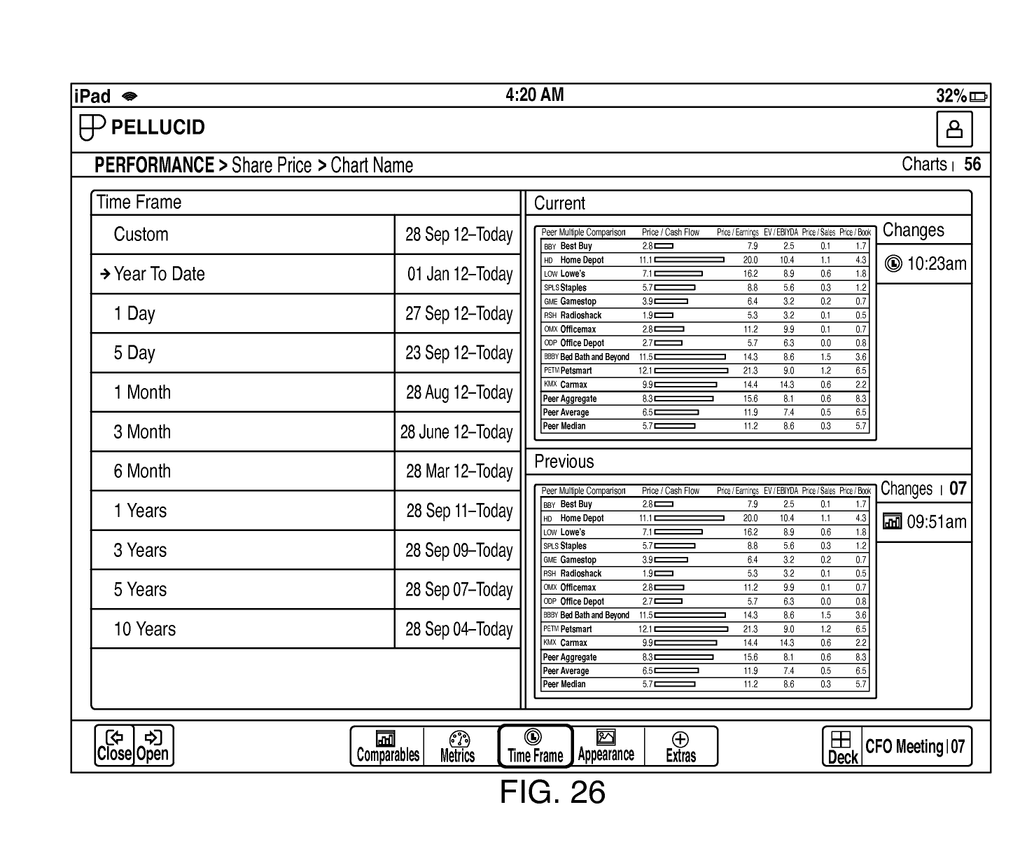

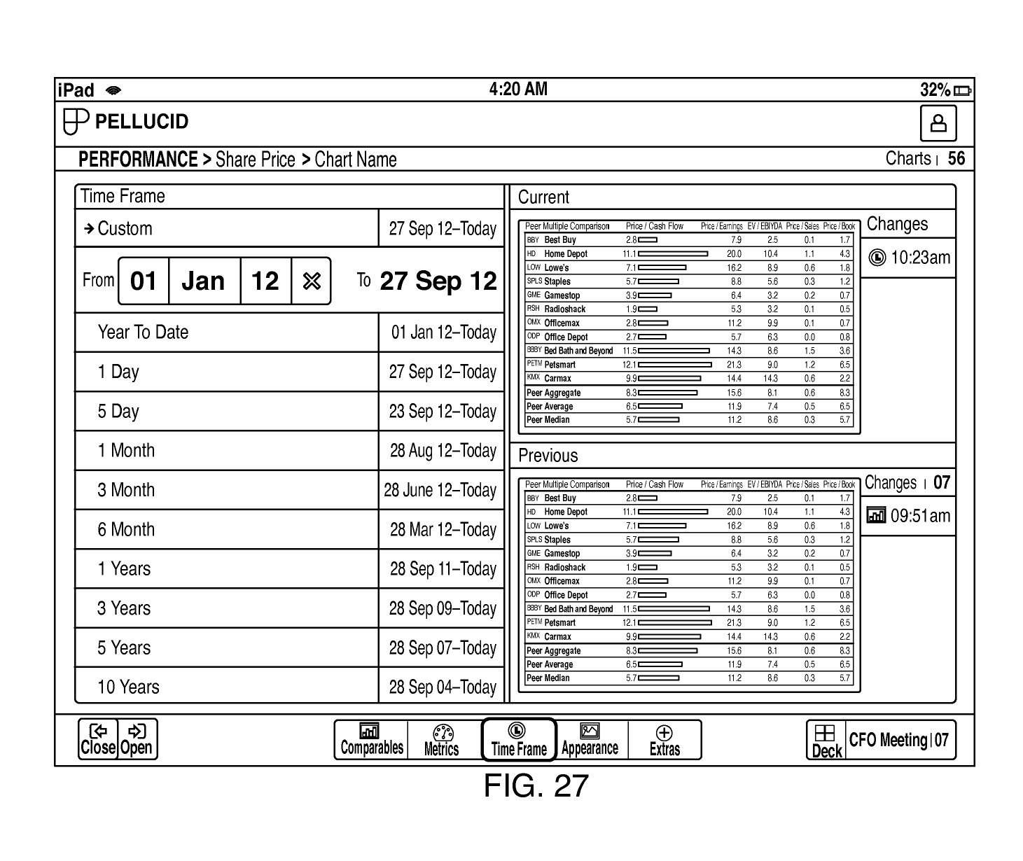

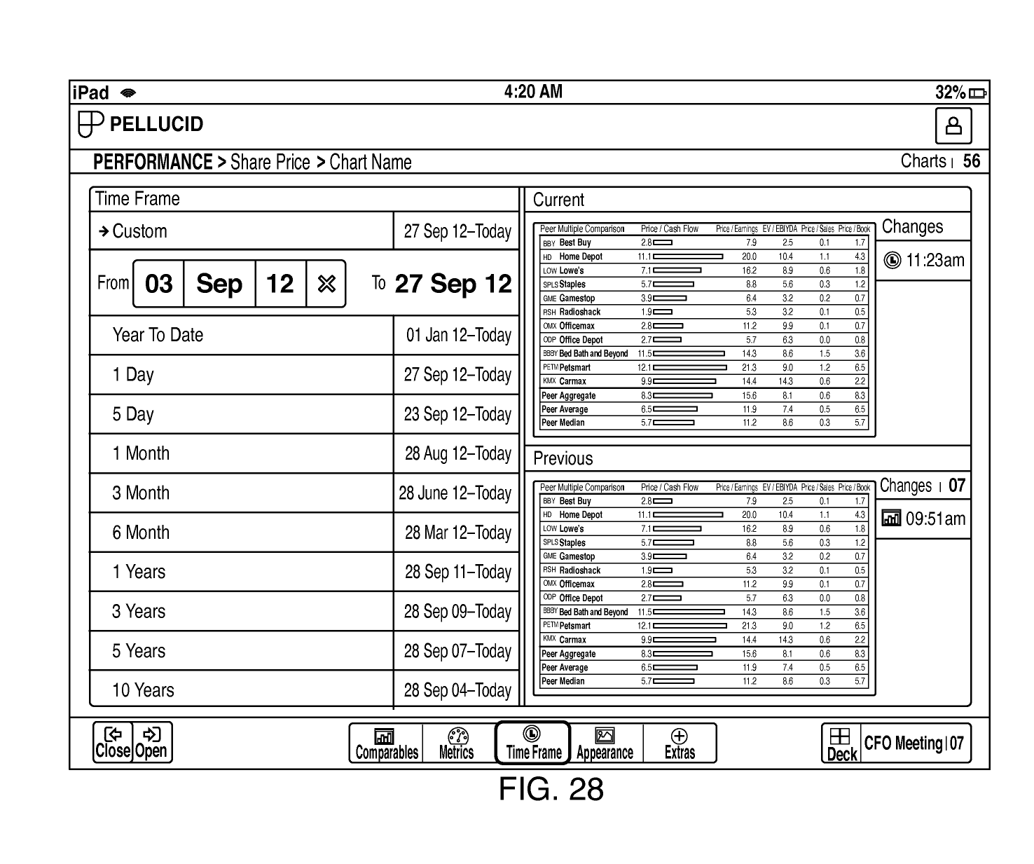

In FIG. 23, the user has tapped the current chart, indicating to the system to close out of it. The system asks whether the banker would like to save the current chart, and if so, the banker taps the check box, otherwise he/she taps the ‘x’. In FIG. 24, the user is able to add comparables to the chart through the pane on the left, and on the right is able to scroll through changes made to the chart. This iterative process exemplifies the review-reject-tweak model. FIG. 25 shows the user searching for a company to add to the current chart's comparables list. Here the user searches for “Be” and the comparables screen autofills with companies having tickers or names beginning with “Be”. Data associated with these companies, such as market capitalization, LTM Sales, and HQ are also shown on the comparables screen. FIG. 26 shows the system presenting the user with the option of changing the time frame of data shown. As shown in the figure, various lengths of time are available, including 1 Day, 5 Day, 1 Month, 3 Month, 6 Month, 1 Years, 3 Years, 5 Years, and 10 Years, but shorter, or longer, increments of time can be selected instead. For example, if a ‘Year To Date’ time frame is selected, then all the metrics shown in the chart will be based on the data since the beginning of the year. FIGS. 27 and 28 show the user making a custom time frame. In FIG. 27, the default ‘From’ date is Jan. 1, 2012 and the default ‘To’ date is the date the application is being run, here Sep. 27, 2012, as of 10:23 am. In FIG. 28, the ‘From’ date has been changed to Sep. 3, 2012 at 11:23 am. The system can also be such that different time frames are used for different metrics, and for different companies, not just for all metrics and all companies.

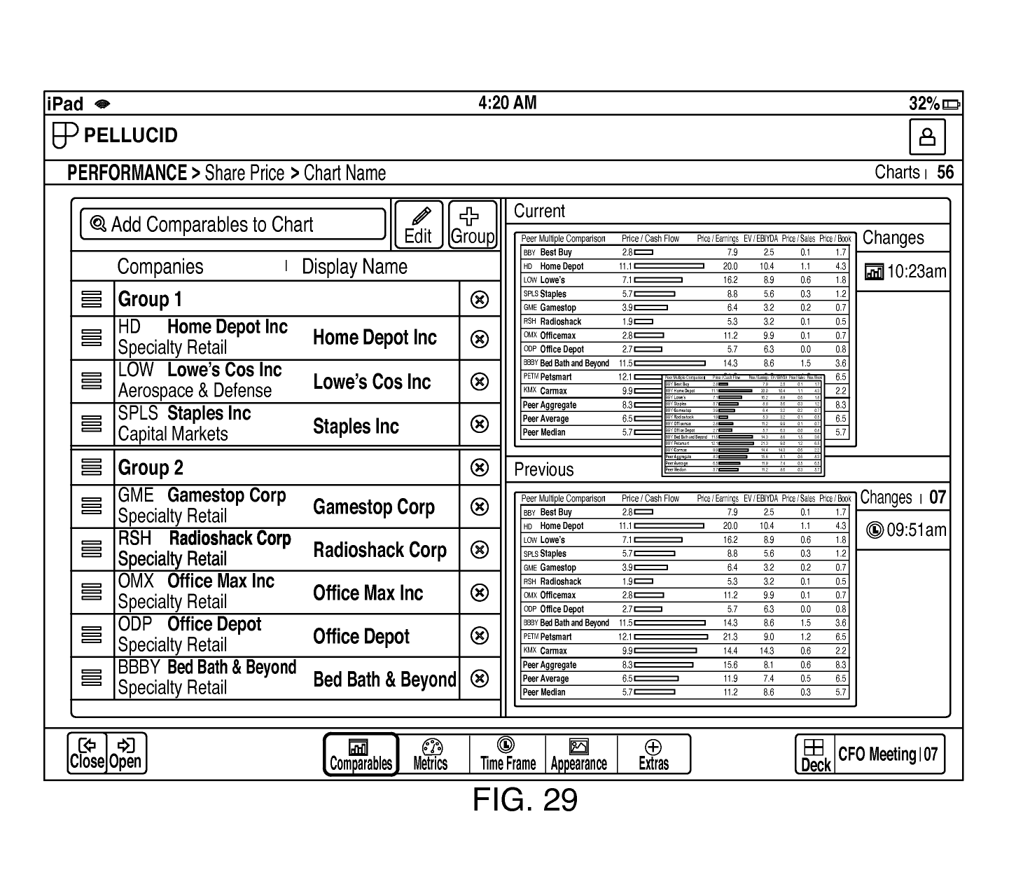

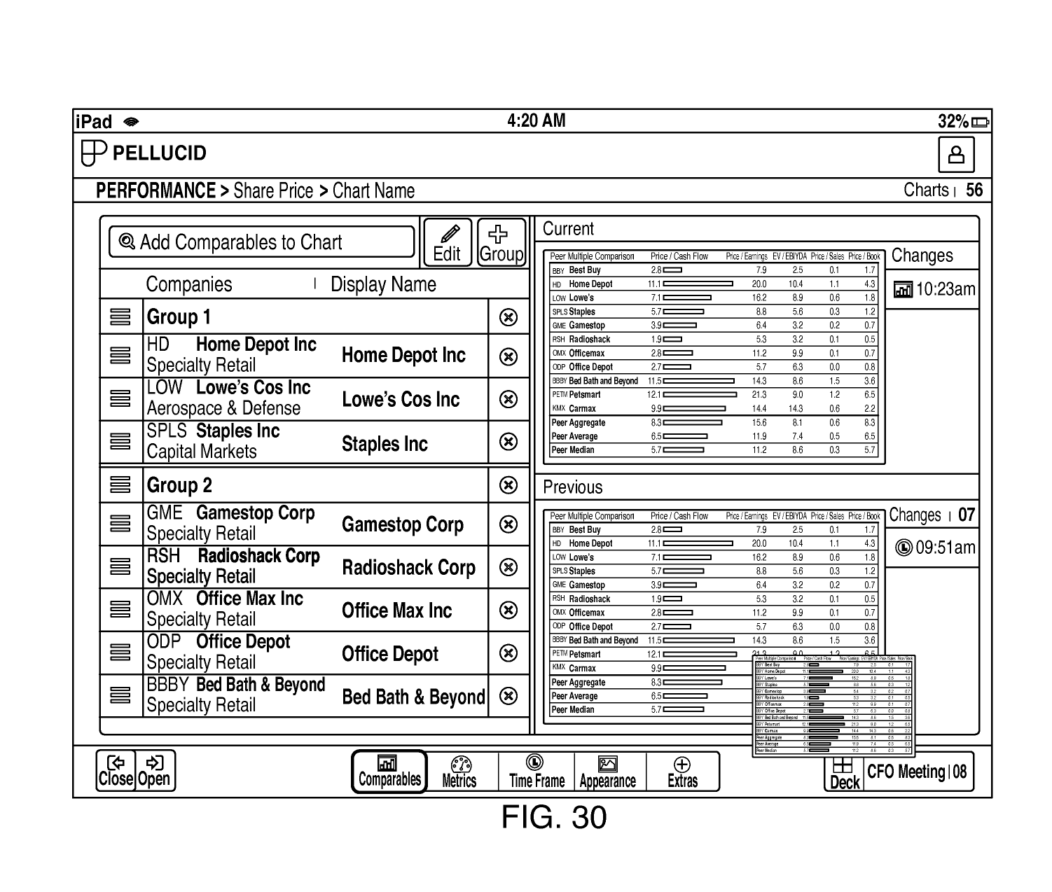

In FIG. 29, the user begins to drag and drop a completed tweaked chart into the CFO meeting deck. While doing this, the dragged chart is a fraction of the size of the original chart's display window, but contains the same visual content as the chart of original size. The silhouette of the location and size of the dragged chart appears in white on the screen. FIG. 30 shows the Peer Multiples Comparison chart being dragged into the CFO meeting deck. As such, the number of charts in the CFO meeting deck is now 8, up 1 from 7. The number of charts in the deck is indicated with a ‘08’ counter.

The user can make changes at a chart-by-chart level and invoke a system to track properties such as comparable companies and time frames across charts in a deck and the chart library to ensure consistency. The system knows which particular properties of which particular charts are linked to each other so that a change in one of these properties in one of these charts would propagate to linked charts, if the user desired. Users have control over how charts and the properties of those charts link to each other. See section C3.

In an alternative embodiment, different elements of the system (the chart library, the deck, each slide and each chart) would have one or more sets of assumptions and elements would, by default, reference the parent element. That is, placing a chart on slide would mean the chart inherited all the slides assumptions, which were in turn inherited from the deck. Of course, the user would be able to turn off this inheritance and explicitly set assumptions at each level.

This part of the application is also capable of incorporating an event alerts system. For each chart, a user can set an alert that notifies the user when data related to the chart satisfies user-defined threshold conditions. These events will be tracked by the system, the user will be alerted when that event occurs and the chart that they based the event on presented to them.

### More Detail on Step 3

Prior to this step, users have selected charts from the chart library and, now, they must be refined and arranged to create a finished product that is in a format that can be delivered to a client in a deck. This refinement involves deciding on the narrative, positioning charts on pages, combining multiple charts onto a single page, incorporating additional text and graphic components and ordering pages

On a given slide, the user can specify “boxes” which are holders for text, charts or other content.

Also in this part of the app, the user may add text around the charts. The embodiment supports the user easily entering text WYSIWYG style or using text markdown. In addition, intelligently generated sample text may be generated based on the charts chosen to assist the user in writing (similar to the hallmark.com website which prompt various sentiments when you are designing a card).

The system also ensures that all decks have a cover and disclaimer page and, if necessary an automatically generated Table of Contents.

The embodiment has the ability to export to Microsoft PowerPoint format and, alternatively, directly to PDF.

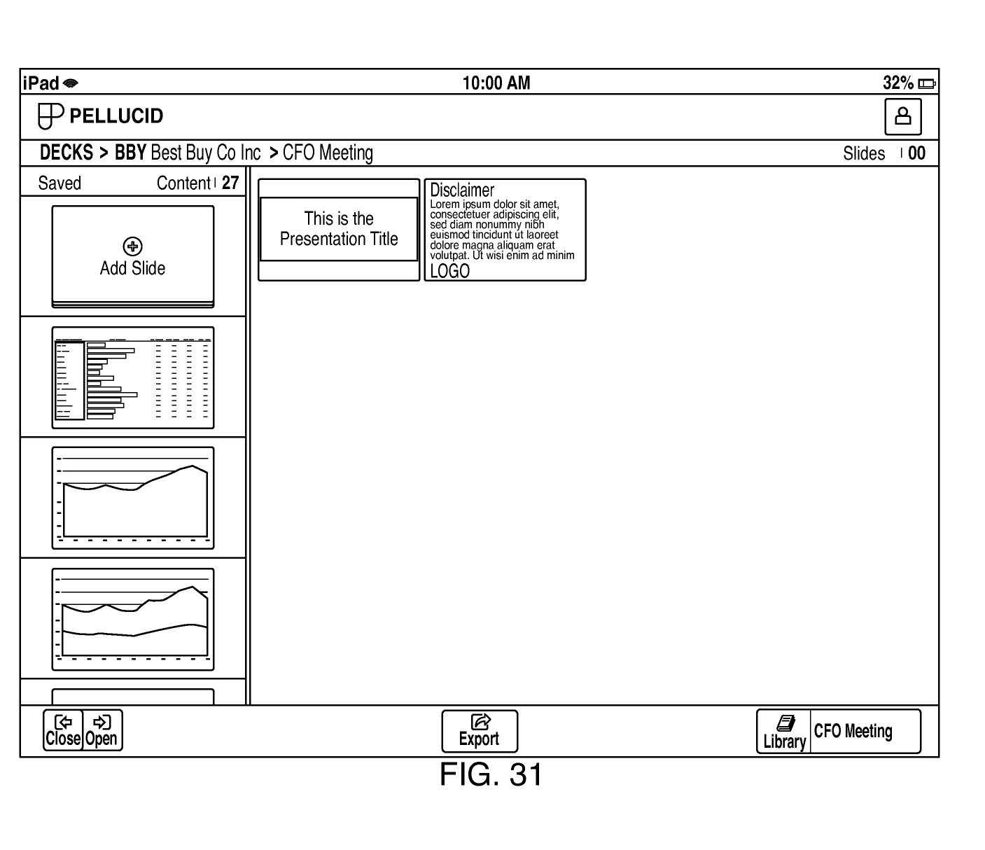

FIG. 31 shows a new deck with a cover and disclaimer styled according to bank specific branding guidelines. The charts that were added from the library are displayed by default in the left content rail. This rail can be opened or closed per the users need. Tapping on “Export” will save the deck out as a PowerPoint file. On the iPad, a file will be saved out and attached to an email for portability. Alternatively on the desktop a PowerPoint file will be saved out to the user's specified location. To go back to the library the user can tap the “Library” icon. If the deck name is tapped the name becomes editable. A deck without a user generated name will default to a deck name based on a date/time stamp.

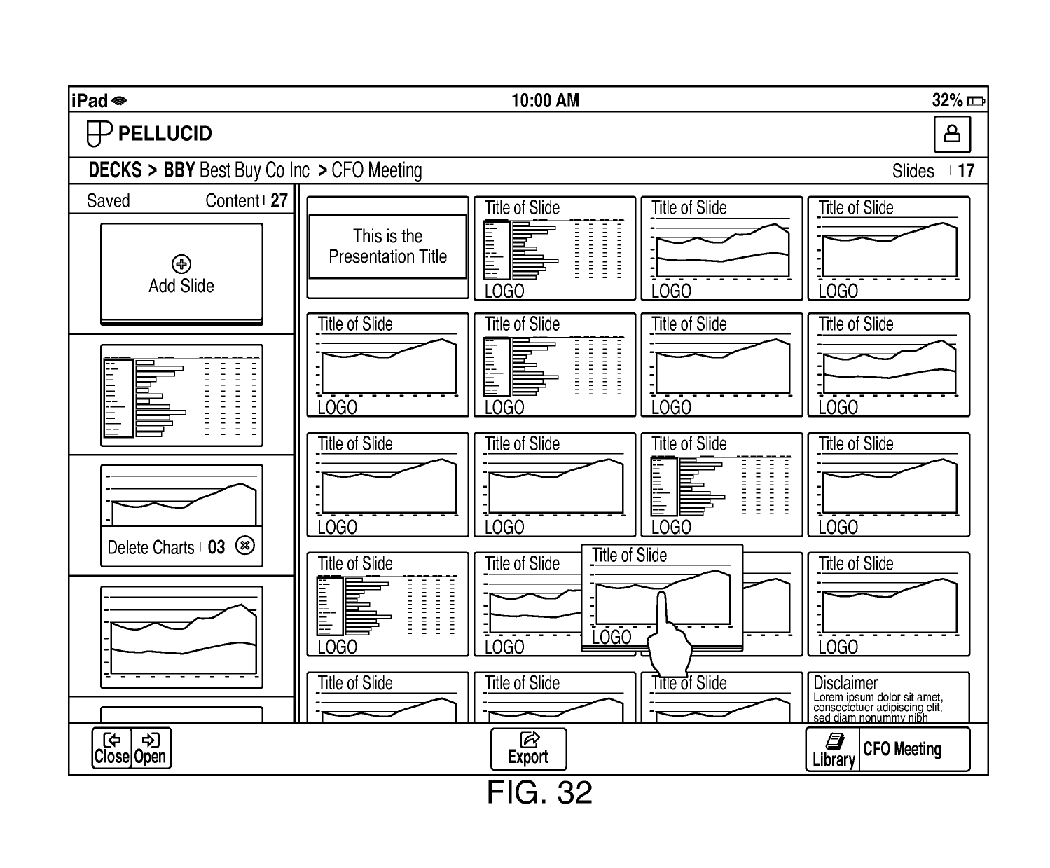

FIG. 32 shows a deck in progress with the content rail open. Charts and slides can be selected singularly or in multiples for addition to the deck or for deletion. The last chart selected will display an aggregate count of the charts chosen and the ability to delete them or move them. Charts can be moved from the rail onto a slide (a slide allows upwards of nine exhibits which could contain either text or chart image) or alternatively wherever they want to create a new slide. Blank slides can be added prior to the disclaimer by tapping on the “Add Slide” button. Additionally through a tap and hold, blank slides can be dropped wherever the user sees fit.

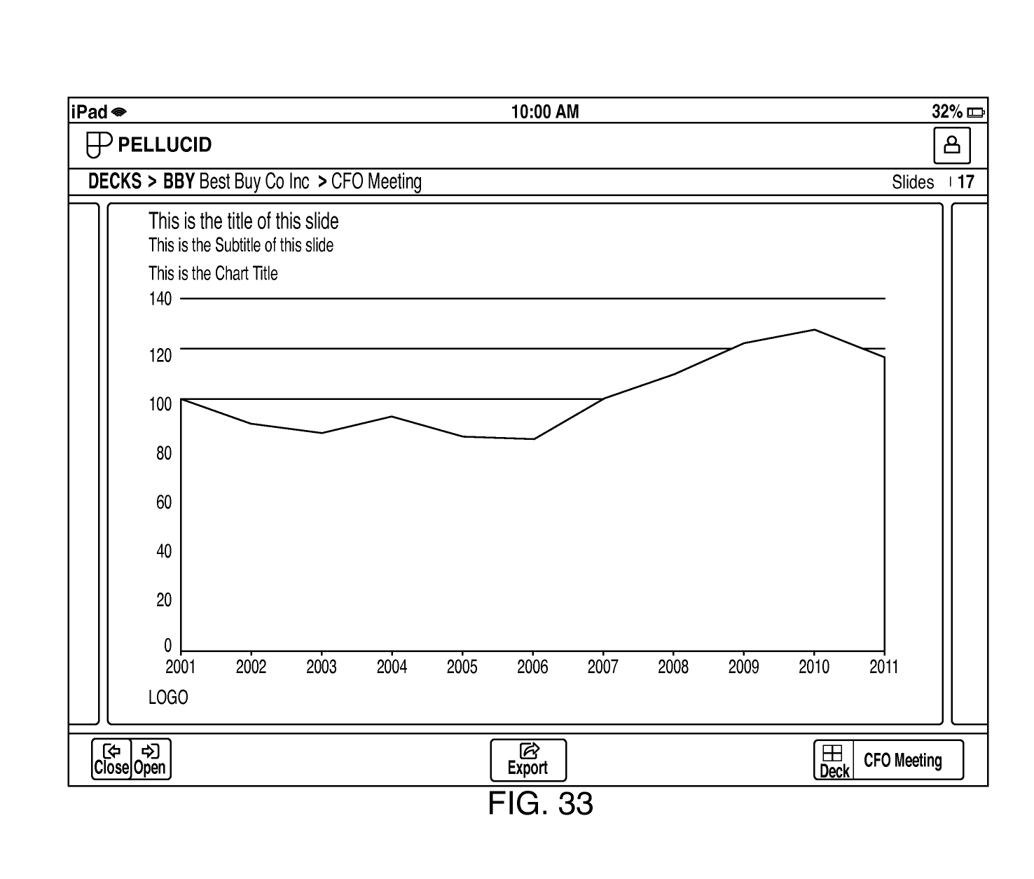

FIG. 33 shows a slide detail with a single exhibit layout. From the view of FIG. 32 when the user double taps on a slide they are “Zoomed in”. This view allows for left and right swiping to navigate to the other slides in the deck. The content rail is also present at this level, giving the user the same functionality they had on the deck view. The lower right “Library” button has changed to “Deck”. Tapping this button will take the user back to the Deck Management view with the slide thumbnails.

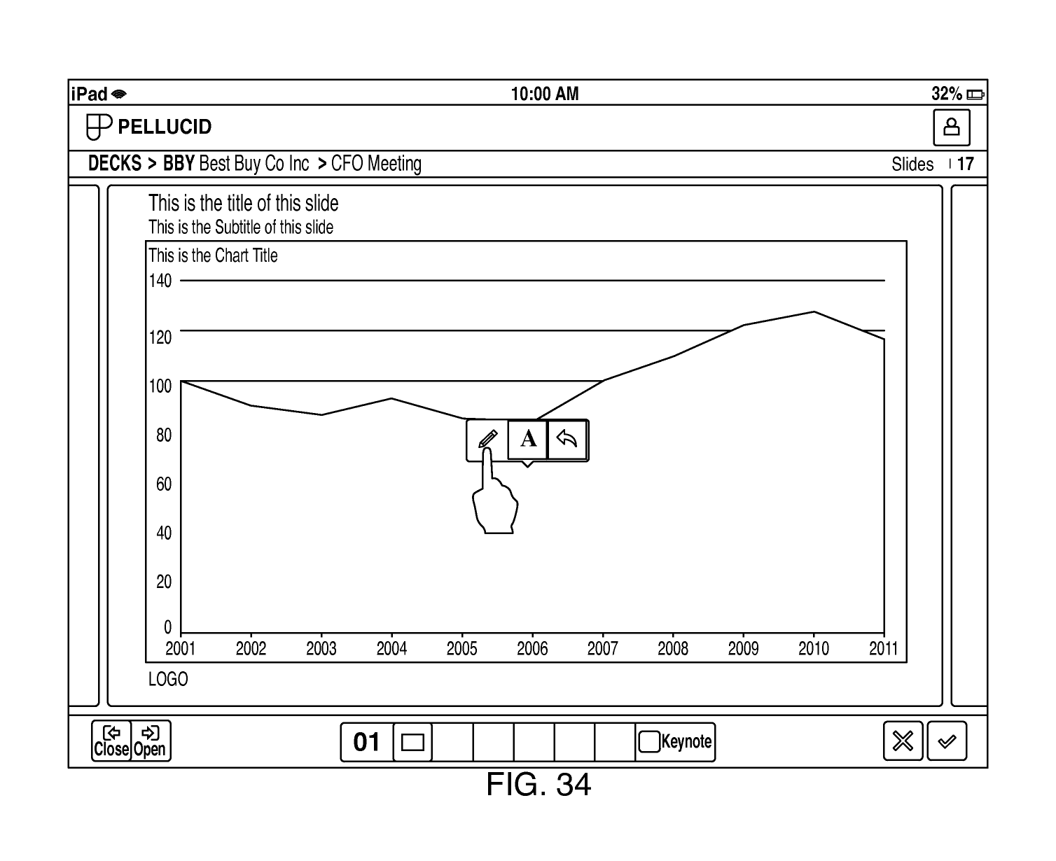

FIG. 34 shows a slide detail with a single chart layout. The user has selected the content area, in this case selecting the single chart. A contextual menu pops out in correspondence to the tap. The “Pencil” button allows the user to edit the chart's various components and mirrors the functionality and display of chart editing in the Library. The “A” button allows the user to edit the header of an exhibit (either chart or text). Depending on branding guidelines this header should be formatted by default per specific bank guidelines. The “Left Arrow” button sends the selected content into the rail. Alternatively content can be picked up and placed into the rail through a tap and hold. With layout mode engaged the export functionality has been replaced by a layout editor. The user can swipe the number up or down to increase or decrease the number of exhibits a slide will contain. Up to six layout options per exhibit number exist. Once the user finds the appropriate layout, tapping it will render the layout on the current slide. When the user is done with his/her edits, the “x” or “Check Mark” will let the user “Cancel” or “Accept”. Either of these actions effectively exits the user out of Layout Mode.

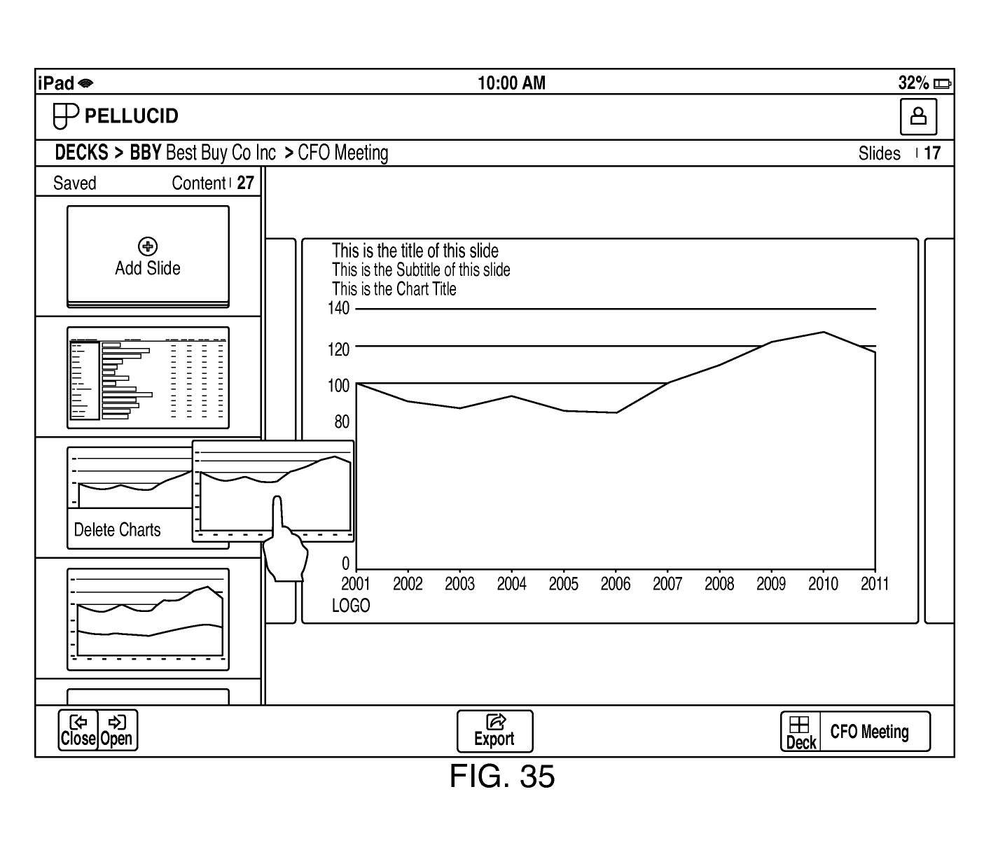

FIG. 35 shows a slide detail with a single exhibit layout. The user has opened the content rail, temporarily disengaging “Layout Mode”. With the rail open the user has the same functionality as in the deck view. As before, the user can single or multi-select content in the rail to move it onto a given slide. If the current layout used doesn't support the number of content pieces being moved, the exhibit number will change to accommodate and a default layout will be served. Alternatively if the current layout chosen will support additional content, the exhibits will be filled according to the order they were selected. Content can also be added to the rail through two methods. Either tapping on the content and using the “Left Arrow” button on the context menu or simply picking it up and moving it to the left side of the screen. Blank slides can be added in the same manner as on the Deck view.

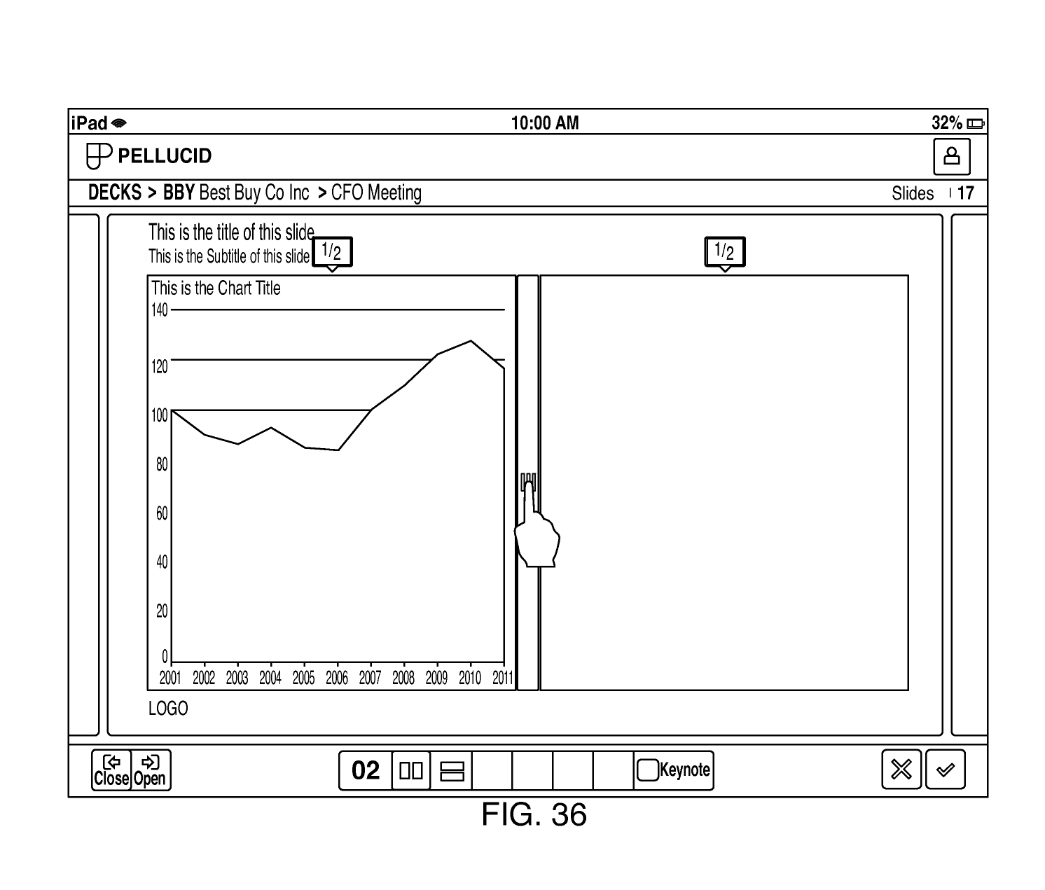

FIG. 36 shows a slide detail with a multiple exhibit layout. The user has tapped the space between two exhibits and a grabber bar has appeared. Above each of the exhibits is a tooltip with a fraction being displayed representing the horizontal or vertical size in relation to the active area. The user in this instance has the ability to increase or decrease the size of the exhibits by dragging to the left or right (alternatively top or bottom depending on the selected layout) snapping to increments of every quarter, third, and half of the active area. The space between the exhibits is contingent on branding guidelines specific to the organization.

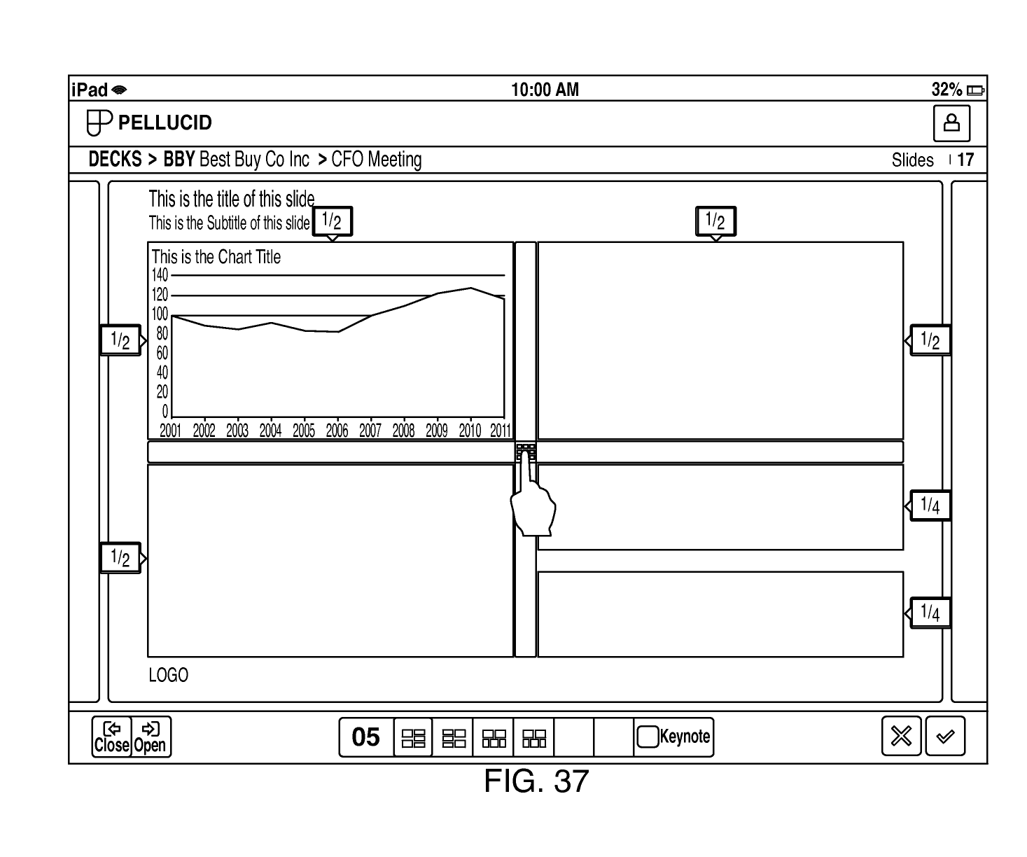

FIG. 37 shows a slide detail with a multiple exhibit layout. The user has tapped the center between exhibits where a vertical and horizontal space converges. This action allows for multiple exhibits to be adjusted horizontally or vertically at one time. The tooltips provide feedback to the user as they adjust the boxes snapping to the quarter, third, and half measurements.

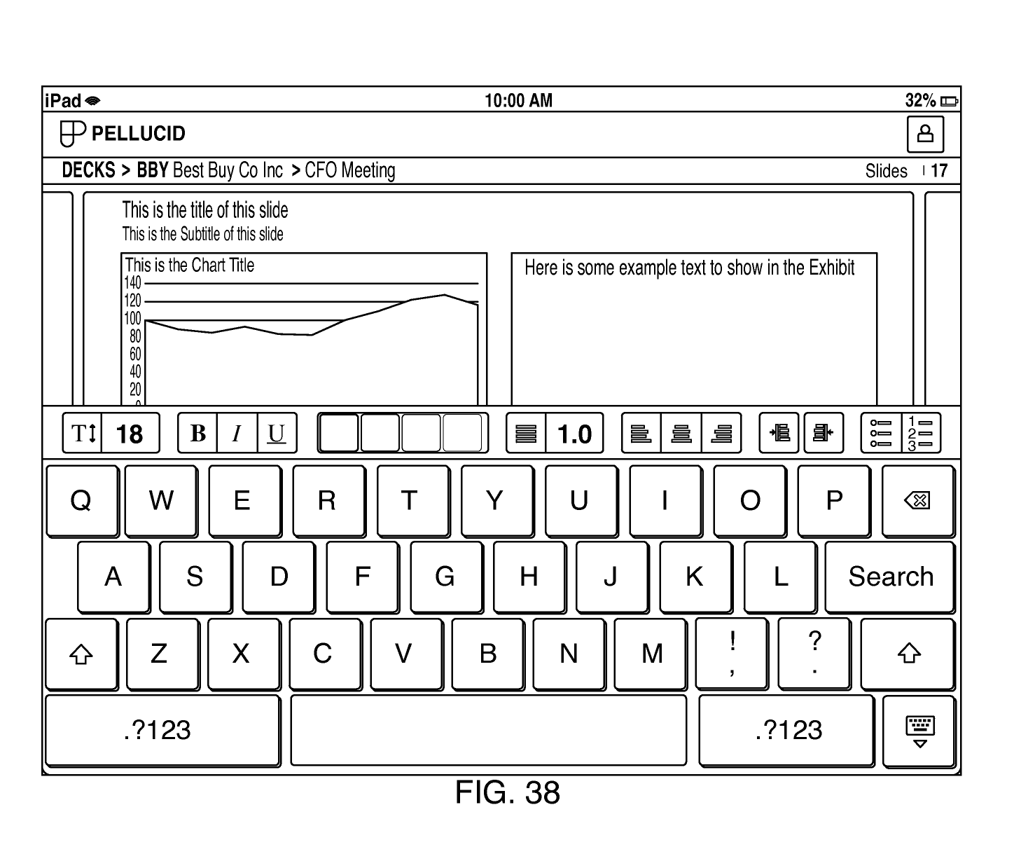

FIG. 38 shows a slide detail with a multiple exhibit layout. The user has tapped on the upper right exhibit and selected the edit button. Alternatively tapping the header button will also engage the type editing features. Smart defaults (according to brand guidelines) will exist whether you are typing out an exhibit slide title, chart header, bullet point, etc. . . . From left to right the various text features include size, style, color, line spacing, alignment, tab level, and bullet types. Text can be tapped and selected with a contextual menu giving further options of cut, copy, and paste. Spell check occurs as you type, indicating when a word has been misspelled and helping to suggest words you might have meant to type instead.

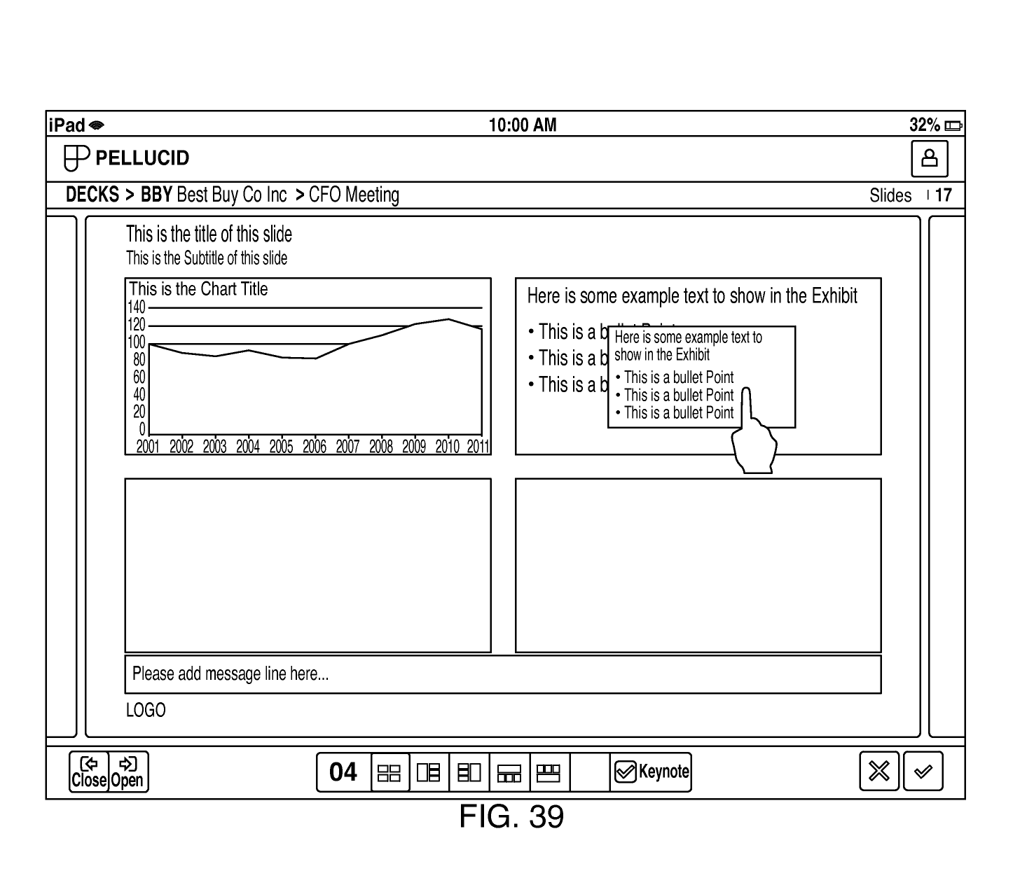

FIG. 39 shows a slide detail with a multiple exhibit layout. The user has tapped and held on the text exhibit popping it out of the slide. From here the user can swap the text with the chart to the left, move it to a blank exhibit or drop it in the content rail. This slide also displays an example of the keynote option being “Checked”. A message line exhibit is added to the active area adjusting the current layout in order to accommodate it.

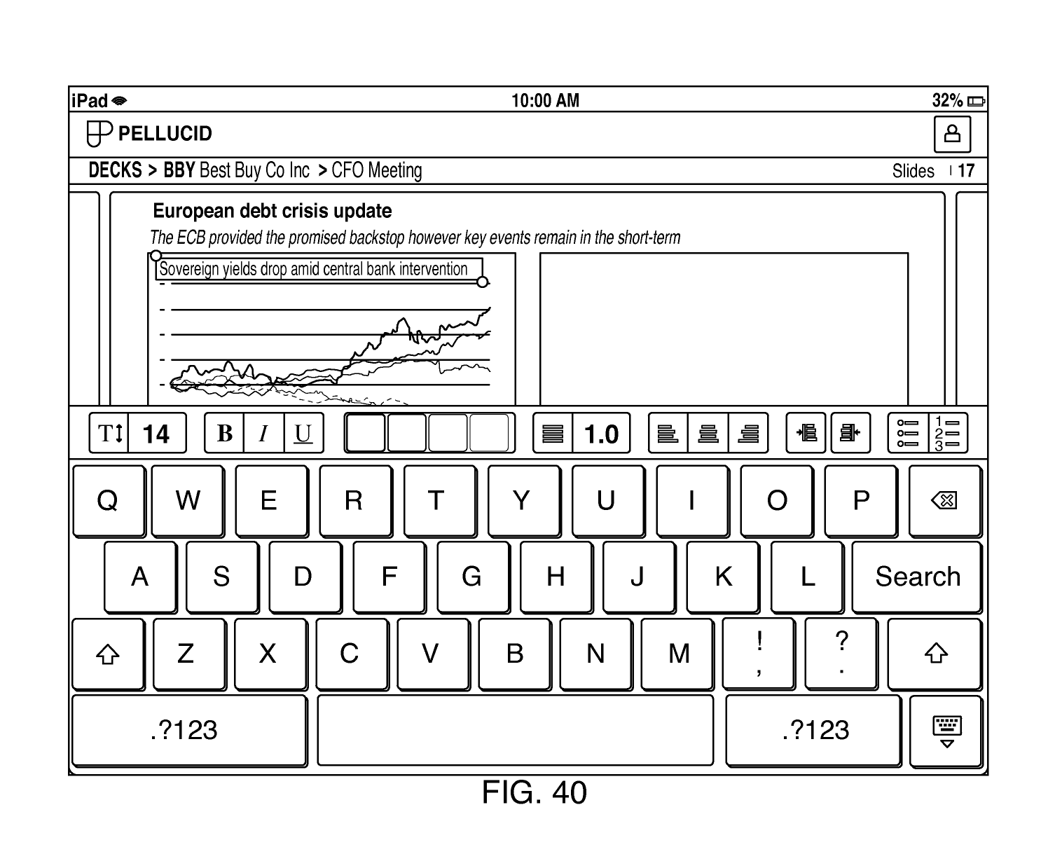

FIG. 40 shows a slide detail with a multiple exhibit layout. The user has tapped on the upper left exhibit and pushed the edit button on the contextual menu. Both charts and text areas can have a header entered. Headers will be styled according to specific brand guidelines by default. This can include ornamentation of some kind that will render with the addition of an exhibit header. For example, a colored line could be rendered below the text that extends the width of the containing exhibit.

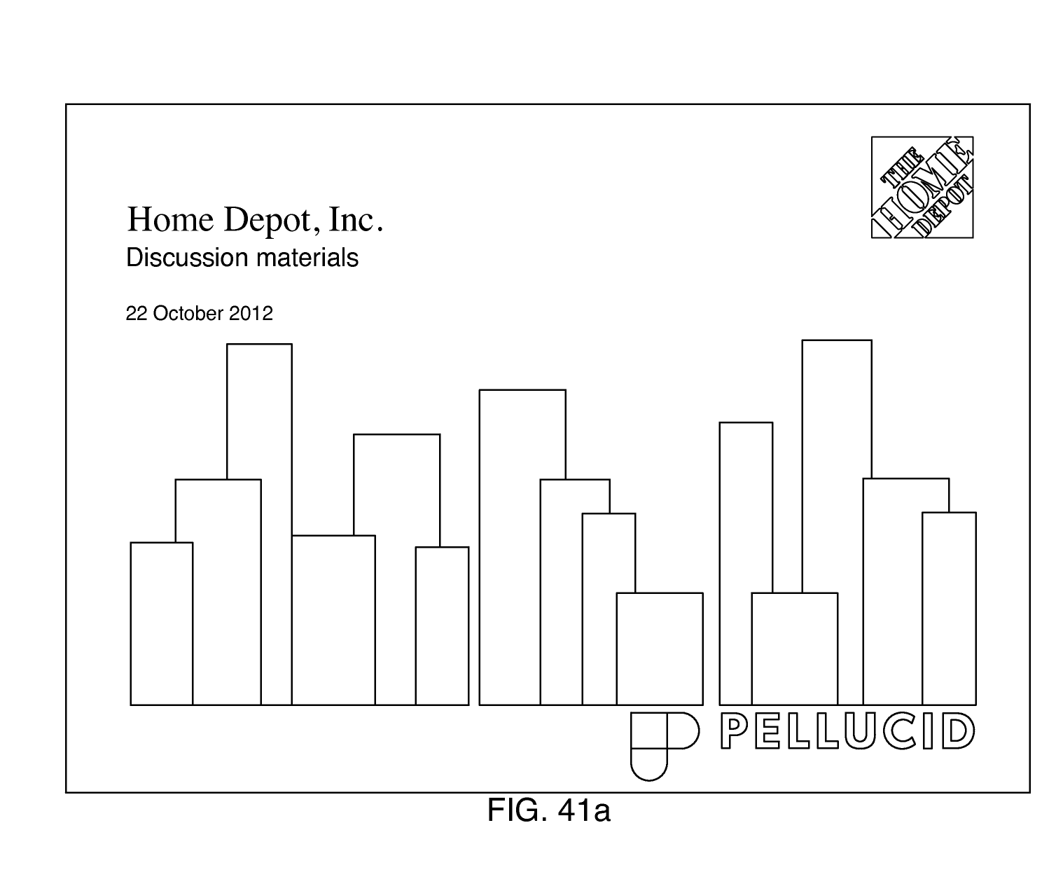

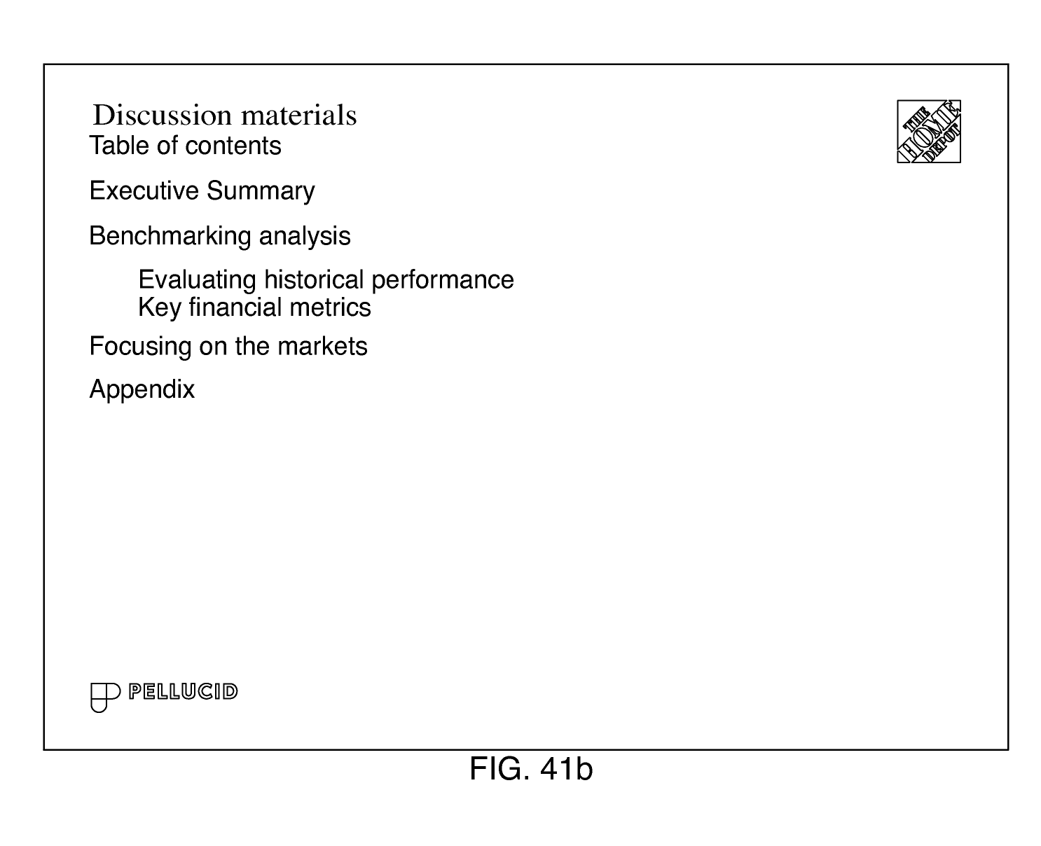

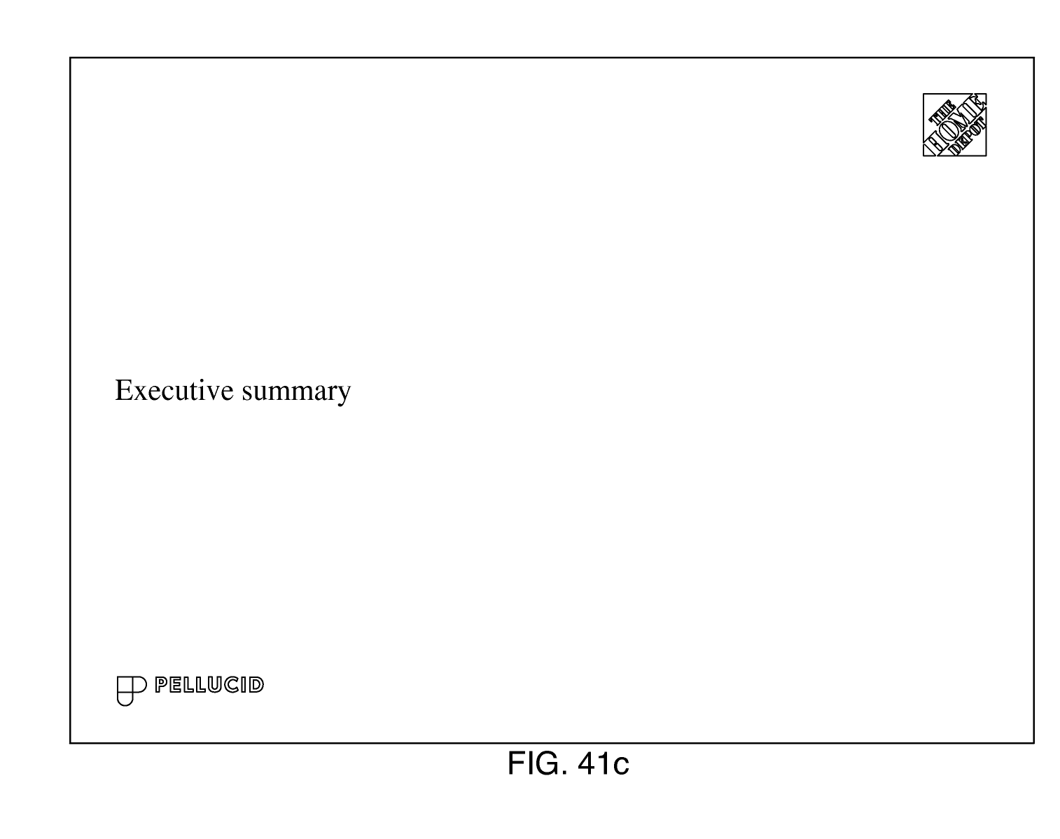

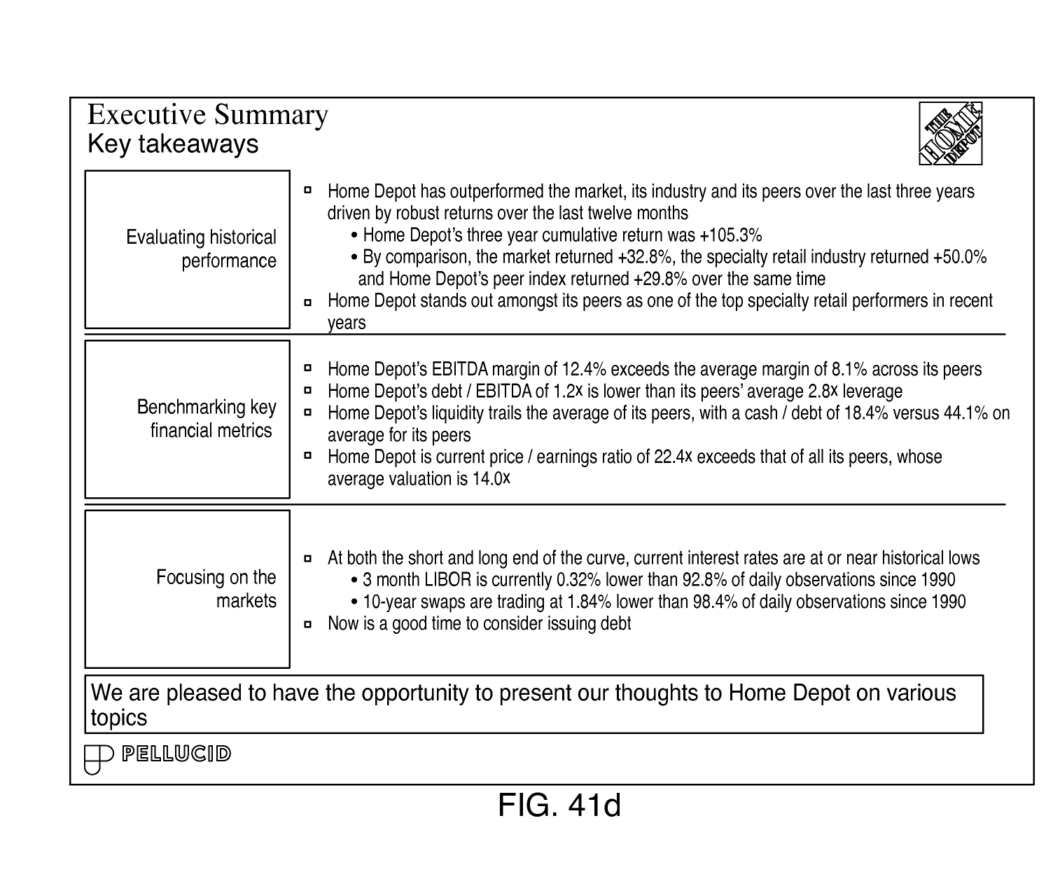

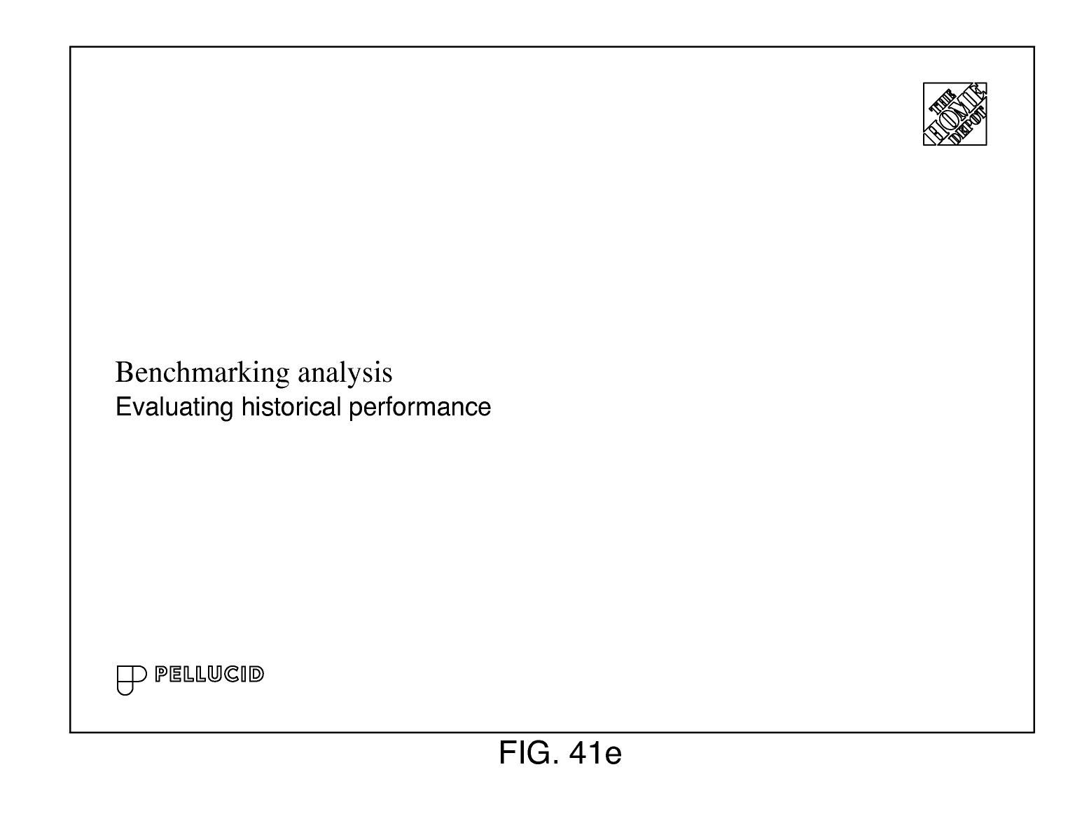

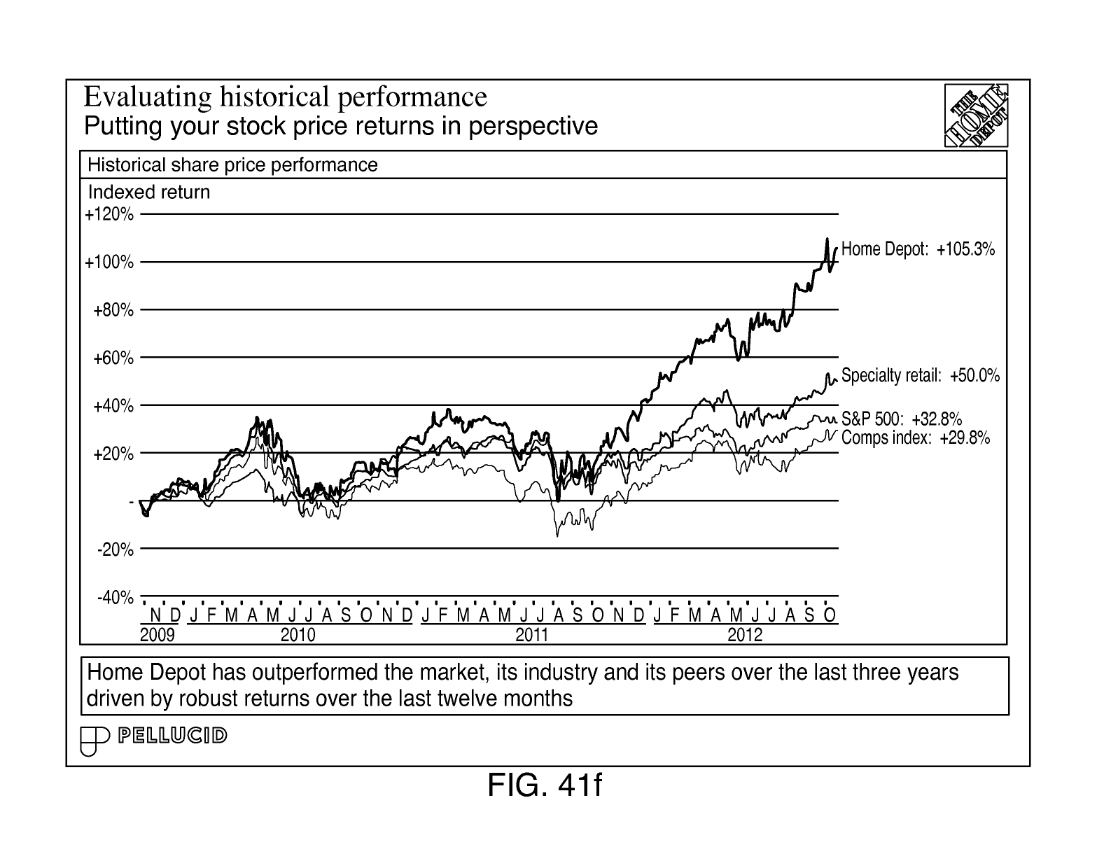

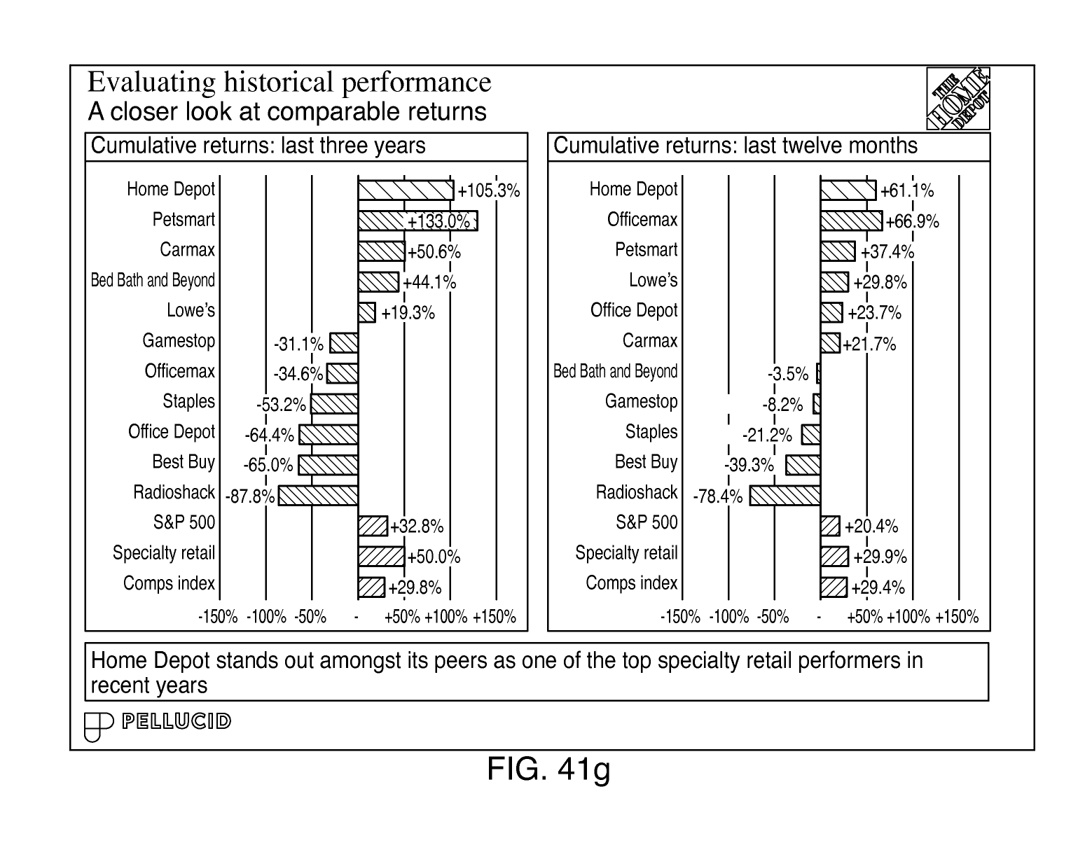

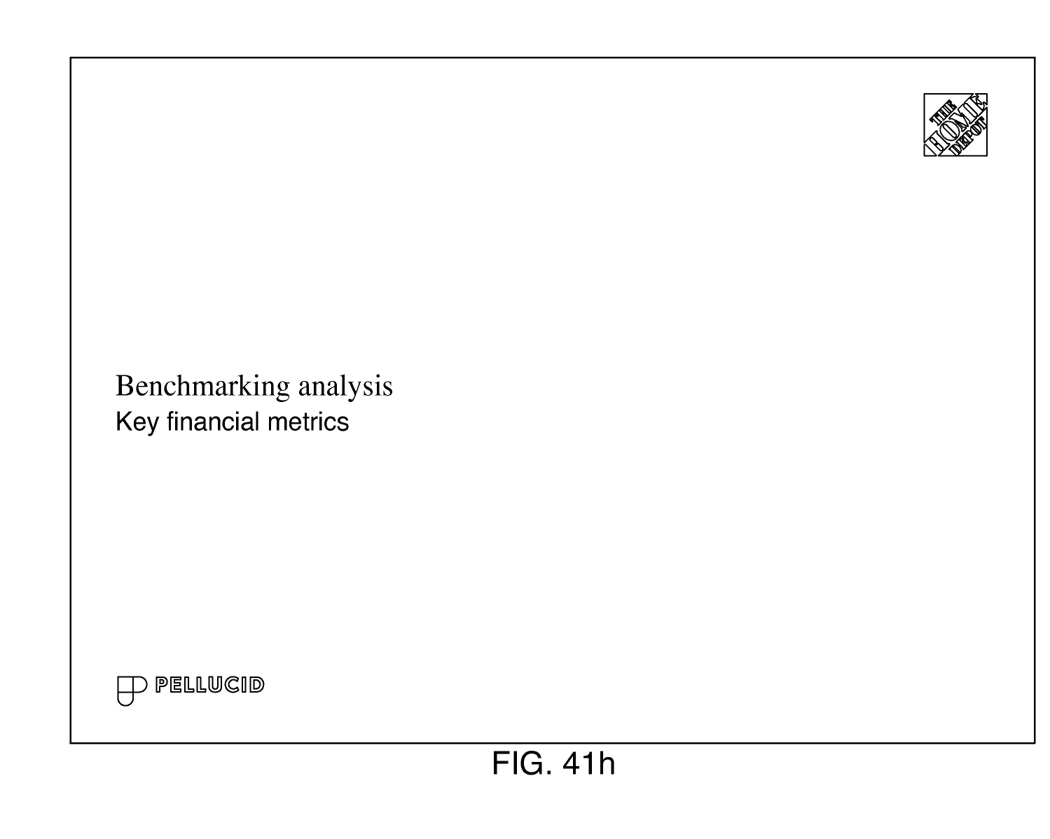

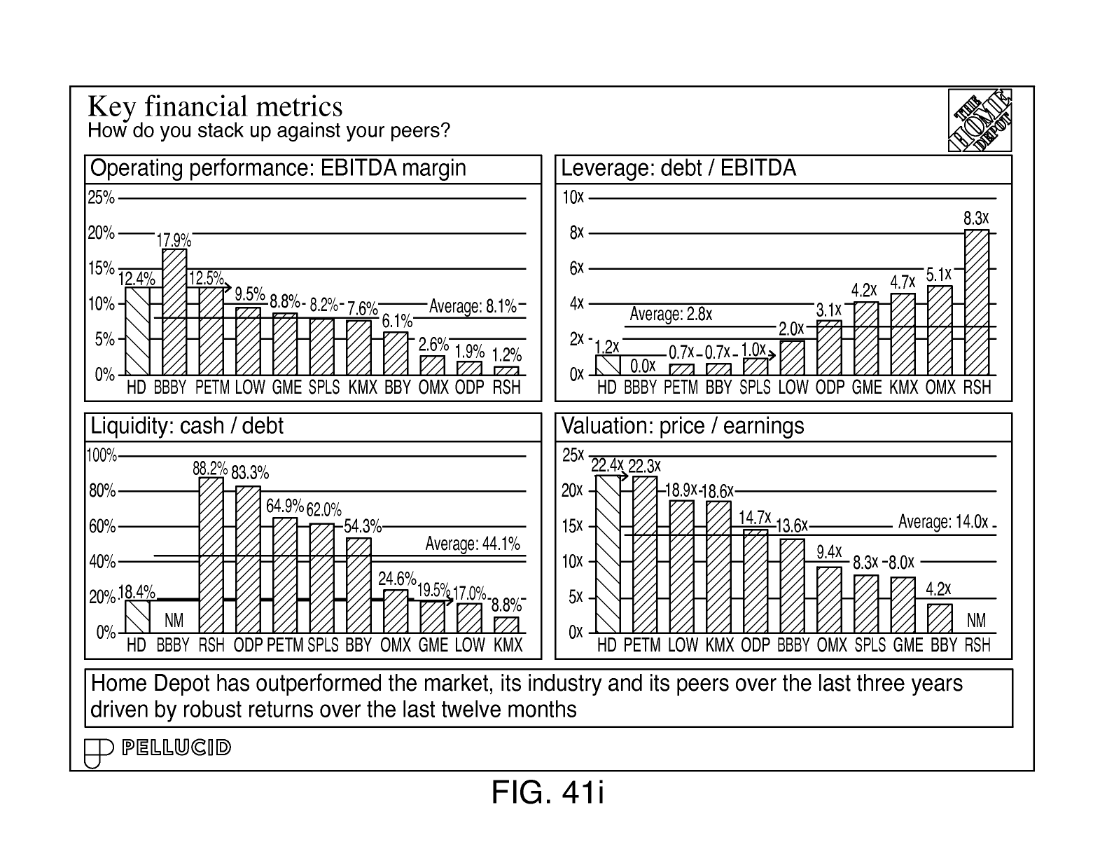

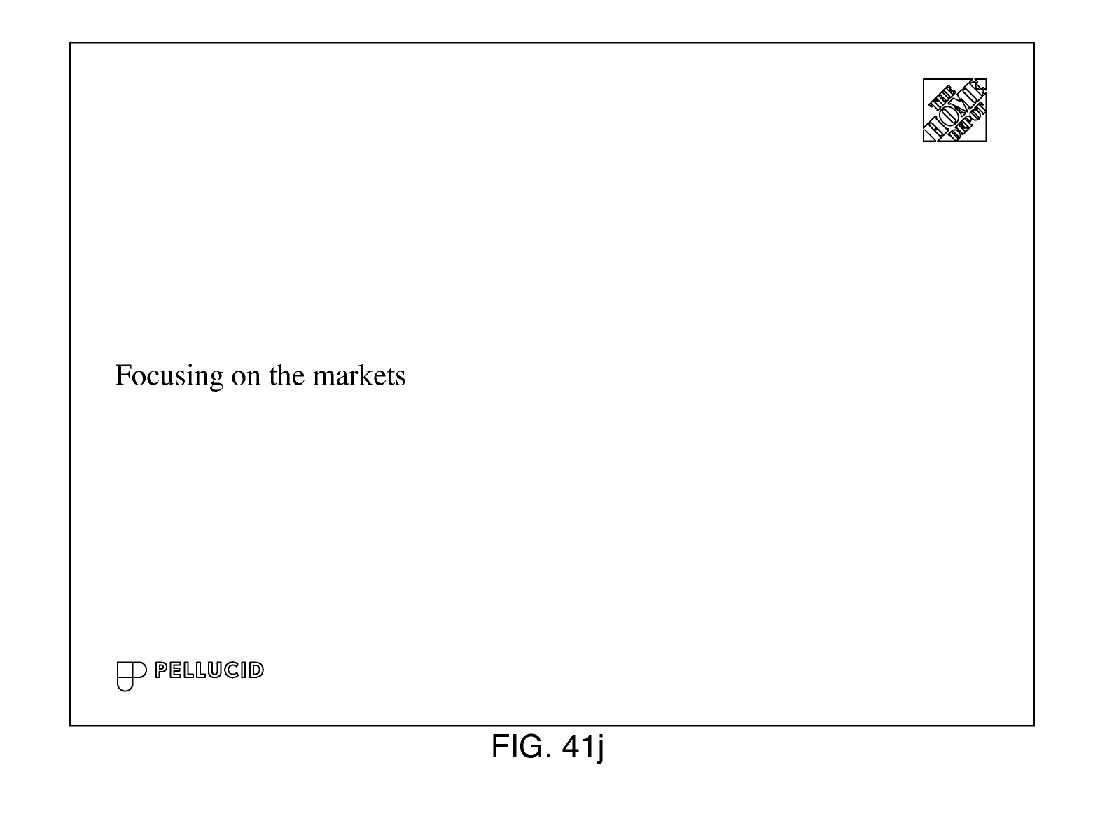

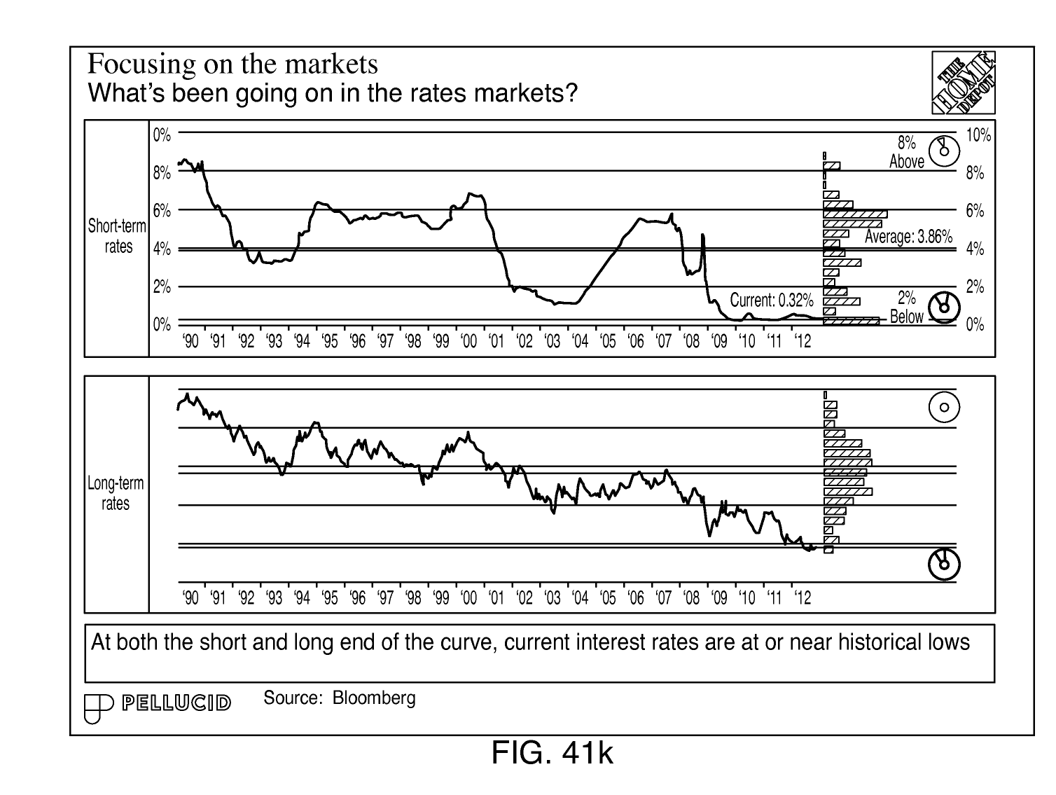

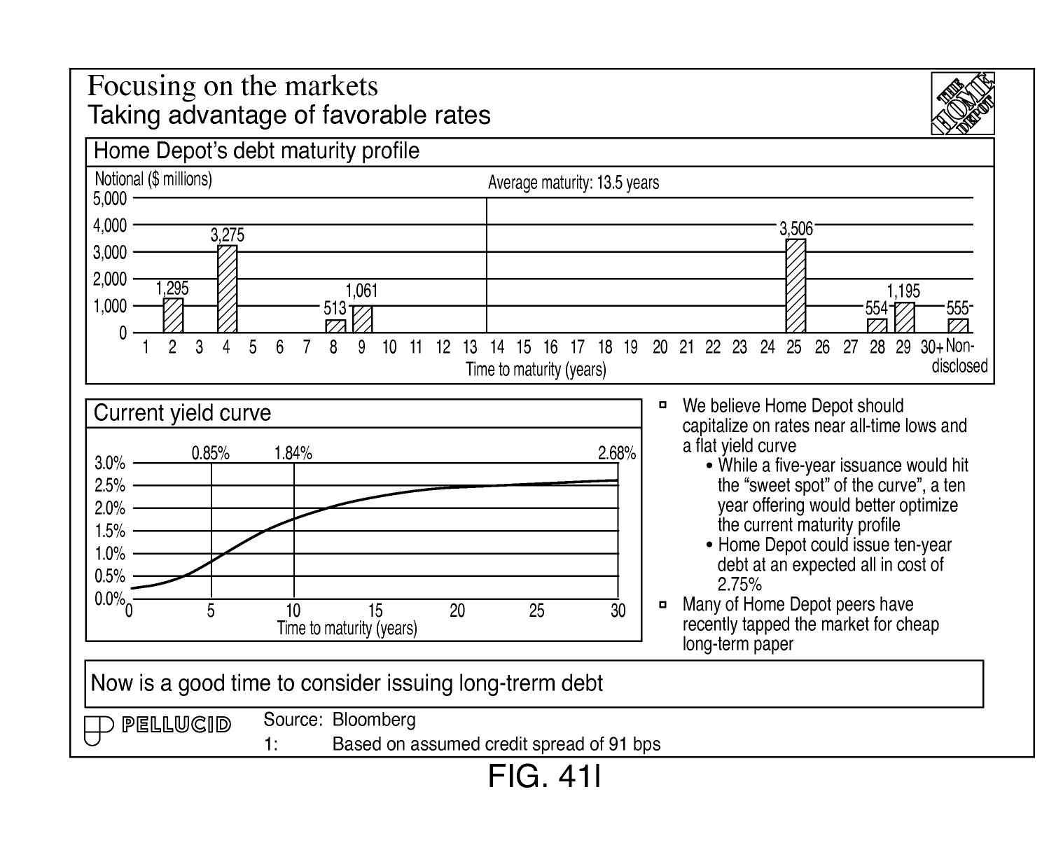

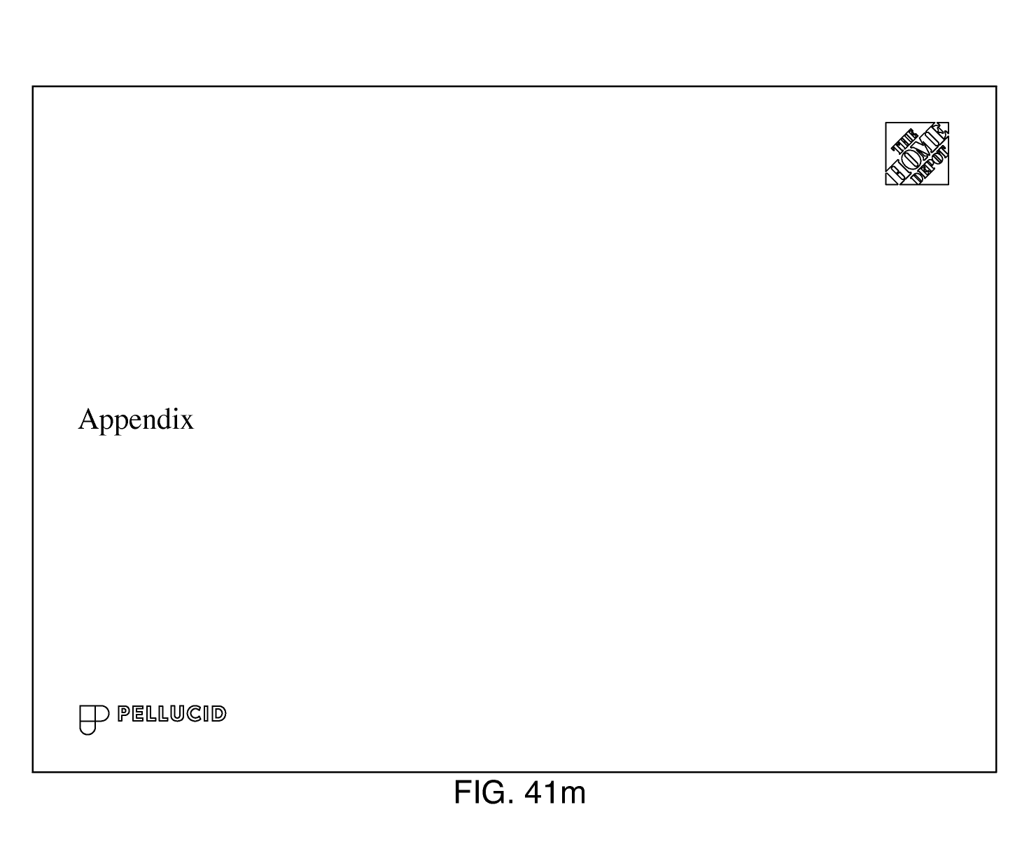

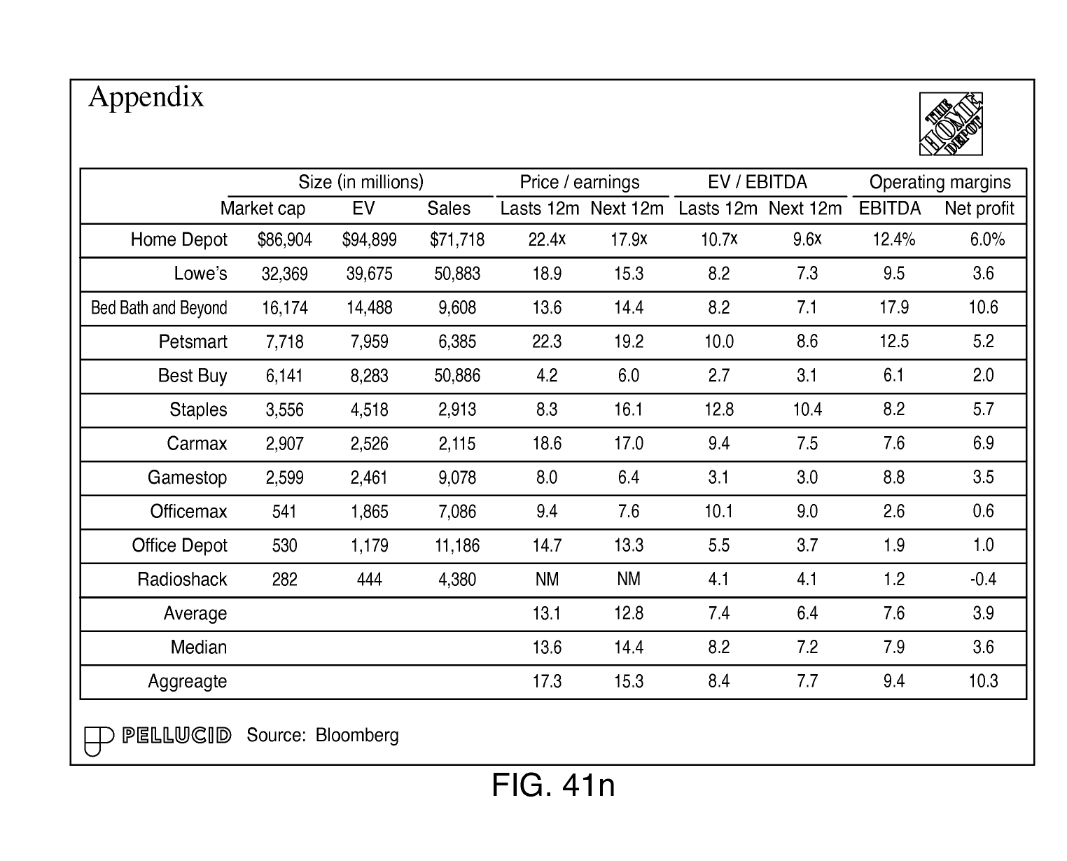

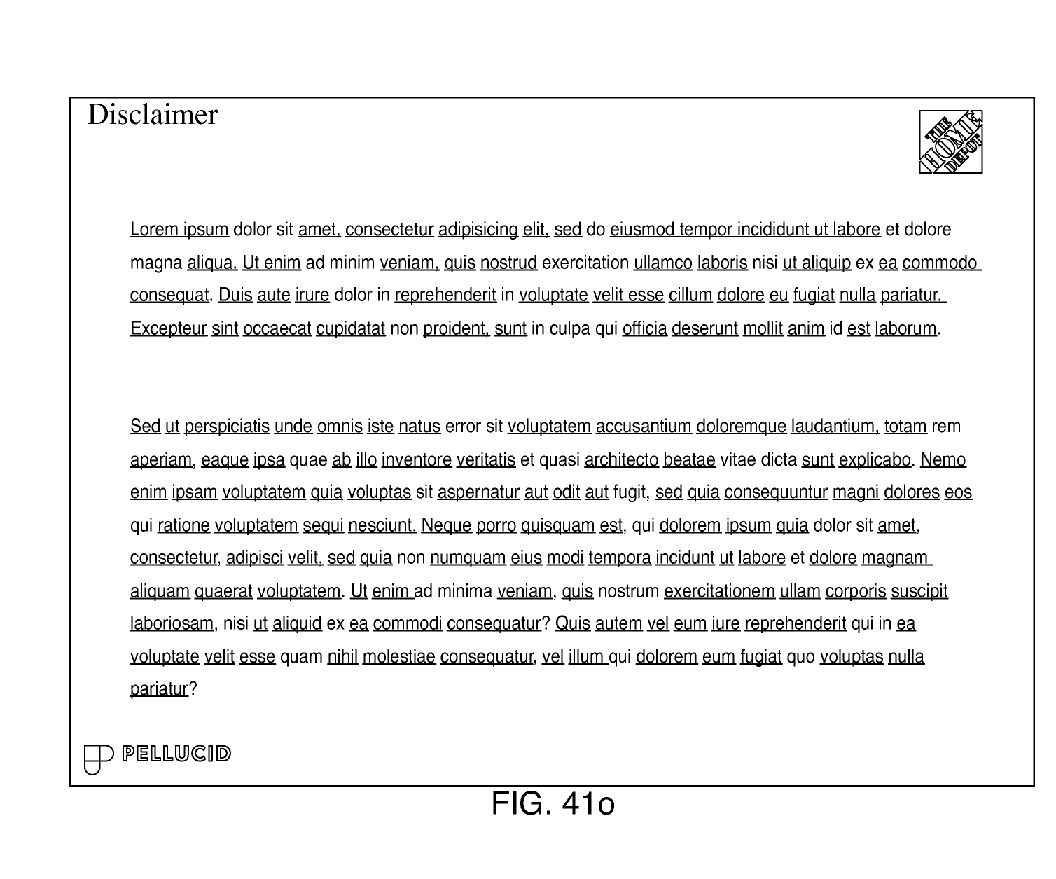

FIGS. 41a-41o show an example deck that the app will help the user produce, and as would be used in discussions between a senior investment banker and the investment bank's client. This is the end result of the end-to-end chart development process, from client selection, general idea conception, research, insight generation, review-reject-tweak modeling, and automatic deck presentation. Or course, what is shown is merely a sample deck illustrating the capabilities of the described embodiment, and is not meant to supply actual opinions or analyses of Home Depot, Inc. or any other company.

FIG. 41a is an example title page of an example deck. The page shows a “Pellucid” logo. This will be replaced with the user investment bank's logo and/or style guidelines. Along the center of the page is a chart graphic illustration, conveying to the audience that a graphical visualization of materials is forthcoming in the presentation. The page contains the name of the company (here, Home Depot, Inc.) and the company logo in the upper right hand corner. The page also indicates the date of the presentation, and that the presentation consists of materials for discussion between a senior investment banker and the client.

FIG. 41b is an example deck Table of Contents. This is also customizable within the application, and will depend on the set of topics chosen by the banker and the order the banker wishes to present them. In FIG. 41b, the Table of contents includes an Executive summary, Benchmarking analysis (including Evaluating historical performance and Key financial metrics), Focusing on the markets, and Appendix. The figure shows the Pellucid logo at the bottom and will appear on every slide in the deck. In practice, this will be the logo of the investment bank, or the slides will contain whatever standard background and styleguides the bank wishes to use in its decks. Like all the other remainder of the slides, at the top right of the chart is the logo of the client, in this case, Home Depot, which is also optional and configurable.

FIG. 41c is the section break page for the Executive Summary portion of the deck, with an investment bank and client logo. FIG. 41d is the content of the Executive Summary. It has three sections, each containing overall financial summary information: Evaluating historical performance, Benchmarking key financial metrics, and Focusing on the markets. The Executive Summary chart can be a template chart within the system, with the data and associated time frames customizable. Insights, which may be considered conclusions, are also shown in the chart, in the Focusing on the markets section: “Now is a good time to consider issuing debt.” Creating chart text, sentences, paragraphs, bullet point arrangements, etc. can also be done within the application, and if desired, through automated if-then algorithms. The data within FIG. 41d is accessed via the system from a reliable, standard financial data source such as Bloomberg or Thomson Reuters.

FIG. 41e is the Benchmarking analysis Evaluating historical performance section break page. FIG. 41f is the deck chart where the historical performance of the client's stock is evaluated. Here, the chart is a graph of the client's stock price returns compared to benchmarks over the past three years. The benchmarks are the aggregate of other specialty retail stores, the S&P 500 and an index of comparable companies (“Comps”). The application is able to make the lines of the charts different colors. However, because the charts are able to be changed on the fly, the benchmark lines can be all one color, for example. The horizontal axis is grouped by year, and further segmented by month. The vertical axis is in increments of 20 percentage points and indicates that the value represents an indexed return. Both the horizontal and vertical axis variables can be adjusted through the system application according to the preferences of the senior banker. The chart also comprises keynote text, formatted by box shadowing: “Home Depot has outperformed the market, its industry and its peers over the last three years driven by robust returns over the last twelve months.” The source of the data as Bloomberg is also indicated at the bottom of the chart.

FIG. 41g shows a chart resulting from the compound layout aspect of the system. A box of comparables has been created and then divided into cumulative returns over the last three years and cumulative returns over the last twelve months. This is a chart originating from the library and then reviewed, rejected and tweaked by the banker. The client (Home Depot) is shown at the top, using a bar of one color. Other retail companies are shown below using, for example, a bar of a different color. Text again is shown at the bottom, indicating an insight or conclusion: “Home Depot stands out amongst its peers as one of the top specialty retail performers in recent years.” The source of the data, Bloomberg, is also shown.

FIG. 41h is the Benchmarking analysis Key financial metrics section break page. FIG. 41i continues the narrative by showing an examination of the client's key financial metrics relative to its peers. The chart is the result of a compound layout: a box for various financial metrics has been created and subdivided into four sections, including Operating performance: EBITDA margin, Leverage: debt/EBITDA, Liquidity: cash/debt, and Valuation: price/earnings. The average for all the metrics is shown as a horizontal line on each chart. Here, the client Home Depot (HD) is shown first and its bar is of a different color than the others. In FIG. 41i an arrow extends from the top of the bar over a selected number of bars of other companies. Text is also included indicating a conclusion, as is the source of the data.

FIG. 41j is the Focusing on the markets section break page. FIG. 41k shows another compound layout, with two boxes on the charts, one showing a graph of short-term rates and another showing a graph of long-term rates. The time-frame selected by the banker is from the years 1990 through 2012, and the vertical axis variable is the level of the rates shown in increments of 2 percentage points. The average rate is shown on the charts, both as a number and as a line across the corresponding point on the chart. On the right of each chart is a histogram indicating the frequency with which the rate fell into a particular range, during the time frame. An insight and conclusion is shown at the bottom of the chart, stating that “at both the short and long end of the curve, current interest rates are at or near historical lows.” The source of the data, Bloomberg, is also shown.

FIG. 41l is a compound layout, with the conclusion that Home Depot should take advantage of favorable rates by issuing long-term debt. It consists of three boxes, one showing Home Depot's debt maturity profile; another with the current yield curve and a third with recommendation text. Debt maturity profile and the current yield curve are both standard charts that are used when presenting a debt idea to a company, which is known and appreciated by the app. The text on the bottom right of the chart summarizes the argument that the banker is making to Home Depot that it could issue ten-year debt at an expected all in cost of 2.75%. The bottom of the chart shows the source of the data as well as lists an assumption in a footnote that the assumed credit spread is 91 bps.

FIG. 41m is the Appendix section break page. FIG. 41n is the Appendix, consisting of summary financial statistics of retail companies grouped by size, price/earnings, EV/EBITDA, and Operating margins. Within the size group, data consists of market cap, EV, and Sales. Within the Price/earnings and EV/EBITDA groups, data is shown for the two time frames Last 12 months and Next 12 months. The Operating margins subgroups are EBITDA and Net profit. Various other data groups and subgroups for an Appendix can be displayed. At the bottom of the chart are the descriptive statistics Average, Median and Aggregate. As indicated in the slide's footnote, the data is taken from Bloomberg.

FIG. 410 is an example disclaimer slide, written using placeholder text common to the publishing industry.

B. Network and Application Architecture

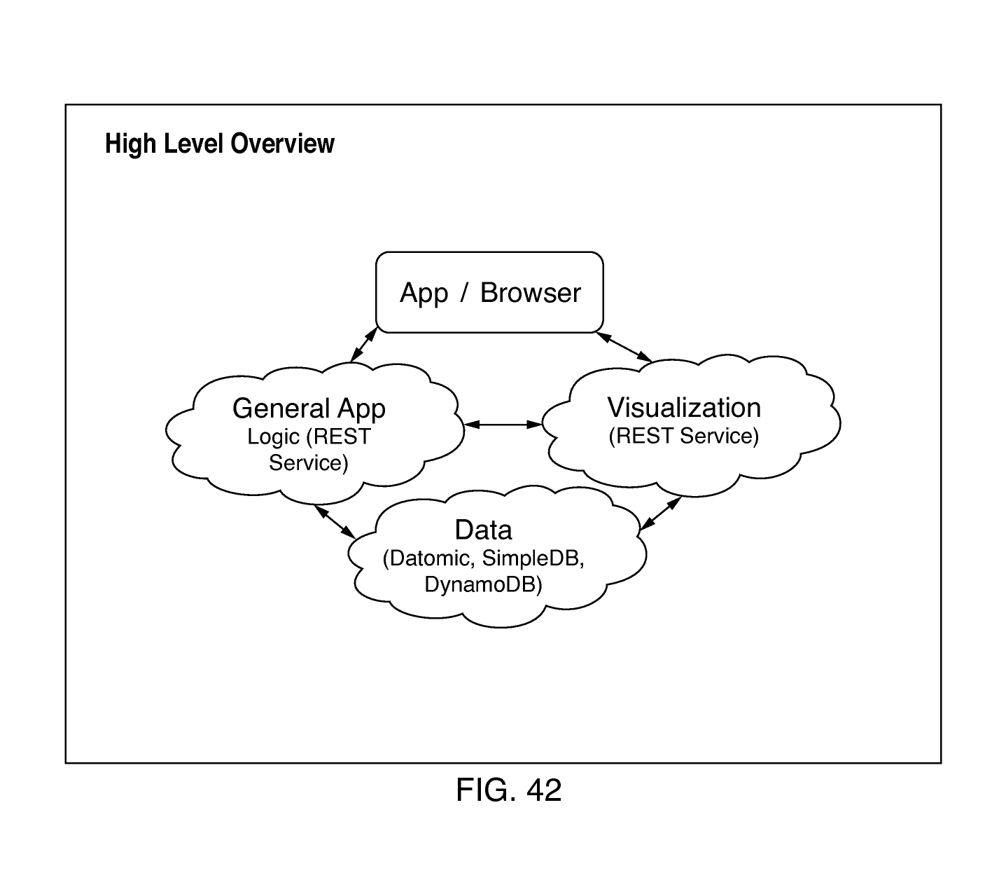

As mentioned previously, the core delivery of the application is to a web browser where the user navigates to the host website, logs in and begins using the application. In the present embodiment, functionality such as data access and chart rendering are performed on the server. The core version of the system is not device specific but is rather available on any modern web browser. FIGS. 42-46 illustrate the system layers and network architecture of the system and method.

FIG. 42 shows a high level overview of the network architecture. It consists of 4 main components: the App/Browser, General App Logic, Visualization, and Data. The General App Logic and Visualization pieces are based on the Representational State Transfer web service model, or REST Service. Data can comprise a database service such as Datomic, SimpleDB, and/or DynamoDB. App/Browser is accessible directly by the user, which is why it is indicated with a rectangular box. Because the rest of the application is hosted, the other components are indicated with a cloud picture. As shown in FIG. 42, the Data component communicates with the General App Logic and Visualization, which both communicate back and forth with the App/Browser. General App Logic and Visualization also communicate with data and messages.

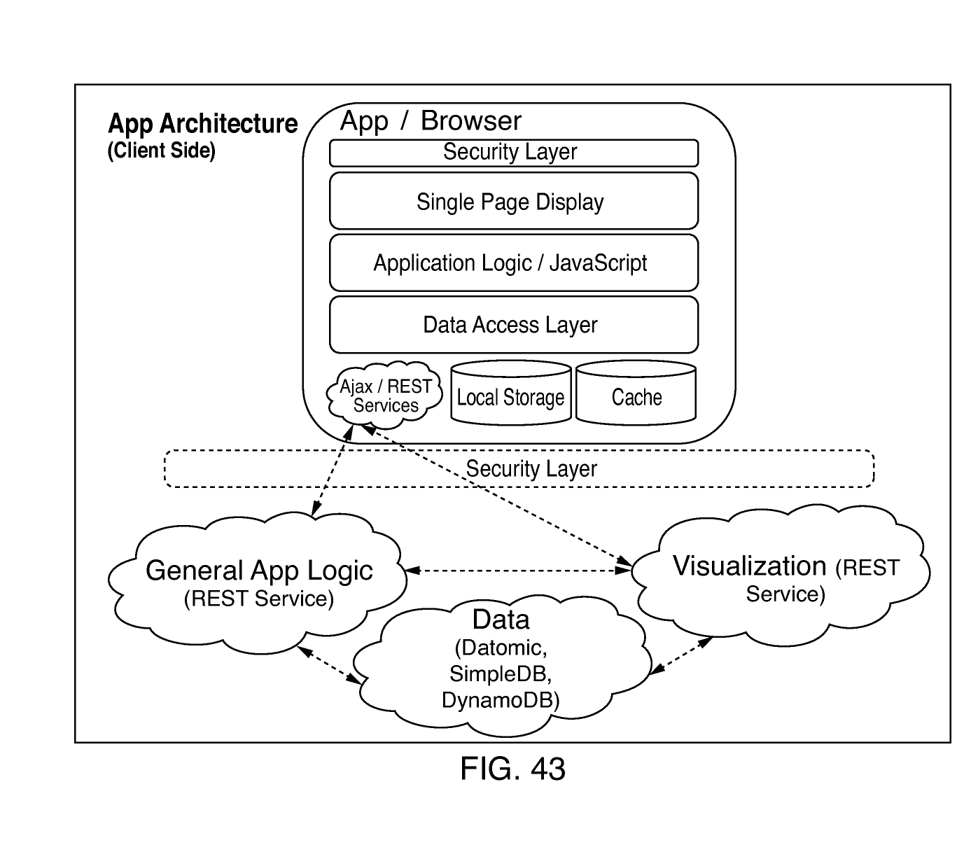

FIG. 43 depicts the client side application architecture of the App/Browser component in more detail. It consists of several layers. The Security Layer comprises user authentication and authorization, enables user access and manages user accounts. Underneath the Security Layer is the Single Page Display layer, comprising the web page application interface presented to the user. The Application Logic/JavaScript contains the functions and procedures used to execute the app functions and internal system algorithms. The Data Access Layer interfaces with the Local Storage and Cache to store frequently used data which speeds up the application and provides the remote feel to the application. As shown in FIG. 43, between the App/Browser and the other major components of the system is a Security Layer, which protects against unauthorized hacks into the system. Ajax/Rest Servies are used to send data to, and receive data from the General App Logic and Visualization components over the Security Layer without interfering with the display and behavior of the application and the experience of the user.

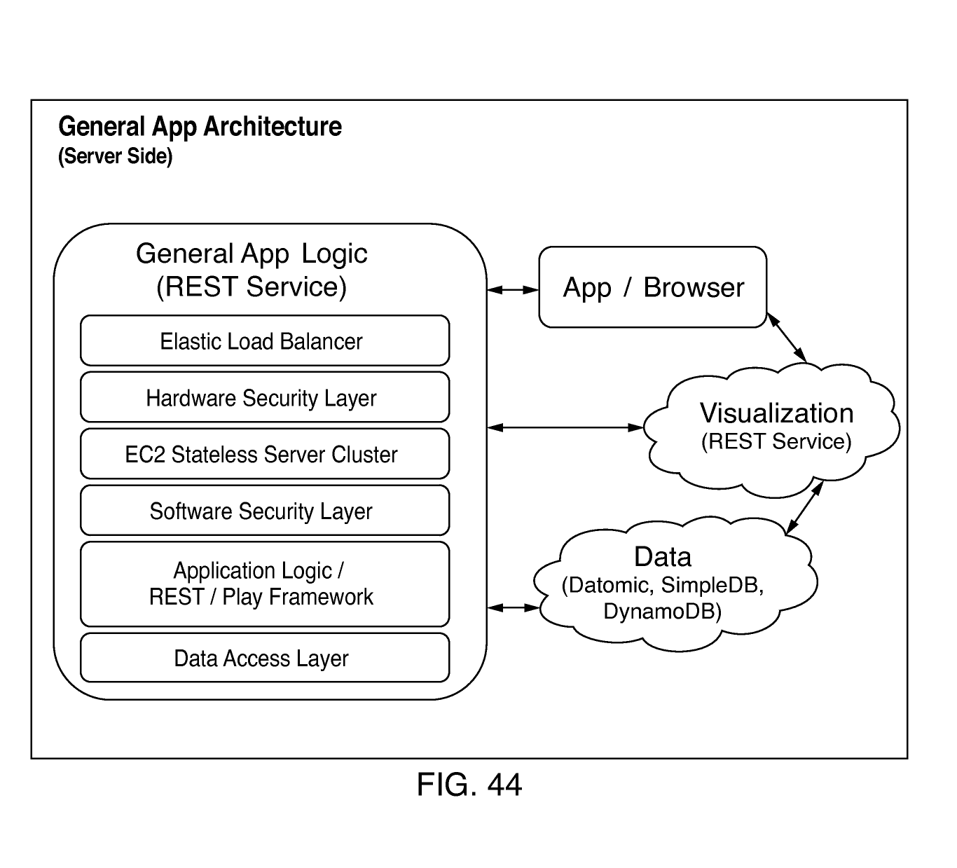

FIG. 44 depicts the server side general application architecture General App Logic component of the system. The Elastic Load Balancer distributes the processing requirements throughout the system to promote efficiency and ensures that not any one piece is overloaded. The Hardware Security Layer ensures that all ports, except the application ports, are closed to reduce exposure to intruders. The EC2 Stateless Server Cluster provides server compute capacity on the cloud, and does not require the server to retain session information or status about each communication partner for the duration of multiple requests. The Software Security Layer ensures that the software application logic is not compromised by data requests, function execution or hardware malfunctions. The Application Logic/REST/Play Framework forms the intelligence of the software and algorithms used in the system. The Data Access Layer serves data to and from the General App Logic to the other system components. The General App Logic component talks to all three other major components of the system architecture.

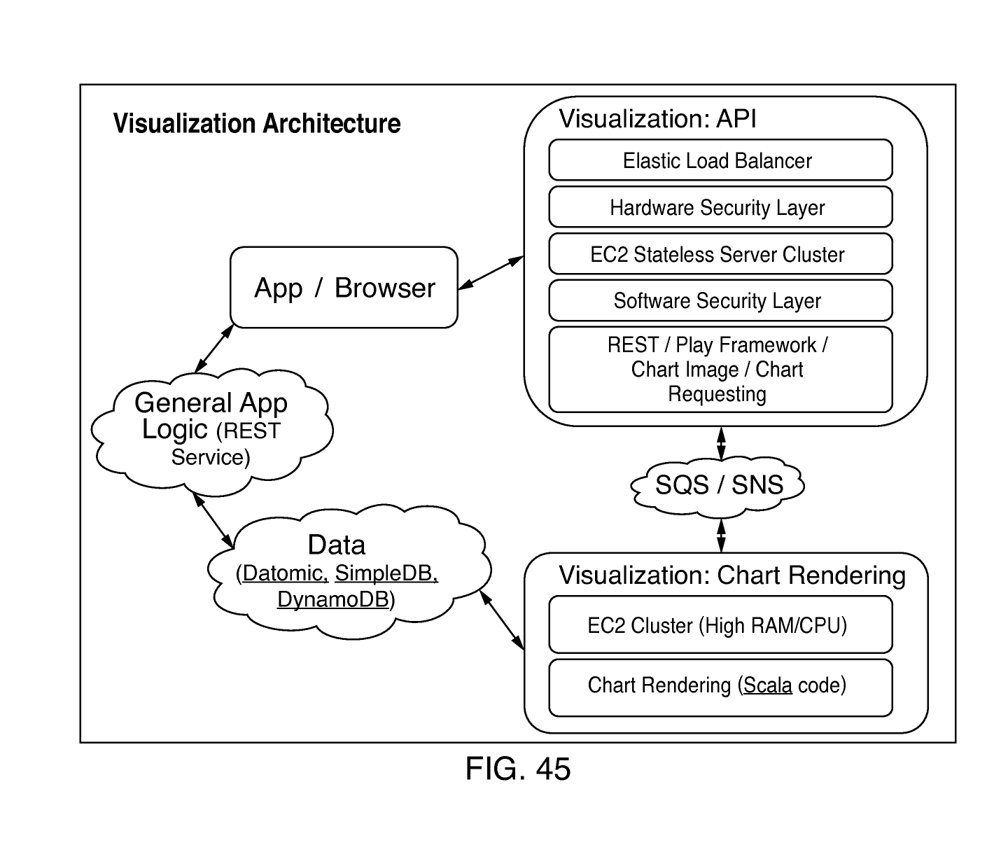

FIG. 45 depicts the Visualization Architecture, which is separated into two main modules connected vis-a-via a SQS/SNS cloud: Visualization: API and Visualization: Chart Rendering. The Visualization: API component of the system has some of the same submodules as the General App Logic component, including a Elastic Load Balancer (functioning similarly acts to distributes the processing requirements throughout the system to promote efficiency and ensures that not any one piece is overloaded), a Hardware Security Layer (ensuring the application does not compromise the integrity of the hardware), a EC2 Stateless Server Cluster (providing server compute capacity on the cloud, and does not require the server to retain session information or status about each communication partner for the duration of multiple requests), and Software Security Layer (ensures that the software application logic is not compromised by data requests, function execution or hardware malfunctions). In addition, the Visualization: API module comprises a REST/Play Framework/Chart Image/Chart Requesting module, which operates as the client side of the chart development system of the application. The Simple Queue Service (SQS)/Simple Notification Service (SNS) relays messages back and forth between the Visualization: API the Visualization: Chart Rendering. SQS and SNS provide an infrastructure for intracomputer communication, in the form of a large distributed queue (SQS) for storing and processing data, and a publish/subscribe system (SNS). The Visualization: Chart Rendering module comprises two submodules, EC2 Cluster (High RAM/CPU) and Chart Rendering (Scala Code). The EC2 Cluster comprises high-performance random access memory and processor suitable for data intensive applications such as chart rendering. The actual Chart Rendering module creates the charts, saves them to S3, and notifies awaiting servers via SQS/SNS using the Scala programming language. Although Scala is used, any multi-paradigm, functional, object-oriented programming language is suitable, such as those built on top of the Java virtual machine.

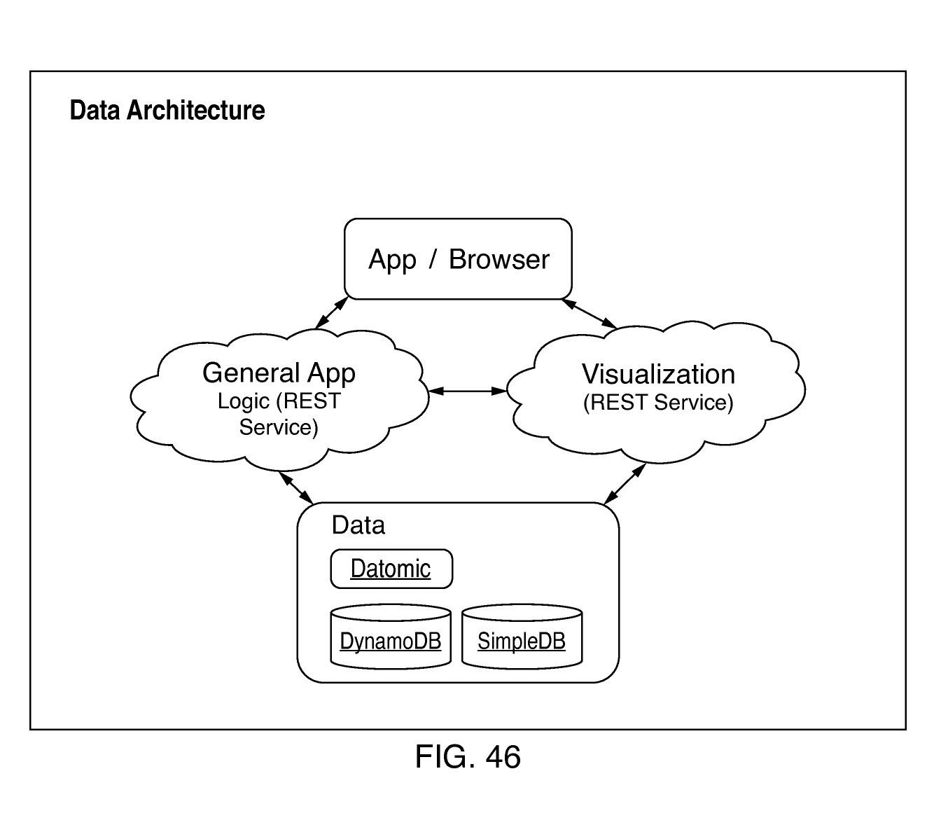

FIG. 46 depicts the Data component of the system. This component comprises a database management system, such as Datomic, Amazon DynamoDB and Amazon SimpleDB, although the system can employ any similar database management solution. Datomic is a database of flexible, time-based facts, supporting queries and joins, with elastic scalability, and ACID transactions. DynamoDS is a fully managed NoSQL database service providing fast and reliable performance which scales easily. SimpleDB is a highly available, scalable, and flexible non-relational data store that offloads the work of database administration.

C. Algorithms for Particular Features

1. Chart Formatting

All charts are already in the relevant format. For each bank that uses the product, the bank's branding and style guidelines (e.g., colors, fonts) are encoded so that charts are presented to the user pre-formatted. This is a significant step-up in usability from sites like finance.yahoo.com and google.com/finance since they will only display charts in their own format. The user can perform additional formatting using the formatting features of the invention.

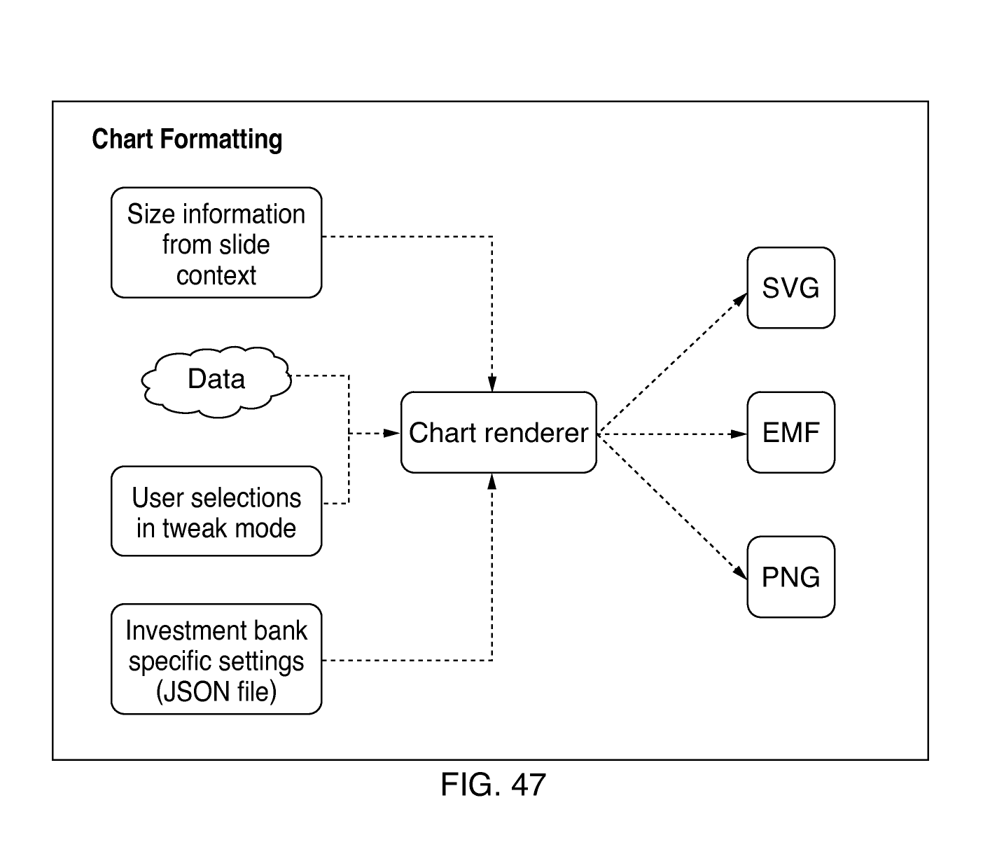

FIG. 47 depicts the software architecture and logic flow diagrams supporting chart formatting in the embodiment. Four data sets are relevant to the computation: the data to be plotted; the size in which the chart needs to be rendered, obtained from where the chart is placed on a slide or a default size if the chart is not yet on a slide; the user's selections about how the chart should be rendered (e.g., whether to add an average line or what start and end date to plot); and, settings particular to the investment bank (e.g., the color of the lines or the font of the labels). While the user has significant flexibility to adjust the appearance of the chart in the tweak mode, they are insulated from decisions about formatting and sizing of the chart which are determined for them either by the bank-specific style guidelines or the placement of the chart on a page. Output image formats for the browser display may vary, and may include .SVG files, .EMF files, or .PNG files.

2. Auto Sizing

The system can auto-size charts within the deck based on user specified parameters. The user specifies the page layout (how many charts, what size, where on the page) and the charts are placed into the layout. Additionally, the user can specify “boxes” which are holders for text, charts or other content. They can draw and resize boxes freely. The embodiment creates charts in the bank's own style and autosizes them to fit templated page layouts.

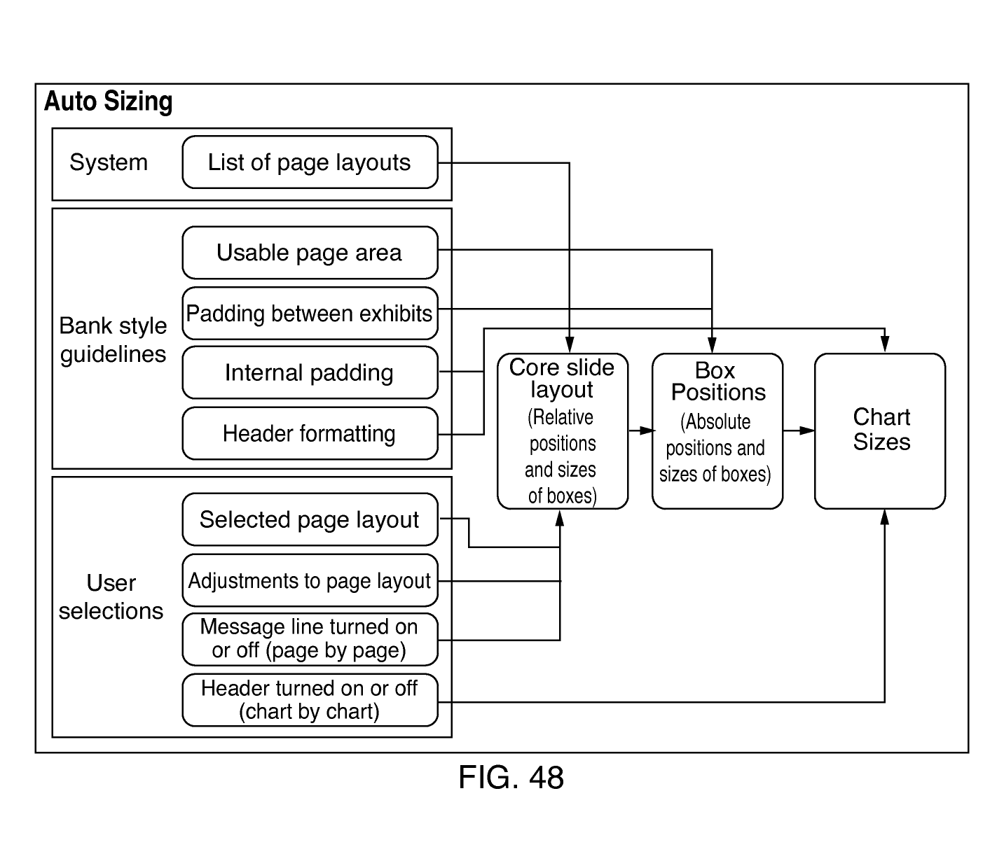

FIG. 48 depicts the software architecture and logic flow diagrams supporting auto sizing in the embodiment. The system contains a set of possible page layouts which may be adjusted by the user as shown in FIGS. 36 and 38. The user's selection of a page layout together with the adjustments and the choice of whether to include a message line (see FIG. 39) gives the core slide layout of how many boxes, their relative positions and relative sizes. This is combined with information from the style guidelines about the padding between boxes and the usable area of the page to give precise top, left, height and width information for each box. The actual plot size of a chart is determined by the box size, scaled down by the internal padding from the style guidelines and, if selected by the user, the space used by the header.

3. Chart Linking

The invention provides a controllable chart linking system. Linking allows the user to make changes at a chart by chart level with an associated assumption tracking system whereby charts are linked to each other and changes at one chart propagate to another. Users can see and control which charts are linked to which other charts and in what way.

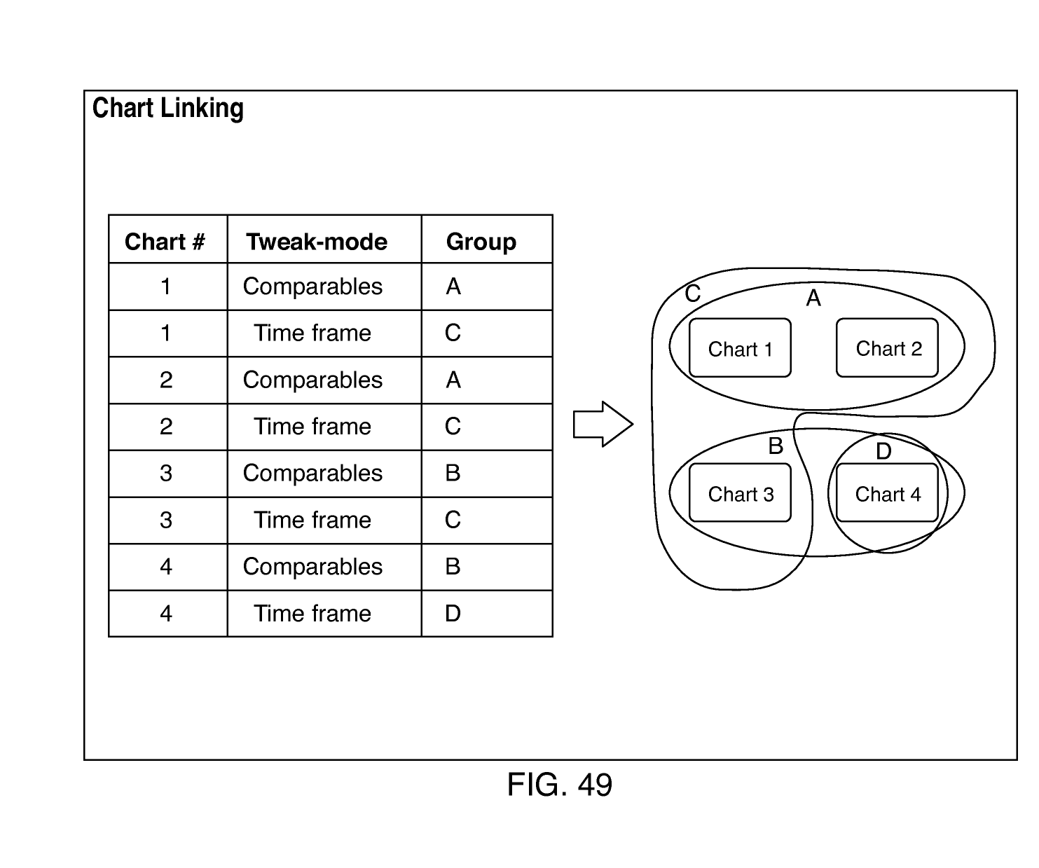

FIG. 49 depicts the software architecture and logic flow diagrams supporting chart linking in the embodiment. Each chart-tweak mode combination is assigned a group. Within that group all charts have the same assumptions. For example, in FIG. 49 charts 1 and 2 have the same list of Comparables, forming group A. Any change to the comparables for chart 1 will automatically update for chart 2 and vice versa. Similarly, changing Comparables for chart 4 will update chart 3 because they are both in group B. However, changing the Time frame for chart 4 will not update chart 3 because Chart 4 is in group D, not group C. The user can split and merge groups to give full control over which charts are linked and library and deck views support a view showing how charts are linked.

4. Visual Alert Definition

The invention defines events visually based on a chart rather than just by abstract rules. The invention supports an event alerts system, such that whenever the user sees a chart they will be able to set alerts on certain events (e.g., the blue line drops below 50% or the blue line crosses the red line). These events will be tracked by the system, the user will be alerted when that event occurs and the chart that they based the event on presented to them.

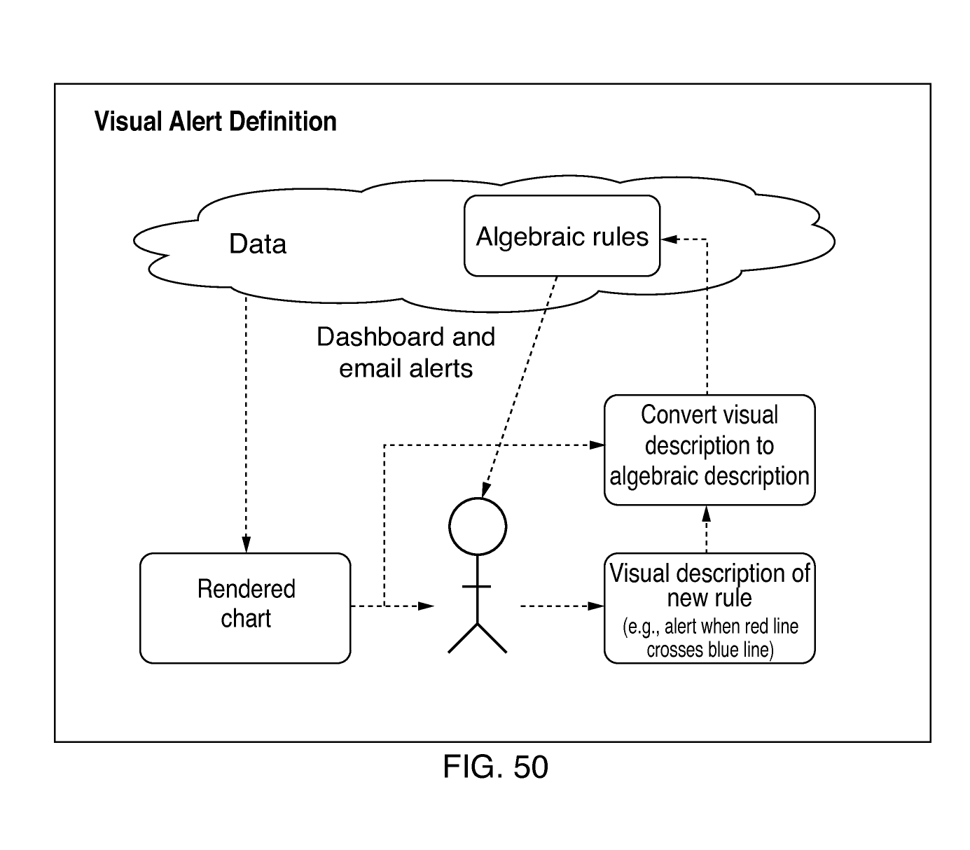

FIG. 50 depicts the software architecture and logic flow diagrams supporting visual alert definition in the embodiment. Rules for generating alerts are held in the cloud with data in the usual algebraic format (as a set of relations and Boolean expressions on data). These rules are evaluated as new data arrives in the system and, if true, trigger a message on the dashboard of the system and, possibly, an email being sent to the user. What is novel is that these rules are generated automatically from user actions based on visual components of a chart.

For example, rather than the user having to say “alert me if the P/E ratio of this company falls below the median P/E ratio of these five comparable companies” the user can look at a chart showing the P/E ratio of a company and the median P/E ratio of five comparable companies and make the more intuitive statement “alert me if the red line crosses the blue line”.

In addition, when an alert is issued, the chart used to generate the alert is included with the alert message. This provides the user with context as to why they setup the alert and allows the user to construct alerts of the form “alert me when this chart becomes interesting”.

Similar functionality allows the user search across companies to find a company which satisfies visual criteria for the chart.

While the above specification and example provide a description of the invention, many embodiments of the invention can be made without departing from the spirit and scope of the invention. It is to be understood that the foregoing embodiments are provided as illustrative only, and does not limit or define the scope of the invention. Various other embodiments are also within the scope of the claims.

We claim:

1. A system for use in creating investment-banking materials, comprising:
a first computer server coupled in real time to a financial data source, the server comprising one or more user accounts corresponding to respective users, the server further comprising a set of default financial chart templates and one or more preselected companies for each of the user accounts,
wherein the server is constructed to receive real-time financial data from the financial data source to populate one or more of the templates to generate a default library of charts for each of the preselected companies,
wherein the server is further constructed to receive requests concerning the user accounts, such requests including selection from among the default library of which selected chart or charts is to be placed into one or more slides,
wherein the server updates the default library of charts for each of the preselected companies with the retrieved real-time financial data, and propagates the real-time financial data into any selected charts, whereby slides that contain the selected charts also contain real-time financial data; and
a rendering computer server coupled to the first computer server, constructed to render the graphic image of the selected charts and the one or more slides.

2. The system of claim 1 wherein the user account comprises one or more decks for each company, each deck comprising the one or more slides.

3. The system of claim 1 comprising a network connection over which the first computer server delivers the selected charts or the one or more slides to a user's computer.

4. The system of claim 3 wherein the user's computer displays in a web browser interface the selected charts or the one or more slides as rendered by the rendering computer server.

5. The system of claim 4 wherein the user's computer displays real-time financial data within the selected charts or the one or more slides through the web browser interface.

6. The system of claim 2 wherein the first computer server is constructed to receive user requests to place a slide into a selected one of the one or more decks.

7. The system of claim 2 wherein the first computer server is constructed to receive user requests to review a slide, and in response to provide said slide image to the user.

8. The system of claim 2 wherein the first computer server is constructed to receive user requests to edit a slide.

9. The system of claim 8 wherein the user requests to edit a slide comprise one or more from the following list: add a chart to a slide, adjust the horizontal division between charts in a slide, adjust the vertical division between charts in a slide, add text to a chart in a slide, add or remove from among comparables for a chart in a slide, add or remove from among the metrics for a chart in a slide, and adjust a timeframe for a chart in a slide.

10. The system of claim 8 wherein the first computer server is constructed to receive user requests to place an edited slide into a selected one of the one or more decks.

11. The system of claim 5 wherein the first computer server is constructed to receive user requests sent via the web browser to place a selected one of the one or more slides into a selected one of the one or more decks.

12. The system of claim 11 wherein the first computer server is constructed to receive user requests sent via the web browser to supply a deck as an output file.

13. The system of claim 12 further comprising a paper deck generated from the output file.

14. The system of claim 1 wherein the first computer server is constructed to link together specific ones of default chart templates such that a user edit to one slide propagates to all slides derived from the same group.

15. The system of claim 1 wherein the first computer server and the rendering computer server exist as parts of a single physical computer server.

16. The system of claim 1 wherein the first computer server further comprises a visually-defined alert condition for a user account, the first computer server constructed to compare the real-time financial data against the customizable alert condition, and to indicate within the user account whether the alert condition has been reached.

17. A method for generating investment-banking materials, comprising:
a. viewing on a web browser a list of companies;
b. selecting a company from that list;
c. reviewing charts related to that company, the reviewed charts populated with real-time financial data inserted into the charts at a connected web server;
d. selecting one or more of the reviewed charts for addition to a deck;
e. repeating steps c. through d. until a deck has been created.

18. The method of claim 17 further comprising:
f. generating an output for displaying the deck selected from one or more of the following: a .pdf file, a .pptx file, and a paper document.

19. The method of claim 17 wherein between steps c. and d. is a step comprising:
c1. changing one or more settings of the chart, selected from the list comprising: timeframe, comparables, and textual content.

20. A non-transitory computer-readable medium comprising first computer program instructions, wherein the first computer program instructions are executable by at least one computer processor to perform a method, the method comprising:
coupling in real time to a financial data source,
establishing one or more user accounts corresponding to respective users,
establishing a set of default financial chart templates and one or more preselected companies for each of the user accounts,
receiving real-time financial data from the financial data source to populate one or more of the templates to generate a default library of charts for each of the preselected companies,
receiving requests concerning the user accounts, such requests including selection from among the default library of which selected chart or charts is to be placed into one or more slides,
updating the default library of charts for each of the preselected companies with the retrieved real-time financial data, and propagating the real-time financial data into any selected charts, whereby slides that contain the selected charts also contain real-time financial data; and
rendering the graphic image of the selected charts and the one or more slides.
